(19) United States
(12) Patent Application Publication
(10) Pub. No.: US 2026/0189388 A1
(43) Pub. Date: Jul. 2, 2026

(54) DEVICE AND METHOD FOR PERFORMING QUANTUM STATE MODULATION ON BASIS OF QUANTUM AUTHENTICATION IN QUANTUM COMMUNICATION SYSTEM

(71) Applicant: LG ELECTRONICS INC., Seoul (KR)

(72) Inventors: Hojae LEE, Seoul (KR); Jayeong KIM, Seoul (KR); Byungkyu AHN, Seoul (KR); Sangrim LEE, Seoul (KR)

(73) Assignee: LG ELECTRONICS INC., Seoul (KR)

(21) Appl. No.: 19/128,137

(22) PCT Filed: Nov. 9, 2022
(86) PCT No.: PCT/KR2022/017574

§ 371 Date: May 7, 2025

(51) Int. Cl. H04L 9/32; H04L 9/08

(52) U.S. Cl. CPC H04L 9/321; H04L 9/0858

(57) ABSTRACT

The present disclosure relates to a quantum communication system. Particularly, the present disclosure relates to a device and a method for performing quantum state modulation based on quantum authentication in a quantum communication system.

### TECHNICAL FIELD

The present disclosure relates to a quantum communication system. Particularly, the present disclosure relates to a device and a method for performing quantum state modulation based on quantum authentication in a quantum communication system.

### Background Art

With the advent of quantum computers, hacking of existing mathematical complexity-based encryption systems (e.g., RSA, AES, etc.) has become possible. In order to prevent hacking, quantum cryptography communication is being proposed.

Meanwhile, the present disclosure is to reduce a number of required qubits of the authentication header for quantum authentication (QA) through symmetric M order quantum state modulation (M-QSM)-based QA, increase a detection capability of Eve, and reduce an amount of information leaked of the preshared key used in the QA.

### DISCLOSURE

### Technical Problem

In order to solve the above-described problem, the present disclosure provides a device and a method for performing quantum state modulation based on quantum authentication in a quantum communication system.

The present disclosure is to a device and a method which may reduce a number of required qubits of the authentication header for quantum authentication (QA) through symmetric M order quantum state modulation (M-QSM)-based QA and increase a detection capability of Eve, and which is to reduce an amount of information leaked of the preshared key used in the QA.

The technical problems to be achieved by the present disclosure are not limited to the technical problems mentioned above, and other technical problems not mentioned will be clearly understood by those skilled in the art to which the present disclosure pertains from the following descriptions.

### Technical Solution

According to various embodiments of the present disclosure, there is provided an operation method of a first device in a quantum communication system comprising transmitting, to a second device, information about M, which is a modulation order of a symmetric M-order quantum state modulation (symmetric M-QSM), and information about one encoding method selected from among a plurality of authentication encoding methods; generating information about a first quantum state on the basis of the symmetric M-order quantum state modulation by using a first authentication code and a first key shared in advance with the second device; transmitting, to the second device, a message including a quantum authentication header (QA header) based on the first quantum state; receiving, from the second device, a feedback message including a second authentication code based on the quantum authentication header; performing a quantum bit error rate (QBER) measurement based on a comparison between the first authentication code and the second authentication code; determining, based on a comparison between a result value of the QBER measurement and a predetermined threshold, whether the second device is authenticated; and transmitting an acknowledgement (ACK) or non-acknowledgement (NACK) message to the second device based on whether the second device being authenticated.

According to various embodiments of the present disclosure, there is provided an operation method of a second device in a quantum communication system comprising receiving, from a first device, information about M, which is a modulation order of a symmetric M-order quantum state modulation (symmetric M-QSM), and information about one encoding method selected from among a plurality of authentication encoding methods; receiving, from the first device, a message including a quantum authentication (QA) header based on a first quantum state, wherein information about the first quantum state is generated based on the symmetric M-order quantum state modulation (symmetric M-QSM) by using a first authentication code and a first key shared in advance with the first device; obtaining a second authentication code based on the quantum authentication header; transmitting, to the first device, a feedback message including the second authentication code; and receiving, from the first device, a message of an acknowledgement (ACK) or a non-acknowledgement (NACK) for an authentication according to a result of a quantum bit error rate (QBER) measurement based on a comparison between the first authentication code and the second authentication code.

According to various embodiments of the present disclosure, there is provided a first device in a quantum communication system comprising a transceiver and at least one processor, wherein the at least one processor is configured to transmit, to a second device, information about M, which is a modulation order of a symmetric M-order quantum state modulation (symmetric M-QSM), and information about one encoding method selected from among a plurality of authentication encoding methods, generate information about a first quantum state on the basis of the symmetric M-order quantum state modulation by using a first authentication code and a first key shared in advance with the second device, transmit, to the second device, a message including a quantum authentication header (QA header) based on the first quantum state, receive, from the second device, a feedback message including a second authentication code based on the quantum authentication header, perform a quantum bit error rate (QBER) measurement based on a comparison between the first authentication code and the second authentication code, determine, based on a comparison between a result value of the QBER measurement and a predetermined threshold, whether the second device is authenticated, and transmit an acknowledgement (ACK) or non-acknowledgement (NACK) message to the second device based on whether the second device being authenticated.

According to various embodiments of the present disclosure, there is provided a second device in a quantum communication system comprising a transceiver and at least one processor, wherein the at least one processor is configured to receiving, from a first device, information about M, which is a modulation order of a symmetric M-order quantum state modulation (symmetric M-QSM), and information about one encoding method selected from among a plurality of authentication encoding methods, receive, from the first device, a message including a quantum authentication (QA) header based on a first quantum state, wherein information about the first quantum state is generated based on the symmetric M-order quantum state modulation (symmetric M-QSM) by using a first authentication code and a first key shared in advance with the first device, obtain a second authentication code based on the quantum authentication header, transmit, to the first device, a feedback message including the second authentication code, and receive, from the first device, a message of an acknowledgement (ACK) or a non-acknowledgement (NACK) for an authentication according to a result of a quantum bit error rate (QBER) measurement based on a comparison between the first authentication code and the second authentication code.

According to various embodiments of the present disclosure, there are provided one or more non-transitory computer readable media storing one or more instructions, wherein the one or more instructions perform operations based on being executed by one or more processors, and wherein the operations include transmitting, to a second device, information about M, which is a modulation order of a symmetric M-order quantum state modulation (symmetric M-QSM), and information about one encoding method selected from among a plurality of authentication encoding methods; generating information about a first quantum state on the basis of the symmetric M-order quantum state modulation by using a first authentication code and a first key shared in advance with the second device; transmitting, to the second device, a message including a quantum authentication header (QA header) based on the first quantum state; receiving, from the second device, a feedback message including a second authentication code based on the quantum authentication header; performing a quantum bit error rate (QBER) measurement based on a comparison between the first authentication code and the second authentication code; determining, based on a comparison between a result value of the QBER measurement and a predetermined threshold, whether the second device is authenticated; and transmitting an acknowledgement (ACK) or non-acknowledgement (NACK) message to the second device based on whether the second device being authenticated.

According to various embodiments of the present disclosure, there are provided one or more non-transitory computer readable media storing one or more instructions, wherein the one or more instructions perform operations based on being executed by one or more processors, and wherein the operations include receiving, from a first device, information about M, which is a modulation order of a symmetric M-order quantum state modulation (symmetric M-QSM), and information about one encoding method selected from among a plurality of authentication encoding methods; receiving, from the first device, a message including a quantum authentication (QA) header based on a first quantum state, wherein information about the first quantum state is generated based on the symmetric M-order quantum state modulation (symmetric M-QSM) by using a first authentication code and a first key shared in advance with the first device; obtaining a second authentication code based on the quantum authentication header; transmitting, to the first device, a feedback message including the second authentication code; and receiving, from the first device, a message of an acknowledgement (ACK) or a non-acknowledgement (NACK) for an authentication according to a result of a quantum bit error rate (QBER) measurement based on a comparison between the first authentication code and the second authentication code.

### Advantageous Effects

According to the present disclosure, a device and a method for performing quantum state modulation based on quantum authentication in a quantum communication system can be provided.

According to the present disclosure, a device and a method can be provided, which can reduce a number of required qubits of the authentication header for quantum authentication (QA) through symmetric M order quantum state modulation (M-QSM)-based QA and increase a detection capability of Eve, and is to reduce an amount of information leaked of the preshared key used in the QA.

### DESCRIPTION OF DRAWINGS

The drawings attached below are intended to aid understanding of the present disclosure and may provide embodiments of the present disclosure along with a detailed description. However, the technical features of the present disclosure are not limited to specific drawings, and the features disclosed in each drawing may be combined to form a new embodiment. Reference numerals in each drawing may refer to structural elements.

FIG. 1 illustrates an example of physical channels and general signal transmission used for the 3GPP system.

FIG. 2 illustrates system architecture of new generation radio access network (NG-RAN).

FIG. 3 illustrates functional split between NG-RAN and 5GC.

FIG. 4 illustrates an example of 5G usage scenario.

FIG. 5 illustrates an example of a communication structure providable in a 6G system.

FIG. 6 illustrates schematically an example of a structure of a perceptron.

FIG. 7 illustrates schematically an example of a structure of a multilayer perceptron.

FIG. 8 illustrates schematically an example of a deep neural network.

FIG. 9 illustrates schematically an example of a convolutional neural network.

FIG. 10 illustrates schematically an example of a filter operation of a convolutional neural network.

FIG. 11 illustrates schematically an example of a neural network structure in which a circular loop exists.

FIG. 12 illustrates schematically an example of an operation structure of a recurrent neural network.

FIG. 13 illustrates an example of an electromagnetic spectrum.

FIG. 14 illustrates an example of a THz communication application.

FIG. 15 illustrates an example of an electronic device-based THz wireless communication transceiver.

FIG. 16 illustrates an example of a method of generating an optical device-based THz signal.

FIG. 17 illustrates an example of an optical device-based THz wireless communication transceiver.

FIG. 18 illustrates a structure of a photoinc source-based transmitter.

FIG. 19 illustrates a structure of an optical modulator.

FIG. 20 is a diagram illustrating an example of a process of delivering qubit information through a quantum channel in a system applicable to the present disclosure.

FIG. 21 is a diagram illustrating an example of a quantum communication system classification according to a type of qubit information in the system applicable to the present disclosure.

FIG. 22 is a diagram illustrating an example of a representation of a qubit state on a Bloch sphere in the system applicable to the present disclosure.

FIG. 23 is a diagram illustrating an example of a quantum state constellation in the system applicable to the present disclosure.

FIG. 24 is a diagram illustrating a constellation of 2-QSM on the Bloch sphere in the system applicable to the present disclosure.

FIG. 25 is a diagram illustrating a constellation of 4-QSM on the Bloch sphere in the system applicable to the present disclosure.

FIG. 26 is a diagram illustrating a constellation of 4-QSM on the Bloch sphere in the system applicable to the present disclosure.

FIG. 27 is a diagram illustrating a constellation of 8-QSM on the Bloch sphere in the system applicable to the present disclosure.

FIG. 28 is a diagram illustrating a constellation of 16-QSM on the Bloch sphere in the system applicable to the present disclosure.

FIG. 29 is a diagram illustrating a constellation of 64-QSM on the Bloch sphere in the system applicable to the present disclosure.

FIG. 30 is a diagram illustrating an example of a man-in-middle attack during quantum communication in the system applicable to the present disclosure.

FIG. 31 is a diagram illustrating an example of a MAC-based authentication technique in the system applicable to the present disclosure.

FIG. 32 is a diagram illustrating an example of a Wegman & Carter Authentication (WCA) algorithm in the system applicable to the present disclosure.

FIG. 33 is a diagram illustrating an example of a collision probability based on the WCA algorithm in the system applicable to the present disclosure.

FIG. 34 is a diagram illustrating an example of a process for exchanging a quantum state generated based on a preshared key between a transmitter and a receiver using a quantum authentication (QA) header in the system applicable to the present disclosure.

FIG. 35 is a diagram illustrating an example of a process of performing an authentication between the transmitter and the receiver in the system applicable to the present disclosure.

FIG. 36 is a diagram illustrating an example of a process of performing an authentication between the transmitter and the receiver in the system applicable to the present disclosure.

FIG. 37 is a diagram illustrating an example of a process of performing an authentication between the transmitter and the receiver in the system applicable to the present disclosure.

FIG. 38 is a diagram illustrating a constellation of symmetric 4-QSM on the Bloch sphere in the system applicable to the present disclosure.

FIG. 39 is a diagram illustrating a constellation of symmetric 6-QSM on the Bloch sphere in the system applicable to the present disclosure.

FIG. 40 is a diagram illustrating a constellation of symmetric 8-QSM on the Bloch sphere in the system applicable to the present disclosure.

FIG. 41 is a diagram illustrating a constellation of symmetric 14-QSM on the Bloch sphere in the system applicable to the present disclosure.

FIG. 42 is a diagram illustrating an example of a symmetric M-QSM sender structure in the system applicable to the present disclosure.

FIG. 43 is a diagram illustrating an example of a Faraday rotator in the system applicable to the present disclosure.

FIG. 44 is a diagram illustrating an example of a symmetric M-QSM receiver structure in the system applicable to the present disclosure.

FIG. 45 is a diagram illustrating an example of a quantum state transform process in the system applicable to the present disclosure.

FIG. 46 is a diagram illustrating an example of a symmetric M-QSM based authentication procedure in the system applicable to the present disclosure.

FIG. 47 is a diagram illustrating an example of symmetric 8-QSM with half encoding in the system applicable to the present disclosure.

FIG. 48 is a diagram illustrating an example of symmetric 8-QSM with near encoding in the system applicable to the present disclosure.

FIG. 49 is a diagram illustrating an example of symmetric 8-QSM with cross encoding in the system applicable to the present disclosure.

FIG. 50 is a diagram illustrating an example of security performance analysis according to a symmetric 8-QSM case in the system applicable to the present disclosure.

FIG. 51 is a diagram illustrating an example of an operation process of a first device in the system applicable to the present disclosure.

FIG. 52 is a diagram illustrating an example of an operation process of a second device in the system applicable to the present disclosure.

FIG. 53 illustrates a communication system 1 applied to various embodiments of the present disclosure.

FIG. 54 illustrates a wireless device which may be applied to various embodiments of the present disclosure.

FIG. 55 illustrates another example of the wireless device applicable to various embodiments of the present disclosure.

FIG. 56 illustrates a signal processing circuit for a transmission signal.

FIG. 57 illustrates another example of the wireless device applied to various embodiments of the present disclosure.

FIG. 58 illustrates a hand-held device applied to various embodiments of the present disclosure.

FIG. 59 illustrates a vehicle or an autonomous vehicle applied to various embodiments of the present disclosure.

FIG. 60 illustrates the vehicle applied to various embodiments of the present disclosure.

FIG. 61 illustrates an XR device applied to various embodiments of the present disclosure.

FIG. 62 illustrates a robot applied to various embodiments of the present disclosure.

FIG. 63 illustrates an AI device applied to various embodiments of the present disclosure.

### MODE FOR DISCLOSURE

In various embodiments of the present disclosure, “A or B” may mean “only A,” “only B” or “both A and B.” In other words, in various embodiments of the present disclosure, “A or B” may be interpreted as “A and/or B.” For example, in various embodiments of the present disclosure, “A, B or C” may mean “only A,” “only B,” “only C” or “any combination of A, B and C.”

A slash (/) or comma used in various embodiments of the present disclosure may mean “and/or.” For example, “A/B” may mean “A and/or B.” Hence, “A/B” may mean “only A,” “only B” or “both A and B.” For example, “A, B, C” may mean “A, B, or C.”

In various embodiments of the present disclosure, “at least one of A and B” may mean “only A,” “only B” or “both A and B.” In addition, in various embodiments of the present disclosure, the expression of “at least one of A or B” or “at least one of A and/or B” may be interpreted in the same meaning as “at least one of A and B.”

Further, in various embodiments of the present disclosure, “at least one of A, B, and C” may mean “only A,” “only B,” “only C” or “any combination of A, B and C.” In addition, “at least one of A, B or C” or “at least one of A, B and/or C” may mean “at least one of A, B, and C.”

Further, parentheses used in various embodiments of the present disclosure may mean “for example.” Specifically, when “control information (PDCCH)” is described, “PDCCH” may be proposed as an example of “control information.” In other words, “control information” in various embodiments of the present disclosure is not limited to “PDCCH,” and “PDDCH” may be proposed as an example of “control information.” In addition, even when “control information (i.e., PDCCH)” is described, “PDCCH” may be proposed as an example of “control information.”

Technical features described individually in one drawing in various embodiments of the present disclosure may be implemented individually or simultaneously.

The following technology may be used in various radio access system including CDMA, FDMA, TDMA, OFDMA, SC-FDMA, and the like. The CDMA may be implemented as radio technology such as Universal Terrestrial Radio Access (UTRA) or CDMA2000. The TDMA may be implemented as radio technology such as a global system for mobile communications (GSM)/general packet radio service (GPRS)/enhanced data rates for GSM evolution (EDGE). The OFDMA may be implemented as radio technology such as Institute of Electrical and Electronics Engineers (IEEE) 802.11 (Wi-Fi), IEEE 802.16 (WiMAX), IEEE 802.20, Evolved UTRA (E-UTRA), or the like. The UTRA is a part of Universal Mobile Telecommunications System (UMTS). 3rd Generation Partnership Project (3GPP) Long Term Evolution (LTE) is a part of Evolved UMTS (E-UMTS) using the E-UTRA and LTE-Advanced (A)/LTE-A pro is an evolved version of the 3GPP LTE. 3GPP NR (New Radio or New Radio Access Technology) is an evolved version of the 3GPP LTE/LTE-A/LTE-A pro. 3GPP 6G may be an evolved version of 3GPP NR.

For clarity in the description, the following description will mostly focus on 3GPP communication system (e.g. LTE-A or 5G NR). However, technical features according to an embodiment of the present disclosure will not be limited only to this. LTE means technology after 3GPP TS 36.xxx Release 8. In detail, LTE technology after 3GPP TS 36.xxx Release 10 is referred to as the LTE-A and LTE technology after 3GPP TS 36.xxx Release 13 is referred to as the LTE-A pro. The 3GPP NR means technology after TS 38.xxx Release 15. The LTE/NR may be referred to as a 3GPP system. “xxx” means a detailed standard document number. The LTE/NR/6G may be collectively referred to as the 3GPP system. For terms and techniques not specifically described among terms and techniques used in the present disclosure, reference may be made to a wireless communication standard document published before the present disclosure is filed. For example, the following document may be referred to.

### 3GPP LTE

36.211: Physical channels and modulation
36.212: Multiplexing and channel coding
36.213: Physical layer procedures
36.300: Overall description
36.331: Radio Resource Control (RRC)

### 3GPP NR

38.211: Physical channels and modulation
38.212: Multiplexing and channel coding
38.213: Physical layer procedures for control
38.214: Physical layer procedures for data
38.300: NR and NG-RAN Overall Description
38.331: Radio Resource Control (RRC) protocol specification

### Physical Channel and Frame Structure

### Physical Channel and General Signal Transmission

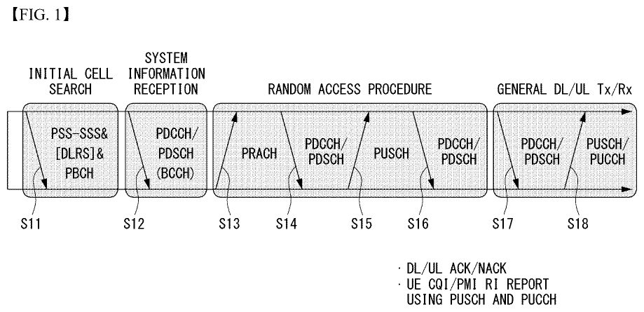

FIG. 1 illustrates an example of physical channels and general signal transmission used for the 3GPP system.

In a wireless communication system, the UE receives information from the eNB through Downlink (DL) and the UE transmits information from the eNB through Uplink (UL). The information which the eNB and the UE transmit and receive includes data and various control information and there are various physical channels according to a type/use of the information which the eNB and the UE transmit and receive.

When the UE is powered on or newly enters a cell, the UE performs an initial cell search operation such as synchronizing with the eNB (S11). To this end, the UE may receive a Primary Synchronization Signal (PSS) and a (Secondary Synchronization Signal (SSS) from the eNB and synchronize with the eNB and acquire information such as a cell ID or the like. Thereafter, the UE may receive a Physical Broadcast Channel (PBCH) from the eNB and acquire in-cell broadcast information. Meanwhile, the UE receives a Downlink Reference Signal (DL RS) in an initial cell search step to check a downlink channel status.

A UE that completes the initial cell search receives a Physical Downlink Control Channel (PDCCH) and a Physical Downlink Control Channel (PDSCH) according to information loaded on the PDCCH to acquire more specific system information (S12).

When there is no radio resource first accessing the eNB or for signal transmission, the UE may perform a Random Access Procedure (RACH) to the eNB (S13 to S16). To this end, the UE may transmit a specific sequence to a preamble through a Physical Random Access Channel (PRACH) (S13 and S15) and receive a response message (Random Access Response (RAR) message) for the preamble through the PDCCH and a corresponding PDSCH. In the case of a contention based RACH, a Contention Resolution Procedure may be additionally performed (S16).

The UE that performs the above procedure may then perform PDCCH/PDSCH reception (S17) and Physical Uplink Shared Channel (PUSCH)/Physical Uplink Control Channel (PUCCH) transmission (S18) as a general uplink/downlink signal transmission procedure. In particular, the UE may receive Downlink Control Information (DCI) through the PDCCH. Here, the DCI may include control information such as resource allocation information for the UE and formats may be differently applied according to a use purpose.

The control information which the UE transmits to the eNB through the uplink or the UE receives from the eNB may include a downlink/uplink ACK/NACK signal, a Channel Quality Indicator (CQI), a Precoding Matrix Index (PMI), a Rank Indicator (RI), and the like. The UE may transmit the control information such as the CQI/PMI/RI, etc., via the PUSCH and/or PUCCH.

### Structure of Uplink and Downlink Channels

### Downlink Channel Structure

A base station transmits a related signal to a UE via a downlink channel to be described later, and the UE receives the related signal from the base station via the downlink channel to be described later.

### (1) Physical Downlink Shared Channel (PDSCH)

A PDSCH carries downlink data (e.g., DL-shared channel transport block, DL-SCH TB) and is applied with a modulation method such as quadrature phase shift keying (QPSK), 16 quadrature amplitude modulation (QAM), 64 QAM, and 256 QAM. A codeword is generated by encoding TB. The PDSCH may carry multiple codewords. Scrambling and modulation mapping are performed for each codeword, and modulation symbols generated from each codeword are mapped to one or more layers (layer mapping). Each layer is mapped to a resource together with a demodulation reference signal (DMRS) to generate an OFDM symbol signal, and is transmitted through a corresponding antenna port.

### (2) Physical Downlink Control Channel (PDCCH)

A PDCCH carries downlink control information (DCI) and is applied with a QPSK modulation method, etc. One PDCCH consists of 1, 2, 4, 8, or 16 control channel elements (CCEs) based on an aggregation level (AL). One CCE consists of 6 resource element groups (REGs). One REG is defined by one OFDM symbol and one (P) RB.

The UE performs decoding (aka, blind decoding) on a set of PDCCH candidates to acquire DCI transmitted via the PDCCH. The set of PDCCH candidates decoded by the UE is defined as a PDCCH search space set. The search space set may be a common search space or a UE-specific search space. The UE may acquire DCI by monitoring PDCCH candidates in one or more search space sets configured by MIB or higher layer signaling.

### Uplink Channel Structure

A UE transmits a related signal to a base station via an uplink channel to be described later, and the base station receives the related signal from the UE via the uplink channel to be described later.

### (1) Physical Uplink Shared Channel (PUSCH)

A PUSCH carries uplink data (e.g., UL-shared channel transport block, UL-SCH TB) and/or uplink control information (UCI) and is transmitted based on a CP-OFDM (Cyclic Prefix-Orthogonal Frequency Division Multiplexing) waveform, DFT-s-OFDM (Discrete Fourier Transform-spread-Orthogonal Frequency Division Multiplexing) waveform, or the like. When the PUSCH is transmitted based on the DFT-s-OFDM waveform, the UE transmits the PUSCH by applying a transform precoding. For example, if the transform precoding is not possible (e.g., transform precoding is disabled), the UE may transmit the PUSCH based on the CP-OFDM waveform, and if the transform precoding is possible (e.g., transform precoding is enabled), the UE may transmit the PUSCH based on the CP-OFDM waveform or the DFT-s-OFDM waveform. The PUSCH transmission may be dynamically scheduled by an UL grant within DCI, or may be semi-statically scheduled based on high layer (e.g., RRC) signaling (and/or layer 1 (L1) signaling (e.g., PDCCH)) (configured grant). The PUSCH transmission may be performed based on a codebook or a non-codebook.

### (2) Physical Uplink Control Channel (PUCCH)

A PUCCH carries uplink control information, HARQ-ACK, and/or scheduling request (SR), and may be divided into multiple PUCCHs based on a PUCCH transmission length.

New radio access technology (RAT, NR) is described below.

As more and more communication devices require larger communication capacity, there is a need for enhanced mobile broadband communication compared to the existing radio access technology (RAT). Massive machine type communications (MTCs) which provide various services anytime and anywhere by connecting many devices and objects are also one of the major issues to be considered in next-generation communications. In addition, a communication system design considering a service/UE sensitive to reliability and latency is also being discussed. As above, the introduction of next generation radio access technology considering enhanced mobile broadband communication, massive MTC, ultra-reliable and low latency communication (URLLC), etc. is discussed, and the technology is called new RAT or NR for convenience in various embodiments of the present disclosure.

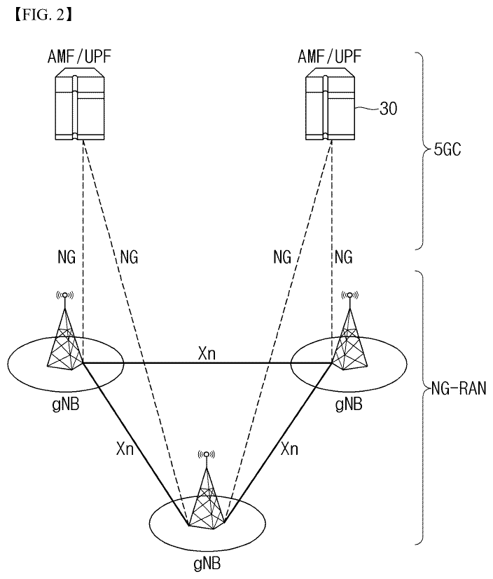

FIG. 2 illustrates system architecture of new generation radio access network (NG-RAN).

Referring to FIG. 2, the NG-RAN may include gNB and/or eNB providing user plane and control plane protocol terminations toward the UE. FIG. 2 illustrates an example where the NG-RAN includes only the gNB. The gNB and the eNB are interconnected via Xn interface. The gNB and the eNB are connected to the 5G core network (5GC) via NG interface. More specifically, the gNB and the eNB are connected to an access and mobility management function (AMF) via NG-C interface and connected to a user plane function (UPF) via NG-U interface.

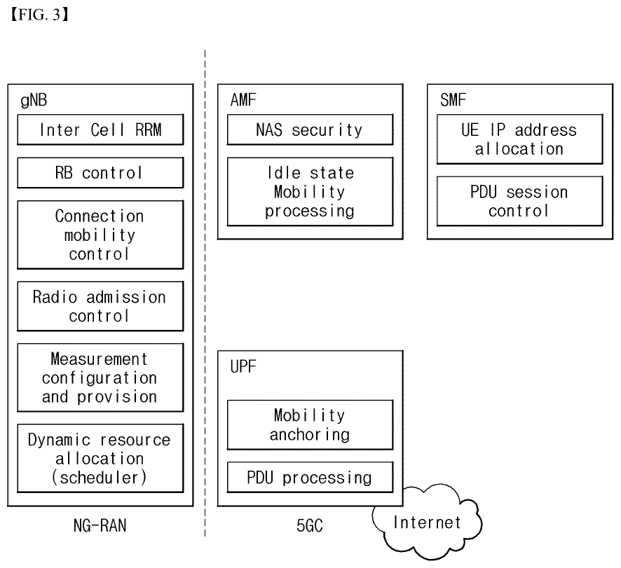

FIG. 3 illustrates functional split between NG-RAN and 5GC.

Referring to FIG. 3, the gNB may provide functions including Inter Cell RRM, RB control, connection mobility control, radio admission control, measurement configuration and provision, dynamic resource allocation, etc. The AMF may provide functions including non-access stratum (NAS) security, idle state mobility processing, etc. The UPF may provide functions including mobility anchoring, protocol data unit (PDU) processing, etc. The session management function (SMF) may provide functions including UE IP address allocation, PDU session control, etc.

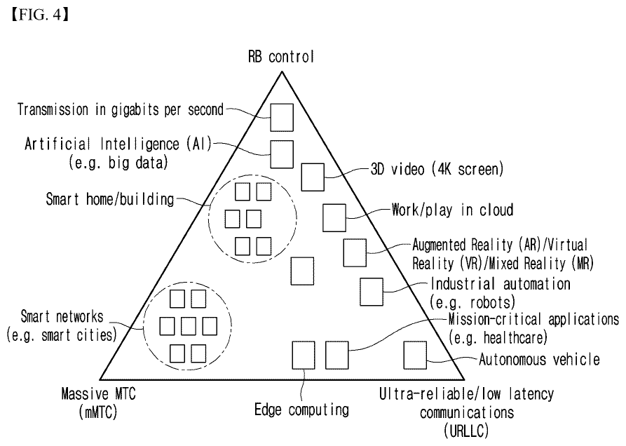

FIG. 4 illustrates an example of 5G usage scenario.

The 5G usage scenario illustrated in FIG. 4 is merely an example, and technical features according to various embodiments of the present disclosure can be applied to other 5G usage scenarios that are not illustrated in FIG. 4.

Referring to FIG. 4, three major requirement areas of 5G include (1) an enhanced mobile broadband (eMBB) area, (2) a massive machine type communication (mMTC) area and (3) an ultra-reliable and low latency communications (URLLC) area. Some use cases may require multiple areas for optimization, and other use case may focus only on one key performance indicator (KPI). 5G intends to support such diverse use cases in a flexible and reliable way.

eMBB focuses on across-the-board enhancements to the data rate, latency, user density, capacity and coverage of mobile broadband access. eMBB targets throughput of about 10 Gbps. eMBB goes far beyond basic mobile Internet access and covers rich interactive work, media and entertainment applications in the cloud or augmented reality. Data will be one of the key drivers for 5G and in new parts of this system we may for the first time see no dedicated voice service in the 5G era. In 5G, voice is expected to be handled as an application, simply using the data connectivity provided by the communication system. The main drivers for the increased traffic volume include an increase in size of content and an increase in the number of applications requiring high data transfer rates. Streaming service (audio and video), interactive video and mobile Internet connectivity will continue to be used more broadly as more devices connect to the Internet. Many of these applications require always-on connectivity to push real time information and notifications to the users. Cloud storage and applications are rapidly increasing for mobile communication platforms. This is applicable for both work and entertainment. Cloud storage is one particular use case driving the growth of uplink data transfer rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is augmented reality for entertainment and information retrieval. The augmented reality requires very low latencies and significant instant data volumes.

mMTC is designed to enable communication between devices that are low-cost, massive in number and battery-driven, and is intended to support applications such as smart metering, logistics, and field and body sensors. mMTC targets batteries with a lifespan of about 10 years and/or about 1 million devices per km2. mMTC enables to smoothly connect embedded sensors in all fields and is one of the most expected 5G use case. It is predicted that IoT devices will potentially reach 20.4 billion by 2020. Industrial IoT is one area where 5G will play a major role, enabling smart cities, asset tracking, smart utilities, agriculture, and security infrastructure.

URLLC will make it possible for devices and machines to communicate with ultra-reliability, very low latency and high availability, making it ideal for vehicular communication, industrial control, factory automation, remote surgery, smart grids and public safety applications. URLLC targets latency of about 1 ms. URLLC includes new services that will transform industries with ultra-reliable/low latency links like remote control of critical infrastructure and an autonomous vehicle. The level of reliability and latency is vital to smart grid control, industrial automation, robotics, and drone control and coordination.

Next, multiple use cases included within the triangle of FIG. 4 are described in more detail.

5G may supplement fiber-to-the-home (FTTH) and cable-based broadband (or DOCSIS) as means for providing a stream evaluated from gigabits per second to several hundreds of megabits per second. Such fast speed may be necessary to deliver TV with resolution of 4K or more (6K, 8K or more) in addition to virtual reality (VR) and augmented reality (AR). VR and AR applications include immersive sports games. A specific application may require special network configuration. For example, in the VR game, in order for game companies to minimize latency, a core server may need to be integrated with an edge network server of a network operator.

The automotive sector is expected to be an important new driver for 5G, along with many use cases for mobile communications for vehicles. For example, entertainment for passengers requires high capacity and high mobile broadband at the same time. The reason for this is that future users will expect to continue their good quality connection independent of their location and speed. Other use cases for the automotive sector are augmented reality dashboards. The augmented reality dashboards display overlay information on top of what a driver is seeing through the front window through the augmented reality dashboards, identifying objects in the dark and telling the driver about the distances and movements of the objects. In the future, wireless modules will enable communication between vehicles, information exchange between vehicles and supporting infrastructure, and information exchange between vehicles and other connected devices (e.g., devices carried by pedestrians). Safety systems guide drivers on alternative courses of action to allow them to drive more safely and lower the risks of accidents. A next phase will be a remotely controlled vehicle or an autonomous vehicle. This requires ultra reliable and very fast communication between different autonomous vehicles and/or between vehicles and infrastructure. In the future, an autonomous vehicle may take care of all driving activity, allowing the driver to rest and concentrate only on traffic anomalies that the vehicle itself cannot identify. The technical requirements for autonomous vehicles require for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost and energy-efficient maintenance of the city or home. A similar setup can be done for each home, where temperature sensors, window and heating controllers, burglar alarms and home appliances are all connected wirelessly. Many of these sensors are typically low data rate, low power and low cost. However, for example, real time HD video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information can include the behaviors of suppliers and consumers, allowing the smart grid to improve the efficiency, reliability, economics and sustainability of the production and distribution of fuels such as electricity in an automated fashion. A smart grid can be seen as another sensor network with low delays.

The health sector has many applications that can benefit from mobile communications. Communications systems enable telemedicine, which provides clinical health care at a distance. It helps eliminate distance barriers and can improve access to medical services that would often not be consistently available in distant rural communities. It is also used to save lives in critical care and emergency situations. Wireless sensor networks based on mobile communication can provide remote monitoring and sensors for parameters such as heart rate and blood pressure.

Wireless and mobile communications are becoming increasingly important for industrial application. Wires are expensive to install and maintain. Therefore, the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G.

Logistics and freight tracking are important use cases for mobile communications that enable the tracking of inventory and packages wherever they are through using location based information systems. The logistics and freight use cases typically require lower data rates but need wide coverage and reliable location information.

Examples of next generation communication (e.g., 6G) that can be applied to various embodiments of the present disclosure are described below.

### 6G System General

A 6G (wireless communication) system has purposes such as (i) a very high data rate per device, (ii) a very large number of connected devices, (iii) global connectivity, (iv) a very low latency, (v) a reduction in energy consumption of battery-free IoT devices, (vi) ultra-reliable connectivity, and (vii) connected intelligence with machine learning capability. The vision of the 6G system may include four aspects such as intelligent connectivity, deep connectivity, holographic connectivity, and ubiquitous connectivity, and the 6G system may satisfy the requirements shown in Table 1 below. That is, Table 1 shows an example of the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

The 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion, and enhanced data security.

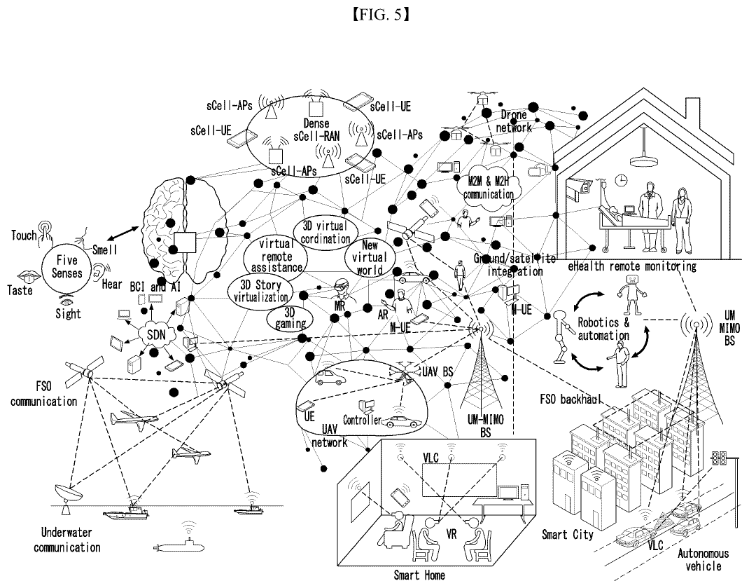

FIG. 5 illustrates an example of a communication structure providable in a 6G system.

The 6G system is expected to have 50 times greater simultaneous wireless communication connectivity than a 5G wireless communication system. URLLC, which is the key feature of 5G, will become more important technology by providing an end-to-end latency less than 1 ms in 6G communication. The 6G system may have much better volumetric spectrum efficiency unlike frequently used domain spectrum efficiency. The 6G system can provide advanced battery technology for energy harvesting and very long battery life, and thus mobile devices may not need to be separately charged in the 6G system. In 6G, new network characteristics may be as follows.
Satellites integrated network: To provide a global mobile group, 6G will be integrated with satellite. Integration of terrestrial, satellite and public networks into one wireless communication system is critical for 6G.
Connected intelligence: Unlike the wireless communication systems of previous generations, 6G is innovative and may update wireless evolution from “connected things” to “connected intelligence”. AI may be applied in each step (or each signal processing procedure to be described later) of a communication procedure.
Seamless integration of wireless information and energy transfer: A 6G wireless network may transfer power to charge batteries of devices such as smartphones and sensors. Therefore, wireless information and energy transfer (WIET) will be integrated.
Ubiquitous super 3D connectivity: Access to networks and core network functions of drone and very low earth orbit satellite will establish super 3D connectivity in 6G ubiquitous.

In the new network characteristics of 6G described above, several general requirements may be as follows.
Small cell networks: The idea of a small cell network has been introduced to improve received signal quality as a result of throughput, energy efficiency, and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network consisting of heterogeneous networks improves overall QoS and reduces costs.
High-capacity backhaul: Backhaul connectivity is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability. Further, billions of devices can be shared on a shared physical infrastructure.

### Core Implementation Technology of 6G System

### Artificial Intelligence (AI)

Technology which is most important in the 6G system and will be newly introduced is AI. AI was not involved in the 4G system. The 5G system will support partial or very limited AI. However, the 6G system will support AI for full automation. Advance in machine learning will create a more intelligent network for real-time communication in 6G. When AI is introduced to communication, real-time data transmission can be simplified and improved. AI may determine a method of performing complicated target tasks using countless analysis. That is, AI can increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, and in particular, deep learning has been focused on the wireless resource management and allocation field. However, such studies have been gradually developed to the MAC layer and the physical layer, and in particular, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimation and channel tracking and may be used for power allocation, interference cancellation, etc. in the physical layer of DL. The machine learning may also be used for antenna selection, power control, symbol detection, etc. in the MIMO system.

However, application of a deep neutral network (DNN) for transmission in the physical layer may have the following problems.

A deep learning based AI algorithm requires a lot of training data in order to optimize training parameters. However, due to limitations in acquiring data in a specific channel environment as the training data, a lot of training data is used offline. Static training for the training data in the specific channel environment may cause a contradiction between the diversity and dynamic characteristics of a radio channel.

Currently, the deep learning mainly targets real signals. However, signals of the physical layer of wireless communication are complex signals. For matching of the characteristics of a wireless communication signal, studies on a neural network for detecting a complex domain signal are further required.

Hereinafter, machine learning is described in more detail.

Machine learning refers to a series of operations to train a machine in order to create a machine capable of doing tasks that people cannot do or are difficult for people to do. Machine learning requires data and learning models. In the machine learning, a data learning method may be roughly divided into three methods, that is, supervised learning, unsupervised learning and reinforcement learning.

Neural network learning is to minimize an output error. The neural network learning refers to a process of repeatedly inputting training data to a neural network, calculating an error of an output and a target of the neural network for the training data, backpropagating the error of the neural network from an output layer to an input layer of the neural network for the purpose of reducing the error, and updating a weight of each node of the neural network.

The supervised learning may use training data labeled with a correct answer, and the unsupervised learning may use training data which is not labeled with a correct answer. That is, for example, in supervised learning for data classification, training data may be data in which each training data is labeled with a category. The labeled training data may be input to the neural network, and the error may be calculated by comparing the output (category) of the neural network with the label of the training data. The calculated error is backpropagated in the neural network in the reverse direction (i.e., from the output layer to the input layer), and a connection weight of respective nodes of each layer of the neural network may be updated based on the backpropagation. Change in the updated connection weight of each node may be determined depending on a learning rate. The calculation of the neural network for input data and the backpropagation of the error may construct a learning cycle (epoch). The learning rate may be differently applied based on the number of repetitions of the learning cycle of the neural network. For example, in the early stage of learning of the neural network, efficiency can be increased by allowing the neural network to rapidly ensure a certain level of performance using a high learning rate, and in the late of learning, accuracy can be increased using a low learning rate.

The learning method may vary depending on the feature of data. For example, in order for a reception end to accurately predict data transmitted from a transmission end on a communication system, it is preferable that learning is performed using the supervised learning rather than the unsupervised learning or the reinforcement learning.

The learning model corresponds to the human brain and may be regarded as the most basic linear model. However, a paradigm of machine learning using, as the learning model, a neural network structure with high complexity, such as artificial neural networks, is referred to as deep learning.

Neural network cores used as the learning method may roughly include a deep neural network (DNN) method, a convolutional deep neural network (CNN) method, and a recurrent Boltzmann machine (RNN) method.

The artificial neural network is an example of connecting several perceptrons.

FIG. 6 illustrates an example of a structure of a perceptron.

Referring to FIG. 6, when an input vector x=(x1, x2, . . . , xd) is input, each component is multiplied by a weight (W1, W2, . . . , Wd), and all the results are summed. After that, the entire process of applying an activation function σ(·) is called a perceptron. The huge artificial neural network structure may extend the simplified perceptron structure illustrated in FIG. 6 to apply the input vector to different multidimensional perceptrons. For convenience of explanation, an input value or an output value is referred to as a node.

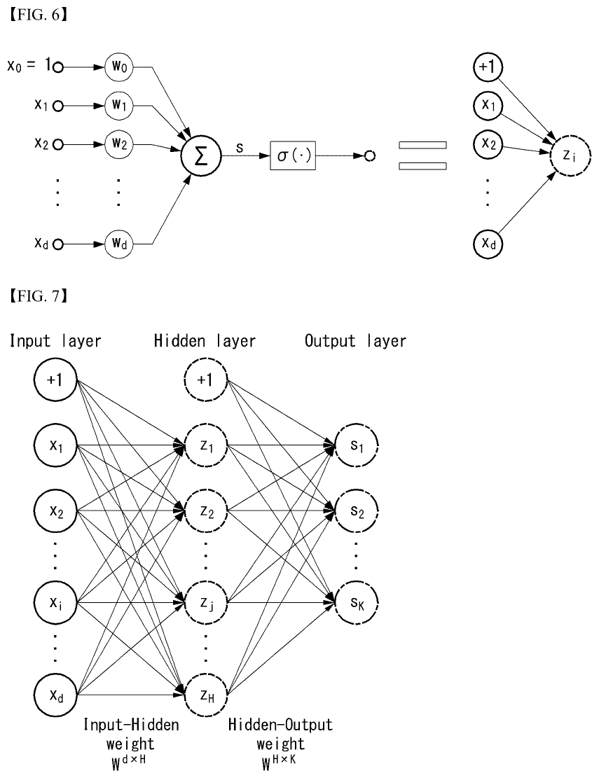

The perceptron structure illustrated in FIG. 6 may be described as consisting of a total of three layers based on the input value and the output value. FIG. 7 illustrates an artificial neural network in which the number of (d+1) dimensional perceptrons between a first layer and a second layer is H, and the number of (H+1) dimensional perceptrons between the second layer and a third layer is K, by way of example.

FIG. 7 illustrates an example of a structure of a multilayer perceptron.

A layer where the input vector is located is called an input layer, a layer where a final output value is located is called an output layer, and all layers located between the input layer and the output layer are called a hidden layer. FIG. 7 illustrates three layers, by way of example. However, since the number of layers of the artificial neural network is counted excluding the input layer, it can be seen as a total of two layers. The artificial neural network is constructed by connecting the perceptrons of a basic block in two dimensions.

The above-described input layer, hidden layer, and output layer can be jointly applied in various artificial neural network structures, such as CNN and RNN to be described later, as well as the multilayer perceptron. The greater the number of hidden layers, the deeper the artificial neural network is, and a machine learning paradigm that uses the sufficiently deep artificial neural network as a learning model is called deep learning. In addition, the artificial neural network used for deep learning is called a deep neural network (DNN).

FIG. 8 illustrates an example of a deep neural network.

The deep neural network illustrated in FIG. 8 is a multilayer perceptron consisting of eight hidden layers+eight output layers. The multilayer perceptron structure is expressed as a fully connected neural network. In the fully connected neural network, a connection relationship does not exist between nodes located at the same layer, and a connection relationship exists only between nodes located at adjacent layers. The DNN has a fully connected neural network structure and is composed of a combination of multiple hidden layers and activation functions, so it can be usefully applied to understand correlation characteristics between input and output. The correlation characteristic may mean a joint probability of input and output.

Based on how the plurality of perceptrons are connected to each other, various artificial neural network structures different from the above-described DNN can be formed.

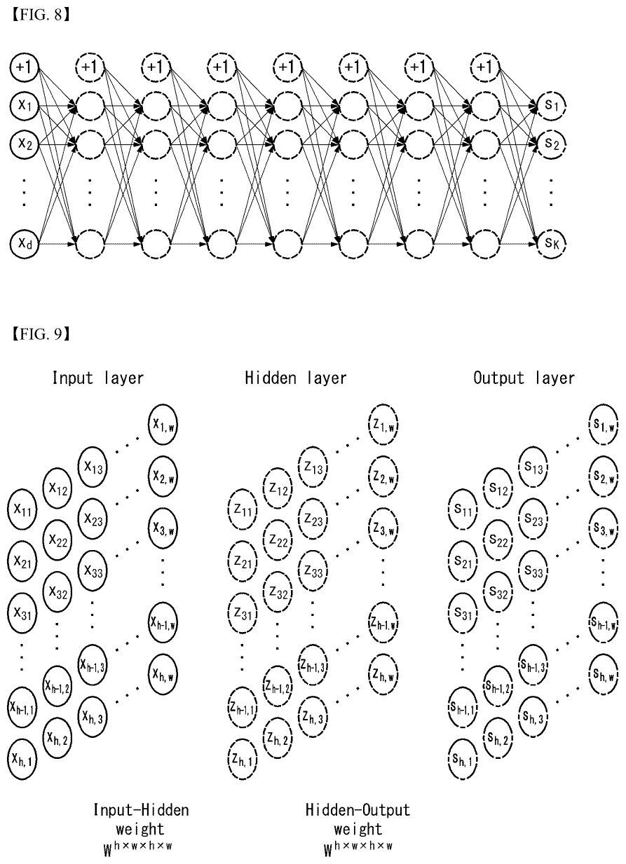

FIG. 9 illustrates an example of a structure of a convolutional neural network.

In the DNN, nodes located inside one layer are arranged in a one-dimensional longitudinal direction. However, in FIG. 9, it may be assumed that w nodes horizontally and h nodes vertically are arranged in two dimensions (convolutional neural network structure of FIG. 9). In this case, since in a connection process leading from one input node to the hidden layer, a weight is given for each connection, a total of h×w weights needs to be considered. Since there are h×w nodes in the input layer, a total of h2w2 weights are required between two adjacent layers.

The convolutional neural network of FIG. 9 has a problem in that the number of weights increases exponentially depending on the number of connections. Therefore, instead of considering the connections of all the nodes between adjacent layers, it is assumed that a small-sized filter exists, and a weighted sum and an activation function calculation are performed on an overlap portion of the filters as illustrated in FIG. 10.

FIG. 10 illustrates an example of a filter operation of a convolutional neural network.

One filter has a weight corresponding to the number as much as its size, and learning of the weight may be performed so that a certain feature on an image can be extracted and output as a factor. In FIG. 10, a filter having a size of 3×3 is applied to the upper leftmost 3×3 area of the input layer, and an output value obtained by performing a weighted sum and an activation function calculation for a corresponding node is stored in z22.

The filter performs the weighted sum and the activation function calculation while moving horizontally and vertically by a predetermined interval when scanning the input layer, and places the output value at a location of a current filter. This calculation method is similar to the convolution operation on images in the field of computer vision. Thus, a deep neural network with this structure is referred to as a convolutional neural network (CNN), and a hidden layer generated as a result of the convolution operation is referred to as a convolutional layer. In addition, a neural network in which a plurality of convolutional layers exists is referred to as a deep convolutional neural network (DCNN).

At the node where a current filter is located at the convolutional layer, the number of weights may be reduced by calculating a weighted sum including only nodes located in an area covered by the filter. Hence, one filter can be used to focus on features for a local area. Accordingly, the CNN can be effectively applied to image data processing in which a physical distance on the 2D area is an important criterion. In the CNN, a plurality of filters may be applied immediately before the convolution layer, and a plurality of output results may be generated through a convolution operation of each filter.

There may be data whose sequence characteristics are important depending on data attributes. A structure, in which a method of inputting one element on the data sequence at each time step considering a length variability and a relationship of the sequence data and inputting an output vector (hidden vector) of a hidden layer output at a specific time step together with a next element on the data sequence is applied to the artificial neural network, is referred to as a recurrent neural network structure.

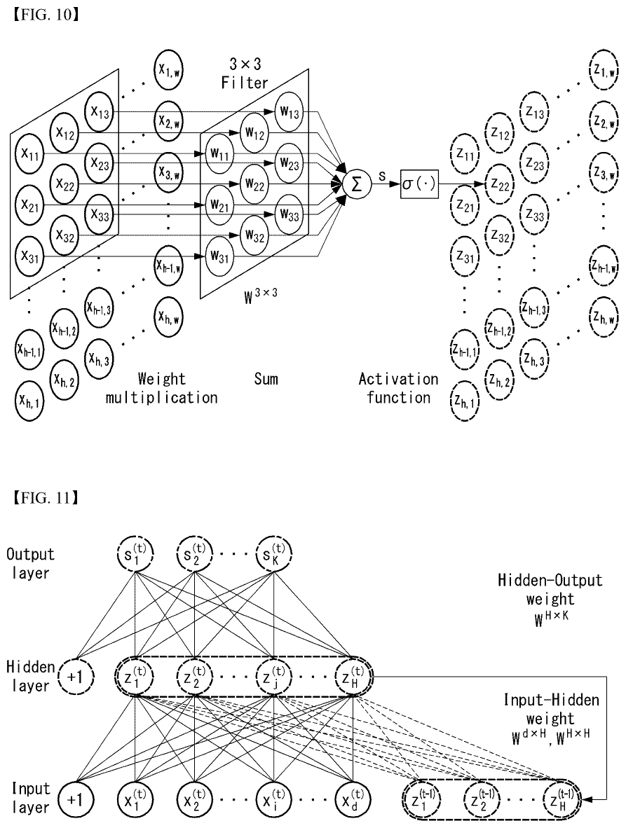

FIG. 11 illustrates an example of a neural network structure in which a circular loop exists.

Referring to FIG. 11, a recurrent neural network (RNN) is a structure in which in a process of inputting elements (x1(t), x2(t), . . . , xd(t)) of any line of sight ‘t’ on a data sequence to a fully connected neural network, hidden vectors (z1(t−1), z2(t−1), . . . , zH(t−1)) are input together at an immediately previous time step (t−1) to apply a weighted sum and an activation function. A reason for transferring the hidden vectors at a next time step is that information within the input vector in previous time steps is considered to be accumulated on the hidden vectors of a current time step.

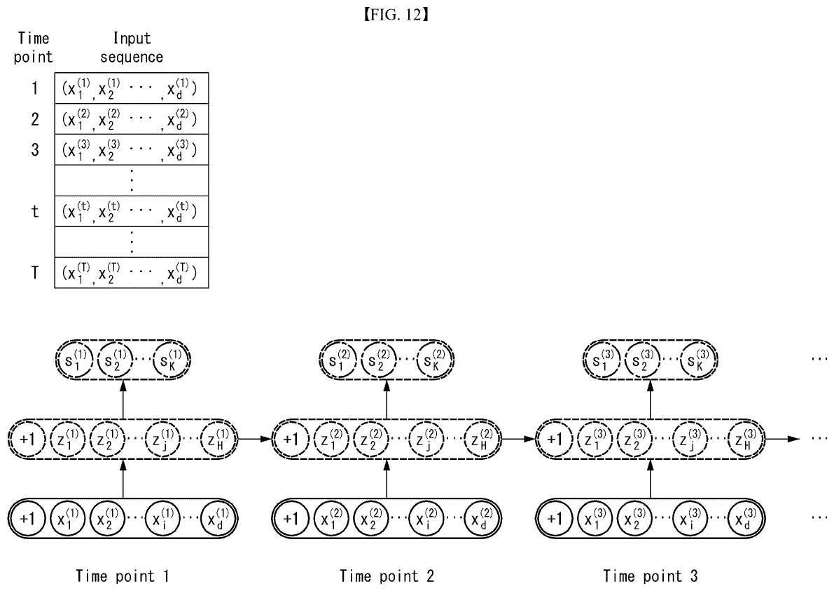

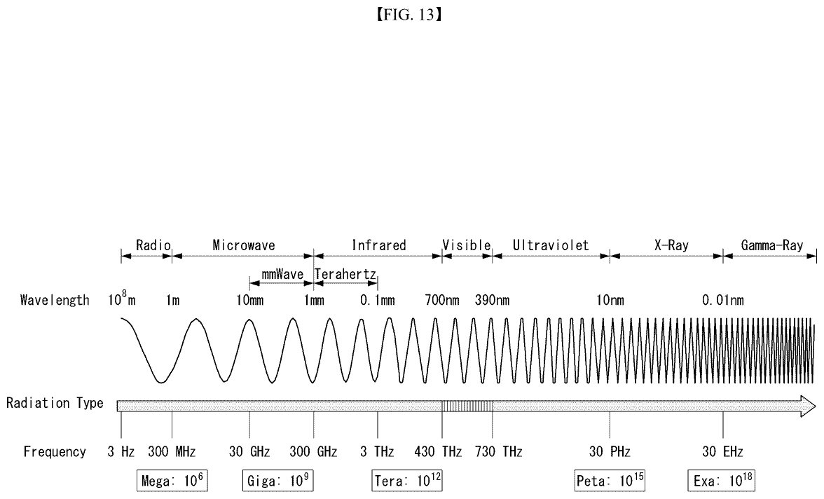

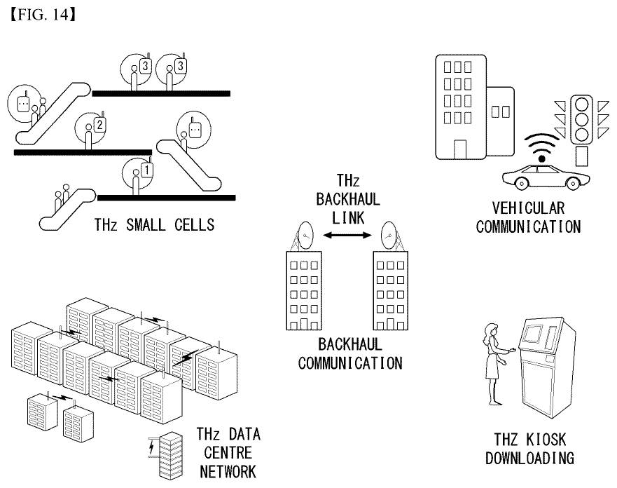

FIG. 12 illustrates an example of an operation structure of a recurrent neural network.

Referring to FIG. 12, the recurrent neural network operates in a predetermined order of time with respect to an input data sequence.

Hidden vectors (z1(1), z2(1), . . . , zH(1)) when input vectors (x1(t), x2(t), . . . , xd(t)) at a time step 1 are input to the recurrent neural network, are input together with input vectors (x1(2), x2(2), . . . , xd(2)) at a time step 2 to determine vectors (z1(2), z2(2), . . . , zH(2)) of a hidden layer through a weighted sum and an activation function. This process is repeatedly performed at time steps 2, 3, . . . , T.

When a plurality of hidden layers are disposed in the recurrent neural network, this is referred to as a deep recurrent neural network (DRNN). The recurrent neural network is designed to be usefully applied to sequence data (e.g., natural language processing).

A neural network core used as a learning method includes various deep learning methods such as a restricted Boltzmann machine (RBM), a deep belief network (DBN), and a deep Q-network, in addition to the DNN, the CNN, and the RNN, and may be applied to fields such as computer vision, speech recognition, natural language processing, and voice/signal processing.

Recently, attempts to integrate AI with a wireless communication system have appeared, but this has been concentrated in the field of wireless resource management and allocation in the application layer, network layer, in particular, deep learning. However, such research is gradually developing into the MAC layer and the physical layer, and in particular, attempts to combine deep learning with wireless transmission in the physical layer have appeared. The AI-based physical layer transmission refers to applying a signal processing and communication mechanism based on an AI driver, rather than a traditional communication framework in the fundamental signal processing and communication mechanism. For example, deep learning-based channel coding and decoding, deep learning-based signal estimation and detection, deep learning-based MIMO mechanism, AI-based resource scheduling and allocation, and the like, may be included.

### Terahertz (THz) Communication

A data transfer rate can be increased by increasing the bandwidth. This can be performed by using sub-TH communication as a wide bandwidth and applying advanced massive MIMO technology. THz waves, which are known as sub-millimeter radiation, generally indicate a frequency band between 0.1 THz and 10 THz with the corresponding wavelengths in the range of 0.03 mm-3 mm. A band range of 100 GHz to 300 GHz (sub THz band) is regarded as a main part of the THz band for cellular communication. When the sub-THz band is added to the mmWave band, the 6G cellular communication capacity increases. 300 GHz-3 THz among the defined THz band is in a far infrared (IR) frequency band. Although the 300 GHz-3 THz band is part of the optical band, it is at the border of the optical band and is immediately after the RF band. Therefore, this 300 GHz-3 THz band shows similarity with RF.

FIG. 13 illustrates an example of an electromagnetic spectrum.

The main characteristics of THz communication include (i) a bandwidth widely available to support a very high data transfer rate and (ii) a high path loss occurring at a high frequency (a high directional antenna is indispensable). A narrow beam width generated in the high directional antenna reduces interference. The small wavelength of a THz signal allows a larger number of antenna elements to be integrated with a device and BS operating in this band. Through this, an advanced adaptive arrangement technology capable of overcoming a range limitation can be used.

### Optical Wireless Technology

Optical wireless communication (OWC) technologies are envisioned for 6G communication in addition to RF based communications for all possible device-to-access networks. These networks access network-to-backhaul/fronthaul network connectivity. The OWC technologies have already been used since 4G communication systems, but will be used more widely to meet the demands of the 6G communication system. The OWC technologies, such as light fidelity, visible light communication, optical camera communication, and FSO communication based on the optical band, are already well-known technologies. Communications based on wireless optical technologies can provide very high data rates, low latencies, and secure communications. LiDAR, which is also based on the optical band, is a promising technology for very high-resolution 3D mapping in 6G communications.

### ESO Backhaul Network

Characteristics of a transmitter and a receiver of the FSO system are similar to characteristics of an optical fiber network. Therefore, data transmission of the FSO system similar to that of the optical fiber system. Accordingly, FSO can be a good technology for providing backhaul connectivity in the 6G system along with the optical fiber network. If FSO is used, very long-distance communication is possible even at a distance of 10,000 km or more. FSO supports massive backhaul connectivity for remote and non-remote areas such as sea, space, underwater, and isolated islands. FSO also supports cellular BS connectivity.

### Massive MIMO Technology

One of core technologies for improving spectral efficiency is to apply MIMO technology. When the MIMO technology is improved, the spectral efficiency is also improved. Therefore, massive MIMO technology will be important in the 6G system. Since the MIMO technology uses multiple paths, multiplexing technology and beam generation and management technology suitable for the THz band should be significantly considered so that data signals can be transmitted through one or more paths.

### Block Chain

A block chain will be an important technology for managing large amounts of data in future communication systems. The block chain is a form of distributed ledger technology, and the distributed ledger is a database distributed across numerous nodes or computing devices. Each node duplicates and stores the same copy of the ledger. The block chain is managed by a P2P network. This may exist without being managed by a centralized institution or server. Block chain data is collected together and is organized into blocks. The blocks are connected to each other and protected using encryption. The block chain completely complements large-scale IoT through improved interoperability, security, privacy, stability, and scalability. Accordingly, the block chain technology provides several functions such as interoperability between devices, high-capacity data traceability, autonomous interaction of different IoT systems, and large-scale connection stability of 6G communication systems.

### 3D Networking

The 6G system integrates the ground and air networks to support communications for users in the vertical extension. The 3D BSs will be provided by low-orbit satellites and UAVs. The addition of new dimensions in terms of height and the associated degrees of freedom makes 3D connectivity significantly different from traditional 2D networks.

### Quantum Communication

Unsupervised reinforcement learning in networks is promising in the context of 6G networks. Supervised learning approaches will not be practical for labeling large amounts of data generated in 6G. Unsupervised learning does not require labeling. Therefore, this technique can be used to create the representations of complex networks autonomously. By combining reinforcement learning and unsupervised learning, it is possible to operate the network truly autonomously.

### Unmanned Aerial Vehicle

An unmanned aerial vehicle (UAV) or drone will be an important factor in 6G wireless communication. In most cases, a high-speed data wireless connection is provided using UAV technology. A BS entity is installed in the UAV to provide cellular connectivity. The UAVs have specific features, which are not found in fixed BS infrastructures, such as easy deployment, strong line-of-sight links, and mobility-controlled degrees of freedom. During emergencies such as natural disasters, the deployment of terrestrial telecommunications infrastructure is not economically feasible and sometimes services cannot be provided in volatile environments. The UAV can easily handle this situation. The UAV will be a new paradigm in the field of wireless communications. This technology facilitates the three basic requirements of wireless networks, such as eMBB, URLLC, and mMTC. The UAV can also support a number of purposes, such as network connectivity improvement, fire detection, disaster emergency services, security and surveillance, pollution monitoring, parking monitoring, and accident monitoring. Therefore, UAV technology is recognized as one of the most important technologies for 6G communication.

### Cell-Free Communication

The tight integration of multiple frequencies and different communication technologies is very important in 6G systems. As a result, the user can move seamlessly from one network to another network without the need for making any manual configurations in the device. The best network is automatically selected from the available communication technology. This will break the limits of the concept of cells in wireless communications. Currently, the user's movement from one cell to another cell causes too many handovers in dense networks, and also causes handover failures, handover delays, data losses, and the ping-pong effect. The 6G cell-free communications will overcome all these and provide better QoS. Cell-free communication will be achieved through multi-connectivity and multi-tier hybrid techniques and by different and heterogeneous radios in the devices.

### Integration of Wireless Information and Energy Transfer (WIET)

WIET uses the same field and wave as a wireless communication system. In particular, a sensor and a smartphone will be charged using wireless power transfer during communication. WIET is a promising technology for extending the life of battery charging wireless systems. Therefore, devices without battery will be supported in 6G communication.

### Integration of Sensing and Communication

An autonomous wireless network is a function for continuously detecting a dynamically changing environment state and exchanging information between different nodes. In 6G, sensing will be tightly integrated with communication to support autonomous systems.

### Integration of Access Backhaul Network

In 6G, the density of access networks will be enormous. Each access network is connected by optical fiber and backhaul connectivity such as FSO network. To cope with a very large number of access networks, there will be a tight integration between the access and backhaul networks.

### Hologram Beamforming

Beamforming is a signal processing procedure that adjusts an antenna array to transmit radio signals in a specific direction. This is a subset of smart antennas or advanced antenna systems. Beamforming technology has several advantages, such as high signal-to-noise ratio, interference prevention and rejection, and high network efficiency. Hologram beamforming (HBF) is a new beamforming method that differs significantly from MIMO systems because this uses a software-defined antenna. HBF will be a very effective approach for efficient and flexible transmission and reception of signals in multi-antenna communication devices in 6G.

### Big Data Analysis

Big data analysis is a complex process for analyzing various large data sets or big data. This process finds information such as hidden data, unknown correlations, and customer disposition to ensure complete data management. Big data is collected from various sources such as video, social networks, images and sensors. This technology is widely used for processing massive data in the 6G system.

### Large Intelligent Surface (LIS)

In the THz band signal, since the straightness is strong, there may be many shaded areas due to obstacles. By installing the LIS near these shaded areas, LIS technology, that expands a communication area, enhances communication stability, and enables additional optional services, becomes important. The LIS is an artificial surface made of electromagnetic materials, and can change propagation of incoming and outgoing radio waves. The LIS can be viewed as an extension of massive MIMO, but is different from the massive MIMO in an array structure and an operating mechanism. Further, the LIS has an advantage such as low power consumption, because this operates as a reconfigurable reflector with passive elements, that is, signals are only passively reflected without using active RF chains. In addition, since each of the passive reflectors of the LIS has to independently adjust the phase shift of an incident signal, this may be advantageous for wireless communication channels. By properly adjusting the phase shift through an LIS controller, the reflected signal can be collected at a target receiver to boost the received signal power.

### Terahertz (THz) Wireless Communication General

THz wireless communication uses wireless communication using a THz wave having a frequency of approximately 0.1 to 10 THz (1 THz=1012 Hz) and may refer to THz band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays, has a shorter wavelength than the RF/millimeter wave to have high straightness, and is capable of beam convergence. In addition, the photon energy of the THz wave is only a few meV and thus is harmless to the human body. A frequency band which is expected to be used for THz wireless communication may be D-band (110 GHz to 170 GHz) or H-band (220 GHz to 325 GHz) band with a low propagation loss due to molecular absorption in air. Standardization discussion on THz wireless communication is being discussed mainly in IEEE 802.15 THz working group in addition to 3GPP, and standard documents issued by a task group of IEEE 802.15 (e.g., TG3d, TG3e) can specify and supplement the description of the present disclosure. The THz wireless communication may be applied to wireless cognition, sensing, imaging, wireless communication, THz navigation, etc.

FIG. 14 illustrates an example of a THz communication application.

As illustrated in FIG. 14, a THz wireless communication scenario may be classified into a macro network, a micro network, and a nanoscale network. In the macro network, THz wireless communication may be applied to vehicle-to-vehicle connectivity and backhaul/fronthaul connectivity. In the micro network, THz wireless communication may be applied to near-field communication such as indoor small cells, fixed point-to-point or multi-point connection such as wireless connection in a data center, and kiosk downloading.

Table 2 below shows an example of technology which can be used in the THz wave.

TABLE 2

| | |
|---|---|
| Transceivers Device | Available immature: UTC-PD, RTD and SBD |
| Modulation and coding | Low order modulation techniques (OOK, QPSK), |
| | LDPC, Reed Soloman, Hamming, Polar, Turbo |
| Antenna | Omni and Directional, phased array with low |
| | number of antenna elements |
| Bandwidth | 69 GHz (or 23 GHz) at 300 GHz |
| Channel models | Partially |
| Data rate | 100 Gbps |
| Outdoor deployment | No |
| Free space loss | High |
| Coverage | Low |
| Radio Measurements | 300 GHz indoor |
| Device size | Few micrometers |

THz wireless communication can be classified based on a method for generating and receiving THz. The method of generating THz can be classified as an optical device or an electronic device-based technology.

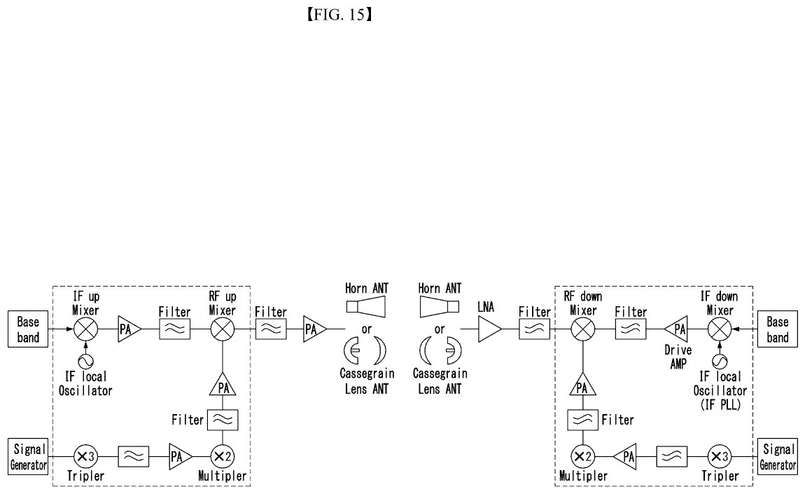

FIG. 15 illustrates an example of an electronic device-based THz wireless communication transceiver.

The method of generating THz using an electronic device includes a method using a semiconductor device such as a resonant tunneling diode (RTD), a method using a local oscillator and a multiplier, a monolithic microwave integrated circuit (MMIC) method using a compound semiconductor high electron mobility transistor (HEMT) based integrated circuit, a method using a Si-CMOS based integrated circuit, and the like. In FIG. 15, a multiplier (e.g., doubler, tripler) is applied to increase the frequency, and radiation is performed by an antenna via a subharmonic mixer. Since the THz band forms a high frequency, the multiplier is essential. Here, the multiplier is a circuit that allows the frequency to have an output frequency which is N times an input frequency, and the multiplier matches a desired harmonic frequency and filters out all the remaining frequencies. In addition, beamforming may be implemented by applying an array antenna or the like to the antenna of FIG. 15. In FIG. 15, IF denotes an intermediate frequency, a tripler and a multiplier denote a multiplier, PA denotes a power amplifier, LNA denotes a low noise amplifier, and PLL denotes a phase-locked loop.

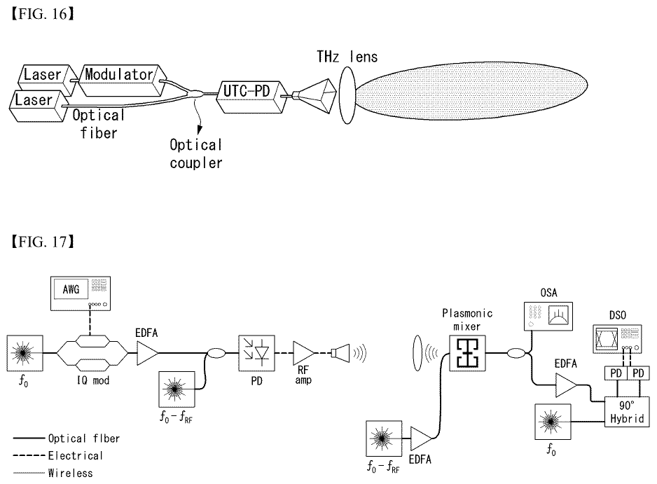

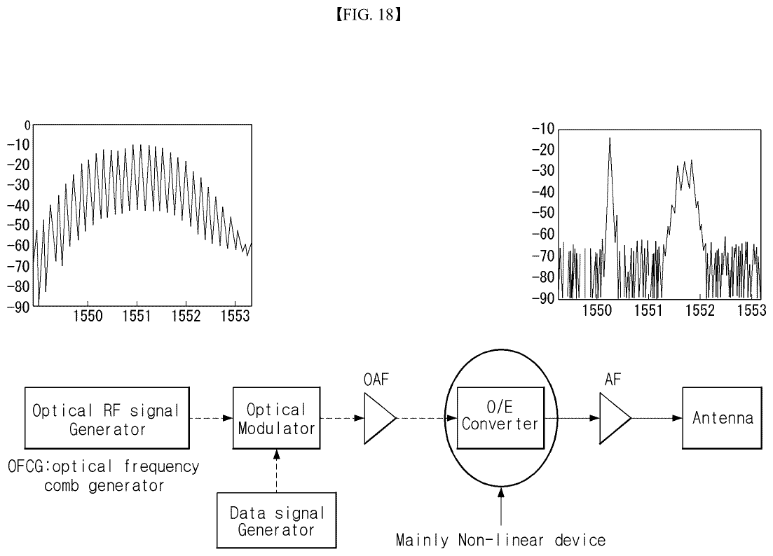

FIG. 16 illustrates an example of a method of generating an optical device-based THz signal.

FIG. 17 illustrates an example of an optical device-based THz wireless communication transceiver.

The optical device-based THz wireless communication technology refers to a method of generating and modulating a THz signal using an optical device. The optical device-based THz signal generation technology refers to a technology that generates an ultrahigh-speed optical signal using a laser and an optical modulator and converts it into a THz signal using an ultrahigh-speed photodetector. This technology is easy to increase the frequency compared to the technology using only the electronic device, can generate a high-power signal, and can obtain a flat response characteristic in a wide frequency band. In order to generate the optical device-based THz signal, as illustrated in FIG. 16, a laser diode, a broadband optical modulator, and an ultrahigh-speed photodetector are required. In FIG. 16, light signals of two lasers having different wavelengths are combined to generate a THz signal corresponding to difference in a wavelength between the lasers. In FIG. 16, an optical coupler refers to a semiconductor device that transmits an electrical signal using light waves to provide coupling with electrical isolation between circuits or systems, and a uni-travelling carrier photo-detector (UTC-PD) is one of photodetectors, which uses electrons as an active carrier and reduces the travel time of electrons by bandgap grading. The UTC-PD is capable of photodetection at 150 GHz or more. In FIG. 17, an erbium-doped fiber amplifier (EDFA) denotes an optical fiber amplifier to which erbium is added, a photo detector (PD) denotes a semiconductor device capable of converting an optical signal into an electrical signal, and OSA denotes an optical sub assembly in which various optical communication functions (e.g., photoelectric conversion, electrophotic conversion, etc.) are modularized as one component, and DSO denotes a digital storage oscilloscope.

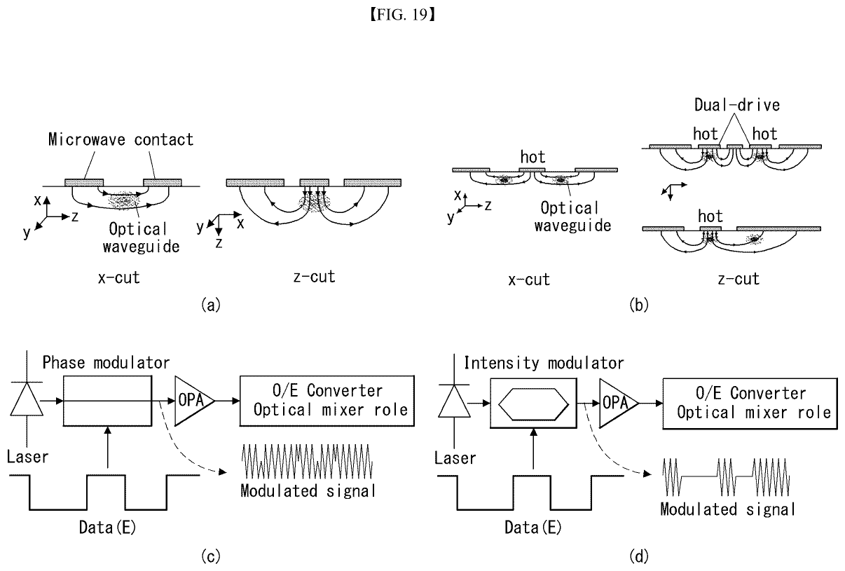

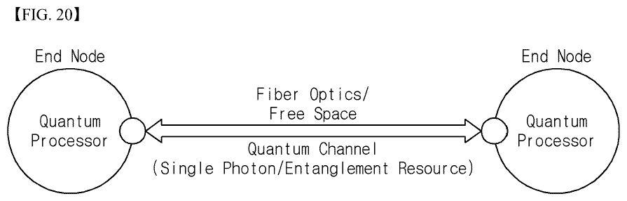

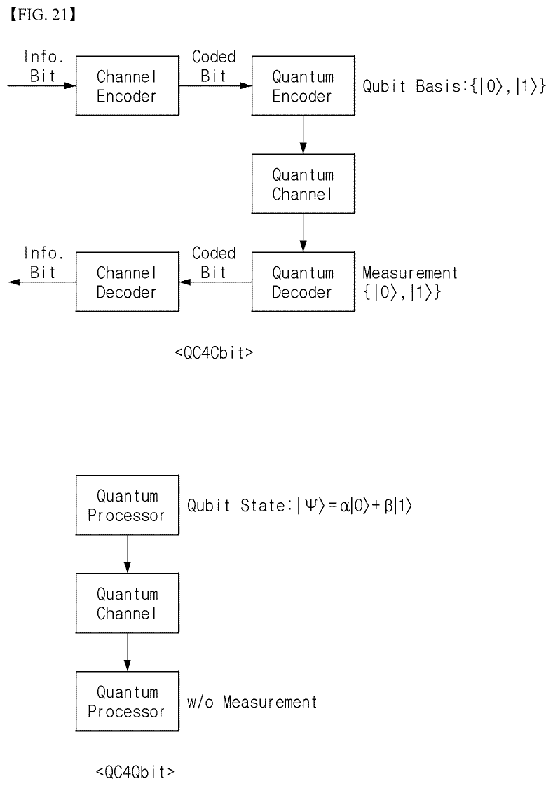

A structure of a photoelectric converter is described with reference to FIGS. 18 and 19.

FIG. 18 illustrates a structure of a photoinc source-based transmitter.

FIG. 19 illustrates a structure of an optical modulator.

Generally, an optical source of a laser may change a phase of a signal by passing through an optical wave guide. In this instance, data is carried by changing electrical characteristics through a microwave contact, or the like. Thus, an optical modulator output is formed in the form of a modulated waveform. A photoelectric modulator (O/E converter) may generate THz pulses based on an optical rectification operation by a nonlinear crystal, a photoelectric conversion (O/E conversion) by a photoconductive antenna, and emission from a bunch of relativistic electrons. The THz pulse generated in the above manner may have a length of a unit from femto second to pico second. The photoelectric converter (O/E converter) performs down-conversion using non-linearity of the device.

Considering THz spectrum usage, multiple contiguous GHz bands are likely to be used as fixed or mobile service usage for the terahertz system. According to outdoor scenario criteria, an available bandwidth may be classified based on oxygen attenuation 10-2 dB/km in the spectrum of up to 1 THz. Hence, a framework in which the available bandwidth consists of several band chunks may be considered. As an example of the framework, if the length of the THz pulse for one carrier is set to 50 ps, the bandwidth (BW) is about 20 GHz.

The effective down-conversion from the infrared (IR) band to the THz band depends on how to utilize the nonlinearity of the photoelectric converter (O/E converter). That is, for down-conversion into a desired THz band, design of the photoelectric converter (O/E converter) having the most ideal non-linearity to move to the corresponding THz band is required. If a photoelectric converter (O/E converter) which is not suitable for a target frequency band is used, there is a high possibility that an error occurs with respect to an amplitude and a phase of the corresponding pulse.

In a single carrier system, a THz transmission/reception system may be implemented using one photoelectric converter. In a multi-carrier system, as many photoelectric converters as the number of carriers may be required, which may vary depending on the channel environment. Particularly, in a multi-carrier system using multiple broadbands according to the plan related to the above-described spectrum usage, the phenomenon will be prominent. In this regard, a frame structure for the multi-carrier system may be considered. A down-frequency-converted signal based on the photoelectric converter may be transmitted in a specific resource area (e.g., a specific frame). The frequency domain of the specific resource area may include a plurality of chunks. Each chunk may consist of at least one component carrier (CC).

### Background Art of Various Embodiments of Present Disclosure

The present disclosure relates to a method and a device used in a quantum communication system.

In a quantum communication system through a wired or wireless communication environment, while stability of information to be sent is maintained based on quantum properties, the transmit information may be delivered to the receiver. The quantum communication is a fundamental technology that constitutes a quantum network (or quantum Internet), and is used to deliver qubit information between quantum nodes. A purpose of the quantum network may be broadly divided into two as follows.

(1) Quantum networks for computation: Networked quantum computing or distributed quantum computing works by linking multiple quantum processors through a quantum network by sending qubits in-between them

(2) Quantum networks for communication: In the realm of quantum communication, one wants to send qubits from one quantum processor to another over long distances [reference: https://en.wikipedia.org/wiki/Quantum_network]

FIG. 20 is a diagram illustrating an example of a process of transferring qubit information through a quantum channel in a system applicable to the present disclosure.

In FIG. 20, the quantum channel may be configured as wired or wireless, and performs delivery of qubit information through direct transfer of single/multiple photons formed at a transmitter or quantum teleportation while dividing an entanglement resource between nodes.

FIG. 21 is a diagram illustrating an example of a quantum communication system classification according to a type of qubit information in the system applicable to the present disclosure.

Depending on a type of information to be delivered, the quantum communication systems may be divided into quantum communication for classical bit (QC4Cbit) and quantum communication for quantum bit (QC4Qbit).

In the QC4Cbit, classical bit information to be delivered is transformed into a qubit basis (or computation basis) in a quantum encoder (with or without applying reliability enhancement techniques such as a channel encoder). At this time, the classical bit information 0 or 1 is transformed into qubit basis |0> or |1>. The qubit basis, which is logical information for a quantum state, may be formed by a physical quantum basis. For example, at the transmitter and receiver, it may be promised that the qubit basis |0> and |1> correspond to horizontal polarization and vertical polarization as the quantum basis. The qubit basis generated at the transmitter is delivered to the receiver through the quantum channel, and a quantum decoder at the receiver decodes the qubit basis by performing measurement using the previously promised quantum basis. The measured qubit basis corresponds to the classical bit information again to obtain the desired information (with or without applying reliability enhancement techniques such as the channel decoder, etc.).

The QC4Qbit refers to a method in which a qubit state |ψ> generated by a quantum processor of the transmitter is delivered to the receiver through the quantum channel, and the receiver uses the received qubit state according to a purpose. At this time, the delivered qubit state is a superposition state of qubit bases, and may be generally expressed as ψ [symbol] =α|0 [symbol] +β|1 [symbol] . At this time, the qubit bases are |0> and |1>, α and β are probability amplitudes, and have a relationship of |a|2+|B|2=1. In the QC4Qbit, when the qubit state |w> received by the receiver is used in the quantum processor, the qubit state |ψ> may be used for the purpose without measurement.

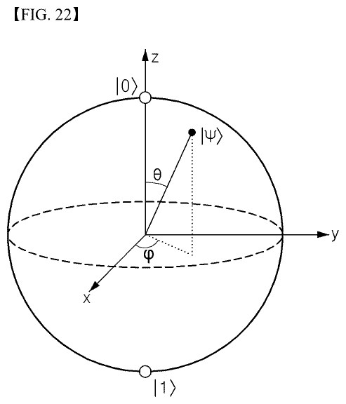

FIG. 22 is a diagram illustrating an example of a representation of a qubit state on a Bloch sphere in the system applicable to the present disclosure.

The qubit state may be represented on a Bloch sphere, which consists of a linear combination of two qubit bases (or computation bases).

In FIG. 22, when a condition |α|²+[β]²==1 is satisfied, the qubit state may be represented on a surface of the Bloch sphere. Any qubit state is a linear combination of two qubit bases, and coefficients α and β of respective bases are complex numbers, so the degree of freedom (DoF) is 4. At this time, when the condition |α|²+|β|²=1 is always satisfied (pure state case), the DoF is reduced to 3. Bloch sphere representations for the qubit state are

$$α = {e}^{j δ} cos \frac{θ}{2} and β = {e}^{j δ} {e}^{j φ} sin \frac{θ}{2} ,$$

and at this time, since a global phase e^{jδ} is not an object of interest, the global phase e^{jδ} may be removed, resulting in

$$α = cos \frac{θ}{2} , and β = {e}^{j φ} sin \frac{θ}{2} ,$$

so α becomes a real number. Therefore, the DoF of the pure state, which always satisfies the condition of |α|²+|β|²=1 becomes 2. On the Bloch Sphere, DoF=2 is formed by angles φ and θ. In a situation where the condition |α|²+|β|²=1 is not satisfied (mixed state case), the DoF means any point inside the Bloch Sphere, and a distance r from a center is added to the DoF, so that DoF=3.

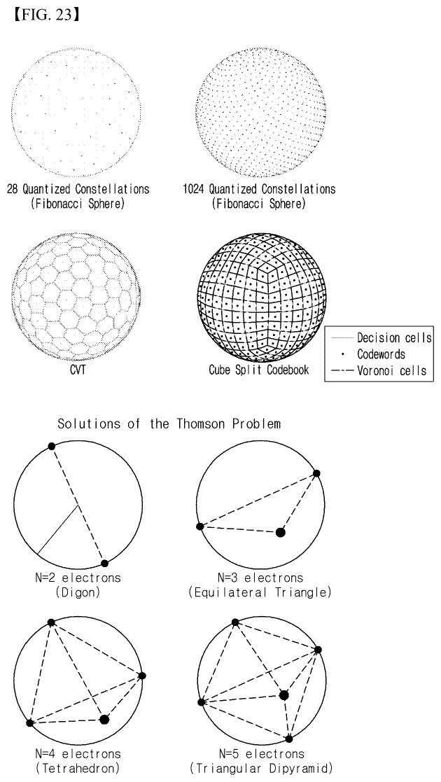

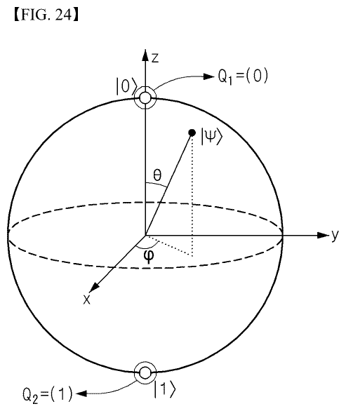

FIG. 23 is a diagram illustrating an example of a quantum state constellation in the system applicable to the present disclosure.

### Quantum State Modulation

The QC4Cbit system, which delivers classical bit information through quantum communication, transforms classical bit information 0 or 1 into qubit basis |0> or |1>, so one classical digital bit corresponds to one qubit. Therefore, in order to deliver multiple bits of information, multiple qubits need to be delivered through the quantum channel. Alternatively, the qubits may be composed of a ‘qudit’ consisting of a d-dimensional Hilbert space, so that d digital information may correspond to one qudit, but since the d-dimensional Hilbert Space is composed of an orthogonal computation basis, the QC4Cbit system is a method of transforming d digital information by further using additional resources. In the existing QC4Cbit, data is a computation basis corresponding to one digital bit, so 1 bit of information may be delivered, and in the existing QC4Qbit, data is a qubit state itself, so qubit information that may not be converted into a classical bit may be delivered.

On the other hand, in order to increase the amount of information transmitted per single qubit, a method of quantizing a single qubit and matching the single bit with multiple pieces of information may be considered. The quantized qubit state is a qubit state that is quantized according to a pre-pre-promised rule, and may be expressed as |ψ [symbol] =α̅|0 [symbol] +β̅|1 [symbol] . At this time, a (α̅,β̅) pair is a constellation included in the pre-promised quantized constellation set S. Therefore, the (α̅,β̅) pair is mapped to ONE specific point on the Bloch sphere representing the qubit. As described above, a method of performing modulation based on the probability amplitude of the qubit state in a two-dimensional quantum system is called quantum state modulation (QSM).

All sets of the quantum state constellation used in the QSM are called quantized constellation set S. At this time, all sets of the quantum state constellation may bed represented as an i-th quantized qubit constellation Qᵢ=(α̅ᵢ,β̅ᵢ) included in the quantized constellation set S. The quantized constellation set S of the QSM described in the present disclosure assumes uniform quantization on a sphere represented by the Bloch sphere in a two-dimensional Hilbert space. Here, the uniform quantization method may be performed through optimal quantization for a surface of a unit sphere based on algorithms such as Spherical Fibonacci Lattice, Centroidal Voronoi Tessellation (CVT), Cube Split Codebook, and Lloyd Max Quantizer. Alternatively, the uniform quantization method may be performed through optimal quantization for the surface of the unit sphere based on a Mathematical Approach such as Sphere Packing Problem, Tammes Problem, Thomson Problem, etc. For example, the uniform quantization method may be schematized as in FIG. 23.

The quantized constellation set S of the QSM includes quantized qubit constellations obtained by applying an optimal quantization for the surface of the unit sphere described above to the Bloch sphere. The quantized constellation set S of the QSM may be obtained by deriving an optimal quantization point for the surface of the unit sphere as described above, and organized into a general problem as shown in Equation 1 below.

$$max \{ {min}_{{c}_{i} , {c}_{i} ∈ {S}^{3}} \vert {c}_{i} - {c}_{j} \vert \} , for i \neq j and i , j = 1 , … , N \qquad [ Equation 1 ]$$

In the above equation, S³ represents a set of all coordinates on the surface of the unit sphere formed by a three-dimensional orthogonal coordinate system, and cᵢ represents a coordinate expressed in the orthogonal coordinate system. Therefore, the problem is to maximize a minimum distance between N coordinates on the surface of the unit sphere. The problem may be derived mathematically for a three-dimensional sphere and may be revealed up to N=4, . . . , 130 [http://neilsloane.com/packings/]. In addition, when the general problem is re-expressed in spherical coordinates, the general problem may be organized as shown in Equation 2 below.

$$max \{ {min}_{( {φ}_{i} , {θ}_{i} ) , ( {φ}_{j} , {θ}_{j} )} \sqrt{2 - 2 ( sin {θ}_{i} sin {θ}_{j} cos ( {φ}_{i} - {φ}_{j} ) + cos {θ}_{i} cos {θ}_{j} )} \} , for i \neq j and i , = 1 , … , N \qquad [ Equation 2 ]$$

Assuming that the problem is derived mathematically, the constellation for the QSM may be defined as follows.

In order to represent a point on the surface of the Bloch sphere representing the quantum state as the constellation, when an i-th constellation point is Qᵢ, Qᵢ is expressed as a (φᵢ,θᵢ) pair in spherical coordinates. Then, a quantized qubit state referred to by the i-th constellation point may be represented as |ψᵢ [symbol] =α̅ᵢ|0 [symbol] +β̅ᵢ|1 [symbol] , where

$$< {\overline{α}}_{i} = cos \frac{{θ}_{i}}{2} and {\overline{β}}_{i} = {e}^{j {φ}_{i}} sin \frac{{θ}_{i}}{2} .$$

When the size of the quantized constellation set S is |S|=N, the quantum State modulation is referred to as N-QSM.

The N-QSM may be expressed as follows.
(1) Set of Constellation: S={Qᵢ}={(α̅ᵢ,β̅ᵢ)} for i=1; . . . , N
(1-1) i^{th} Constellation: (α̅ᵢ,β̅ᵢ)∈S where

$$( {\overline{α}}_{i} = cos \frac{{θ}_{i}}{2} , {\overline{β}}_{i} = {e}^{j {φ}_{i}} sin \frac{{θ}_{i}}{2} )$$

for i=1, . . . , N
(1-2) (φᵢ,θᵢ) is an i-th quantized qubit constellation that obtains the optimal quantization on the surface of the Bloch sphere.
# of Constellation: N=[S]
Length of Bit Mapping Sequence: B=log₂(N)
Condition: |α̅ᵢ|²+|β̅ᵢ|²=1 for i=1, . . . , N

In the above, N constellation points are optimal Euclidean distance (φᵢ, θᵢ) pairs derived by the general problem.

In the above, the number of quantized qubit states, N may be limited and promised to 2^{B} from the viewpoint of modulation, and defined by a number of bits, B.

FIG. 24 is a diagram illustrating a constellation of 2-QSM on the Bloch sphere in the system applicable to the present disclosure.

In the N-QSM, when N=2 (B=1), the constellation may be defined by the computation basis similarly to the existing QDC system, and the constellation set may be organized as follows.

2-QSM (optimal Euclidean case) may be expressed as follows.

(1) Set of Constellation: S={Q₁, Q₂}={(α̅₁̅, β̅₁̅), (α̅₂̅,β̅₂̅)}
(1-1) i^{th} Constellation: (α̅ᵢ,β̅ᵢ)∈S where

$$( {\overline{α}}_{i} = cos \frac{{θ}_{i}}{2} , {\overline{β}}_{i} = {e}^{j {φ}_{i}} sin \frac{{θ}_{i}}{2} )$$

for i=1,2
(1-2) (φᵢ,θᵢ) is an i-th quantized qubit constellation that obtains the optimal quantization on the surface of the Bloch sphere.
(2) # of Constellation: N=|s|=2
(3) Length of Bit Mapping Sequence: B=log₂(N)=1
(4) Condition: |α̅ᵢ|²+|β̅ᵢ|²=1 for i=1,2
(5) Set of Bit Sequence={0, 1}
(5-1) Bit Mapping: {Q₁,Q₂}→{0,1}

A 2-QSM mapping table obtained by the optimal quantization may be represented as in Table 3 below.

TABLE 3

| Constellation Index i | Bit Mapping | (φᵢ, θᵢ) | (α̅ᵢ, β̅ᵢ) |
|---|---|---|---|
| 1 | 0 | (0, 0) | (1, 0) |
| 2 | 1 | (0, π) | (0, 1) |

When the 2-QSM constellation on the Bloch sphere is schematized, the 2-QSM constellation may be represented as in FIG. 24.

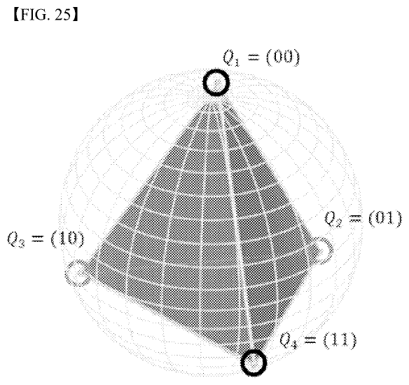

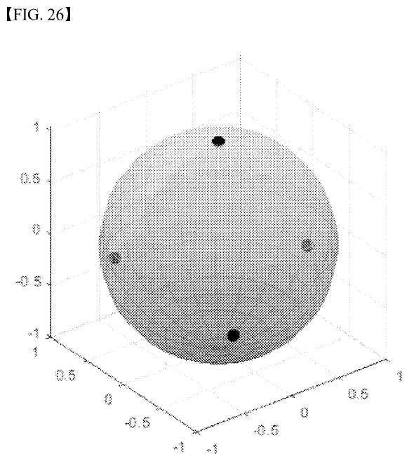

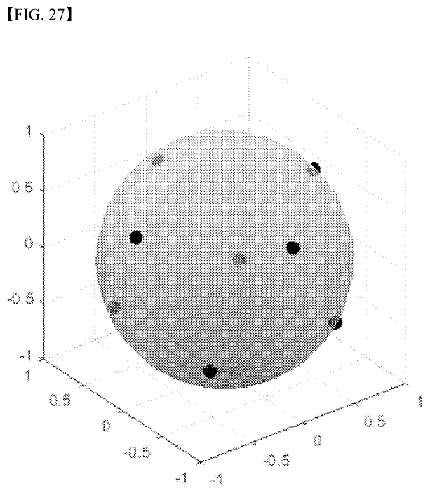

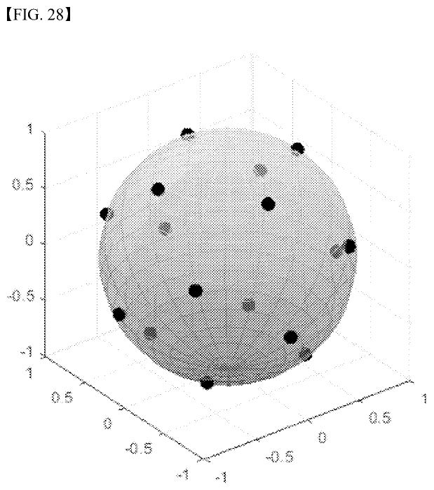

FIG. 25 is a diagram illustrating a constellation of 4-QSM on the Bloch sphere in the system applicable to the present disclosure.

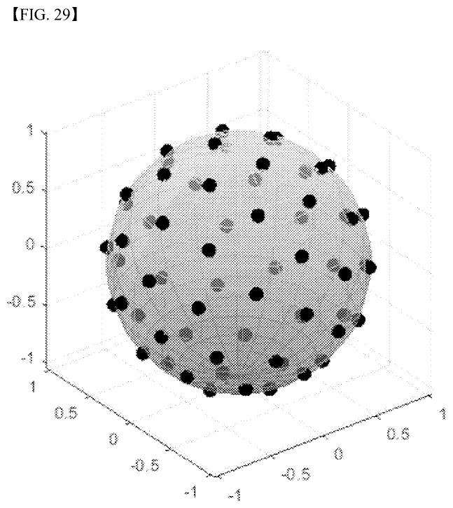

FIG. 26 is a diagram illustrating a constellation of 4-QSM on the Bloch sphere in the system applicable to the present disclosure.

In the N-QSM, a method of mapping to have the optimal Euclidean distance between constellations when N=4 may be organized as follows.

4-QSM (optimal Euclidean distance case) may be expressed as follows.
(1) Set of Constellation:

$$S = \{ {Q}_{1} , {Q}_{2} , {Q}_{3} , {Q}_{4} \} = \{ ( \overline{{α}_{1}} , \overline{{β}_{1}} ) , ( \overline{{α}_{2}} , \overline{{β}_{2}} ) , ( \overline{{α}_{3}} , \overline{{β}_{3}} ) , ( \overline{{α}_{4}} , \overline{{β}_{4}} ) \}$$

(1-1) i^{th} Constellation: (α̅ᵢ,β̅ᵢ)∈S where

$$( {\overline{α}}_{i} = cos \frac{{θ}_{i}}{2} , {\overline{β}}_{i} = {e}^{j {φ}_{i}} sin \frac{{θ}_{i}}{2} )$$

for i=1, . . . , 4
(1-2) (φᵢ,θᵢ) is an i-th quantized qubit constellation that obtains the optimal quantization on the surface of the Bloch sphere.
(2) # of Constellation: N=[s]=4
(3) Length of Bit Mapping Sequence: B=log₂(N)=2
(4) Condition: |αᵢ|²+|β̅ᵢ|²=1 for i=1, . . . , 4
(5) Set of Bit Sequence={00, 01, 10, 11}
(5-1) Bit Mapping: {Q₁, Q₂, Q₃, Q₄}→{00, 01, 10, 11}

A 4-QSM mapping table obtained by the optimal quantization may be represented as in Table 4 below.

TABLE 4

| Constellation | Bit | | |
|---|---|---|---|
| Index i | Mapping | (φᵢ, θᵢ) | (α̅ᵢ, β̅ᵢ) |
| 1 | 00 | (0, 0) | (1, 0) |
| 2 | 01 | $( 0 , arc cos - \frac{1}{3} )$ | $( \sqrt{\frac{1}{3}} , \sqrt{\frac{2}{3}} )$ |
| 3 | 10 | $( \frac{2 π}{3} , arc cos - \frac{1}{3} )$ | $( \sqrt{\frac{1}{3}} , - \sqrt{\frac{1}{6}} + \sqrt{\frac{1}{2}} j )$ |
| 4 | 11 | $( \frac{4 π}{3} , arc cos - \frac{1}{3} )$ | $( \sqrt{\frac{1}{3}} , - \sqrt{\frac{1}{6}} - \sqrt{\frac{1}{2}} j )$ |

When the constellation of the 4-optimal Euclidean distance case (QSM) on the Bloch sphere is schematized, the 4-QSM constellation may be represented as in FIGS. 25 and 26.

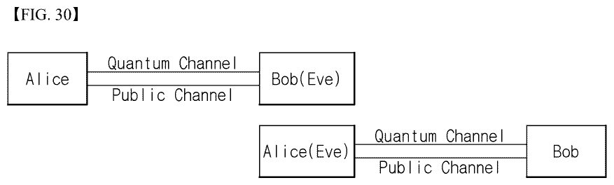

FIG. 27 is a diagram illustrating a constellation of 8-QSM on the Bloch sphere in the system applicable to the present disclosure.

A method of mapping to have the optimal Euclidean distance between constellations when N=8 may be organized as follows.

8-QSM (optimal Euclidean distance case) may be expressed as follows.
(1) Set of Constellation: S={Q₁, . . . , Q_{B}}={(α̅₁̅,β̅₁̅), . . . , (α̅₈̅,β̅₈̅)}
(1-1) i^{th} Constellation: (α̅ᵢ,β̅ᵢ)∈S where

$$( {\overline{α}}_{i} = cos \frac{{θ}_{i}}{2} , {\overline{β}}_{i} = {e}^{j {φ}_{i}} sin \frac{{θ}_{i}}{2} )$$

for i=1, . . . , 8
(1-2) (φᵢ,θᵢ) is an i-th quantized qubit constellation that obtains the optimal quantization on the surface of the Bloch sphere.
(2) # of Constellation: N=[S]=8
(3) Length of Bit Mapping Sequence: B=log₂(N)=3
(4) Condition: |α̅ᵢ|²+|β̅ᵢ|²=1 for i=1, . . . , 8
(5) Set of Bit Sequence={000, . . . , 111}
(5-1) Bit Mapping: (Q₁, . . . , Q_{B}}→{000, . . . , 111}

An 8-QSM mapping table obtained by the optimal quantization may be represented as in Table 5 below.

TABLE 5

| Constellation | Bit | | |
|---|---|---|---|
| Index i | Mapping | (φᵢ, θᵢ) | (α̅ᵢ, β̅ᵢ) |
| 1 | 000 | $( 0 , \frac{π}{3} )$ | $( \sqrt{\frac{3}{4}} , \sqrt{\frac{1}{4}} )$ |
| 2 | 001 | $( \frac{π}{2} , \frac{π}{3} )$ | $( \sqrt{\frac{3}{4}} , \sqrt{\frac{1}{4}} j )$ |
| 3 | 010 | $( \frac{3 π}{2} , \frac{π}{3} )$ | $( \sqrt{\frac{3}{4}} , - \sqrt{\frac{1}{4}} j )$ |
| 4 | 011 | $( π , \frac{π}{3} )$ | $( \sqrt{\frac{3}{4}} , - \sqrt{\frac{1}{4}} )$ |
| 5 | 100 | $( \frac{π}{4} , \frac{2 π}{3} )$ | $( \sqrt{\frac{1}{4}} , \sqrt{\frac{3}{8}} + \sqrt{\frac{3}{8}} j )$ |
| 6 | 101 | $( \frac{3 π}{4} , \frac{2 π}{3} )$ | $( \sqrt{\frac{1}{4}} , - \sqrt{\frac{3}{8}} + \sqrt{\frac{3}{8}} j )$ |
| 7 | 110 | $( \frac{7 π}{4} , \frac{2 π}{3} )$ | $( \sqrt{\frac{1}{4}} , \sqrt{\frac{3}{8}} - \sqrt{\frac{3}{8}} j )$ |
| 8 | 111 | $( \frac{5 π}{4} , \frac{2 π}{3} )$ | $( \sqrt{\frac{1}{4}} , - \sqrt{\frac{3}{8}} - \sqrt{\frac{3}{8}} j )$ |

When the constellation of the 8-optimal Euclidean distance case (QSM) on the Bloch sphere is schematized, the 8-QSM constellation may be represented as in FIG. 27.

FIG. 28 is a diagram illustrating a constellation of 16-QSM on the Bloch sphere in the system applicable to the present disclosure.

In the same method as described above, the 16-QSM and the table are defined as shown in Table 6 below. In Table 6, when xᵢ, yᵢ, and z^{z}ᵢ as coordinates of the orthogonal coordinate system of the mathematically obtained optimal constellation point are transformed into the spherical coordinates and transformed into the probability amplitude, the xᵢ, yᵢ, and z^{z}ᵢ may be represented like the 8-QSM.

TABLE 6

| Constellation | Bit | | | |
|---|---|---|---|---|
| Index i | Mapping | xᵢ | yᵢ | zᵢ |
| 1 | 0000 | 0.1266 | 0.9636 | −0.2357 |
| 2 | 0001 | −0.5918 | 0.7709 | 0.2357 |
| 3 | 0010 | 0.0811 | 0.6174 | 0.7825 |
| 4 | 0011 | −0.3792 | 0.4939 | −0.7825 |
| 5 | 0100 | −0.9636 | 0.1266 | −0.2357 |
| 6 | 0101 | −0.7709 | −0.5918 | 0.2357 |
| 7 | 0110 | −0.6174 | 0.0811 | 0.7825 |
| 8 | 0111 | −0.4939 | −0.3792 | −0.7825 |
| 9 | 1000 | −0.1266 | −0.9636 | −0.2357 |
| 10 | 1001 | 0.5918 | −0.7709 | 0.2357 |
| 11 | 1010 | −0.0811 | −0.6174 | 0.7825 |
| 12 | 1011 | 0.3792 | −0.4939 | −0.7825 |
| 13 | 1100 | 0.9636 | −0.1266 | −0.2357 |
| 14 | 1101 | 0.7709 | 0.5918 | 0.2357 |
| 15 | 1110 | 0.6174 | −0.0811 | 0.7825 |
| 16 | 1111 | 0.4939 | 0.3792 | −0.7825 |

When the constellation of the 16-optimal Euclidean distance case (QSM) on the Bloch sphere is schematized, the 16-QSM constellation may be represented as in FIG. 28.

FIG. 29 is a diagram illustrating a constellation of 64-QSM on the Bloch sphere in the system applicable to the present disclosure.

In the same method as described above, the 64-QSM and the table are defined as shown in Table 7 below. In Table 7, when xᵢ, yᵢ, and zᵢ as coordinates of the orthogonal coordinate system of the mathematically obtained optimal constellation point are transformed into the spherical coordinates and transformed into the probability amplitude, the xᵢ, yᵢ, and zᵢ may be represented like the 8-QSM.

TABLE 7

| Constellation | Bit | | | |
|---|---|---|---|---|
| Index i | Mapping | xᵢ | yᵢ | zᵢ |
| 1 | 000000 | −0.4725 | 0.2632 | −0.8411 |
| 2 | 000001 | −0.7938 | 0.5125 | −0.3274 |
| 3 | 000010 | −0.0868 | 0.9937 | −0.0716 |
| 4 | 000011 | 0.0295 | −0.2588 | 0.9655 |
| 5 | 000100 | 0.3848 | −0.5334 | −0.7533 |
| 6 | 000101 | 0.6939 | 0.7020 | 0.1600 |
| 7 | 000110 | −0.7054 | −0.6471 | −0.2893 |
| 8 | 000111 | −0.6612 | −0.4940 | 0.5646 |
| 9 | 001000 | 0.3130 | −0.1265 | −0.9413 |
| 10 | 001001 | −0.2127 | 0.6063 | 0.7662 |
| 11 | 001010 | −0.3207 | −0.8801 | −0.3501 |
| 12 | 001011 | −0.2652 | −0.5839 | 0.7673 |
| 13 | 001100 | −0.3943 | 0.8859 | 0.2444 |
| 14 | 001101 | 0.9289 | 0.0337 | −0.3689 |
| 15 | 001110 | −0.9611 | −0.1425 | 0.2368 |
| 16 | 001111 | −0.5059 | 0.2641 | 0.8212 |
| 17 | 010000 | −0.3926 | −0.5982 | −0.6985 |
| 18 | 010001 | −0.4139 | −0.1841 | −0.8915 |
| 19 | 010010 | 0.6234 | 0.3416 | 0.7034 |
| 20 | 010011 | 0.2237 | −0.9411 | −0.2537 |
| 21 | 010100 | −0.4974 | 0.8452 | −0.1958 |
| 22 | 010101 | 0.5524 | −0.6742 | 0.4902 |
| 23 | 010110 | −0.0758 | 0.1021 | −0.9919 |
| 24 | 010111 | −0.7630 | 0.6373 | 0.1079 |
| 25 | 011000 | −0.4108 | −0.1735 | 0.8951 |
| 26 | 011001 | −0.4611 | 0.6500 | −0.6040 |
| 27 | 011010 | 0.8998 | −0.4073 | −0.1561 |
| 28 | 011011 | 0.6626 | 0.0855 | −0.7441 |
| 29 | 011100 | 0.5260 | −0.3293 | 0.7841 |
| 30 | 011101 | 0.6729 | −0.7375 | 0.0572 |
| 31 | 011110 | 0.1863 | −0.6289 | 0.7548 |
| 32 | 011111 | −0.0285 | −0.4234 | −0.9055 |
| 33 | 100000 | −0.8148 | −0.5618 | 0.1429 |
| 34 | 100001 | −0.0940 | 0.5303 | −0.8426 |
| 35 | 100010 | −0.7673 | −0.0589 | 0.6386 |
| 36 | 100011 | 0.0240 | −0.7783 | −0.6274 |
| 37 | 100100 | −0.8852 | 0.2855 | 0.3674 |
| 38 | 100101 | 0.8161 | −0.0491 | 0.5758 |
| 39 | 100110 | −0.0021 | 0.8812 | 0.4728 |
| 40 | 100111 | 0.3074 | 0.3249 | −0.8944 |
| 41 | 101000 | 0.5157 | 0.8225 | −0.2399 |
| 42 | 101001 | −0.0891 | 0.1792 | 0.9798 |
| 43 | 101010 | −0.9421 | −0.2706 | −0.1983 |
| 44 | 101011 | 0.9967 | −0.0292 | 0.0755 |
| 45 | 101100 | 0.3318 | 0.6970 | −0.6356 |
| 46 | 101101 | −0.9809 | 0.1711 | −0.0922 |
| 47 | 101110 | −0.0741 | −0.8758 | 0.4769 |
| 48 | 101111 | 0.2175 | 0.4861 | 0.8464 |
| 49 | 110000 | 0.7105 | 0.4762 | −0.5180 |
| 50 | 110001 | −0.0711 | 0.8601 | −0.5051 |
| 51 | 110010 | 0.2948 | −0.9303 | 0.2181 |
| 52 | 110011 | 0.7486 | −0.3274 | −0.5765 |
| 53 | 110100 | −0.6002 | 0.5992 | 0.5299 |
| 54 | 110101 | −0.8112 | 0.1294 | −0.5702 |
| 55 | 110110 | 0.5896 | −0.7084 | −0.3880 |
| 56 | 110111 | −0.7349 | −0.3170 | −0.5995 |
| 57 | 111000 | −0.4767 | −0.8362 | 0.2711 |
| 58 | 111001 | 0.3077 | 0.9401 | 0.1464 |
| 59 | 111010 | 0.9057 | 0.4085 | −0.1139 |
| 60 | 111011 | 0.4316 | 0.7304 | 0.5294 |
| 61 | 111100 | 0.3501 | 0.0611 | 0.9347 |
| 62 | 111101 | −0.1183 | −0.9922 | 0.0404 |
| 63 | 111110 | 0.8657 | −0.4034 | 0.2965 |
| 64 | 111111 | 0.8844 | 0.3278 | 0.3323 |

When the constellation of the 64-optimal Euclidean distance case (QSM) on the Bloch sphere is schematized, the 8-QSM constellation may be represented as in FIG. 29.

As described above, the QSM optimized from the perspective of the optimal Euclidean distance is called optimal N-QSM. Here, N represents a number of constellations.

FIG. 30 is a diagram illustrating an example of a man-in-middle attack during quantum communication in the system applicable to the present disclosure.

### User Authentication Technology

In a quantum communication technique, a security of information transmitted through a quantum channel is guaranteed through a non-cloning theorem, a quantum dynamics property. From this, it is possible to determine whether there has been eavesdropping by a third party of message information transmitted via the quantum channel through a quantum bit error rate (QBER) estimation process using some of the information transmitted via the quantum channel, thereby ensuring the safety of the transmitted message. However, as shown in FIG. 1, when a third party Eve exists between a sender Alice and a receiver Bob and attempts a man-in-the-middle attack by pretending to be the receiver to Alice and the sender to Bob, it is impossible to confirm whether the third party Eve commits the man-in-the-middle attack based on the QBER estimation result through information transmission between Alice and Eve and between Eve and Bob. This allows the third party, Eve, to see all the information being delivered while relaying the data, and even attempt forgery and falsification. Therefore, in order to prevent this, a user authentication process is needed to verify that the sender and receiver, who are the entities exchanging information, are authorized users.

Existing authentication techniques may be divided into a scheme based on hash functions that include elements of a cryptographic strength and a scheme based on security from an information theory perspective. First, techniques based on cryptographic hash functions are used as authentication techniques based on a fact that a collision probability of hash functions is based on computational complexity, and among current cryptographic techniques, an SHA technique is known as a representative hash function-based technology. However, since this technique is based on the computational complexity, this technique is highly likely that a safety of the technique will be threatened in the future with an advent of quantum computers. In order to enhance security, the current quantum cryptography communication system uses a family of keyed hash functions that combine symmetric keys and hash functions based on information theoretic security as an authentication technology, and quantum communication standards organizations such as ETSI are also adopting this scheme as a standard authentication scheme. This scheme uses a hash function called Strongly Universal Hashing as a message authentication code (MAC) algorithm to generate a message authentication code (MAC) to be used in the authentication process, and additionally uses a symmetric key used as a one time pad (OTP) during a generation process, and since it is very unlikely that information may be recovered through a reverse process from the MAC without knowing the key information, this scheme is currently known to have a highest level of security. A representative method is the Wegman & Carter Authentication (WCA) technique proposed by M. Wegman and J. Carter. Currently, a WCA series of authentication technique is being applied as a standard authentication method for a quantum information transmission technique such as QKD, and a detailed configuration of the WCA is as follows.

### Classical Authentication Method: Message Authentication Code (MAC) by Wegman & Carter

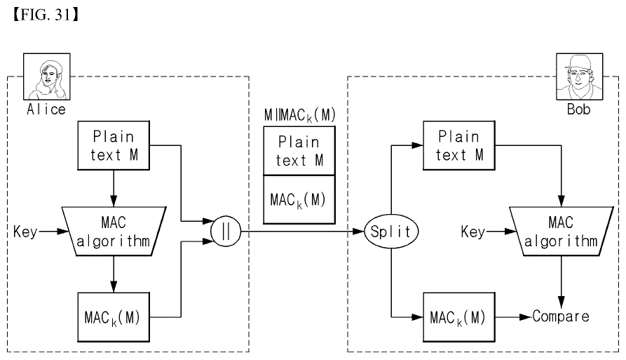

FIG. 31 is a diagram illustrating an example of a MAC-based authentication technique in the system applicable to the present disclosure.

MAC is used to verify an integrity of a message, and is an authentication technique that uses a fact that it is difficult for a third party who does not know the one-time symmetric key information shared in advance between the sender and the receiver to know which MAC algorithm is used when generating the MAC, as illustrated in FIG. 31. Before the authentication process, the sender and the receiver share the same symmetric key information and MAC algorithm, and when the sender inputs a plaintext message to be used for authentication into the MAC algorithm, it selects which MAC algorithm to use is selected based on a value of a preshared key. Then, by inputting a plaintext into the selected MAC algorithm, the MAC may be obtained as an output value, and the sender transmits a plaintext message and an MAC generated thereby through a classical channel to generate an MAC for the receiver. The receiver passes the received plaintext message through the receiver's MAC algorithm. At this time, since the receiver has a same preshared key as the sender, the receiver may generate the MAC using the same MAC algorithm as the sender. Last, it is compared whether the MAC transmitted by the sender matches the MAC generated by the receiver. When the two values match, authentication is passed; and when the two values do not match, the authentication fails. In the scheme of using MAC, the preshared symmetric key information is not information transmitted through the classical channel, but information that only a promised sender and a promised receiver have, so even if a third party who does not know this knows message information without obtaining a symmetric key, the sender and the receiver may not know which MAC algorithm is applied, and this is a scheme that ensures the security. Therefore, the security of this technique may be said to be higher as the number of methods for configuring the MAC algorithm increases.

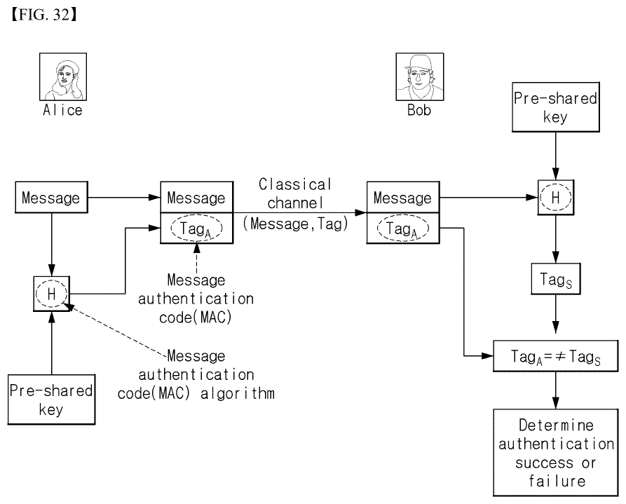

FIG. 32 is a diagram illustrating an example of a Wegman & Carter Authentication (WCA) algorithm in the system applicable to the present disclosure.

A quantum key distribution (QKD) protocol, which is currently being applied as a security technology for 4G LTE/5G, adopts the WCA technique proposed by Wegman and Carter as a standard authentication technology and uses the scheme of FIG. 32 to generate a tag with a MAC to be used for authentication using a symmetric key generated in the form of a One time pad and a strongly universal hash class.

This technique may be applied to both user authentication to check whether the sender and the receiver are changed during message transmission, and message authentication to check whether a content and an order of message information are changed. Here, similar to the MAC, tag information that acts as the MAC is also generated using a preshared key and a MAC algorithm, and the MAC algorithm used here is a hash function set H of the strongly universal hash class. In addition, the preshared key information in the sender and the receiver serves to select which hash function hₖ to use in H, and a length of the preshared key is allocated as log₂[H] bits, where |H| means a number of hash functions that make up the hash function set. Next, the tag information is expressed as T=hₖ(m), and is obtained from a result obtained after passing the message m of the authentication process through the hash function selected from the preshared key as an input value. Last, the tag information transmitted by the sender is with the tag information of the receiver obtained from the message received by the receiver, and the preshared key and the hash function of the receiver, and whether both tag information match each other, and then determine whether the authentication is made.

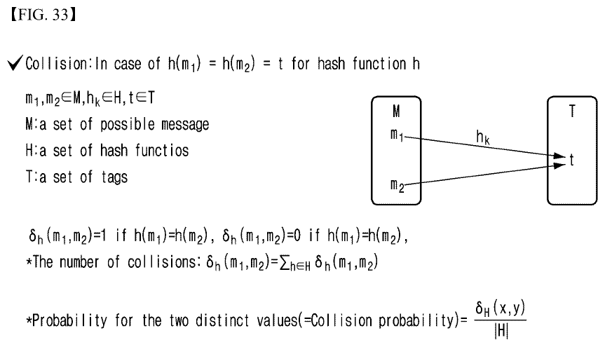

FIG. 33 is a diagram illustrating an example of a collision probability based on the WCA algorithm in the system applicable to the present disclosure.

As mentioned earlier, the Wegman & Carter authentication technique uses the hash function as the MAC algorithm, and the hash function as a function that receives information of an arbitrary length and outputs a hash value of a fixed length is also called a message digest because a sentence of an original length is reduced to a size of a predetermined length. In addition, a reason why the hash function is used as the MAC in the authentication process is that the hash function has three following properties.
(1) Preimage resistance: For any given output value y, it is computationally impossible to find an input value x that satisfies y=h(x).
(2) 2^{nd} Preimage resistance): When there is h(x) for the given input value x and h (x)=h(x′), it is computationally impossible to find another input value x′ such that x≠x′.
(3) Collision resistance: It is computationally impossible to find two input values x and x′ that satisfy the hash value h (x)=h (x′).

The WCA is a man in the middle attack, and when Eve replaces a message m with m′, and guesses and sends a tag, Eve does not know which hash function the sender and the receiver use, so Eve selects a random hash function to guess the tag, and as a result, a success probability is 1/|T| (Here, |T| means a number of tags). That is, the number of tags is determined according to how many types |H| of hash functions used, so the more types of hash functions are used, the lower the possibility that Eve will guess the tag. That is, as in a collision probability equation of FIG. 33, the larger the number of hash functions, the lower the collision probability.

### REFERENCES

Ref 1) T. Krovetz and W. Dai (2007). “VMAC: Message Authentication Code using Universal Hashing”. CFRG Working Group. IETF. Retrieved 2010 Aug. 12
Ref 2) J. Carter; M. Wegman (1977). “Universal classes of hash functions”. Proceedings of the Ninth Annual ACM Symposium on Theory of Computing. ACM: 106-112.
Ref 3) J. Carter; M. Wegman (1981). “New hash functions and their use in authentication and set equality”. Journal of Computer and System Sciences. 22 (3): 265-279.

### Problems to be Solved by Various Embodiments of Present Disclosure

The symbols/abbreviations/terms used in the present disclosure are as follows.
QC4Cbit: Quantum Communication for Classical Bit
QC4Qbit: Quantum Communication for Quantum Bit
Qbit: Quantum Bit
Cbit: Classical Bit
QSM: Quantum State Modulation
QA: Quantum Authentication
MitM Attack: Man-in-the-Middle Attack

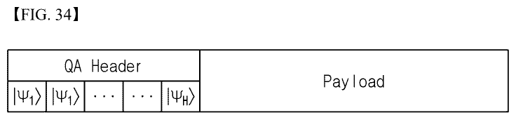

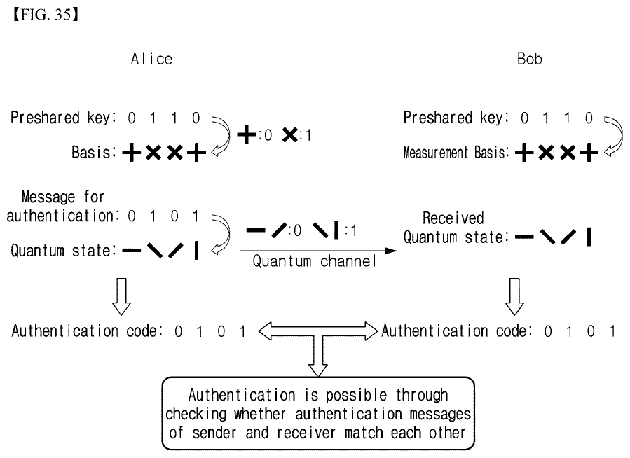

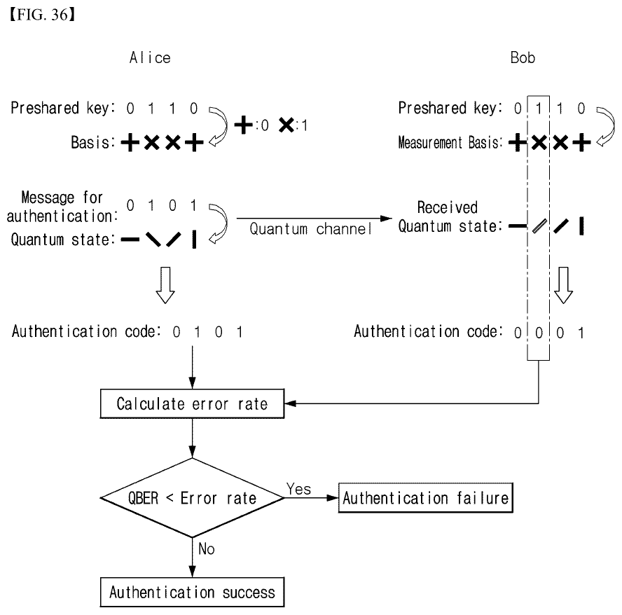

FIG. 34 is a diagram illustrating an example of a process for exchanging a quantum state generated based on a preshared key between a transmitter and a receiver using a quantum authentication (QA) header in the system applicable to the present disclosure.

Among the user authentication schemes via the quantum channel, a method of selecting the computation basis based on the preshared key may be considered. The method of selecting the computation basis based on the preshared key is for the sender to generate information to be used for authentication by selecting one of the a rectilinear basis and a cross basis as the computation basis based on each bit of the preshared key, and deliver the generated information to the receiver. The receiver performs authentication by performing a measurement by on the computational basis using the same method based on the preshared key shared with the transmitter and exchanging a measurement result with the transmitter. At this time, ae quantum state that generates information to be used for authentication based on the preshared key may be defined as a quantum authentication (QA) header, and exchanged between the sender and the receiver.

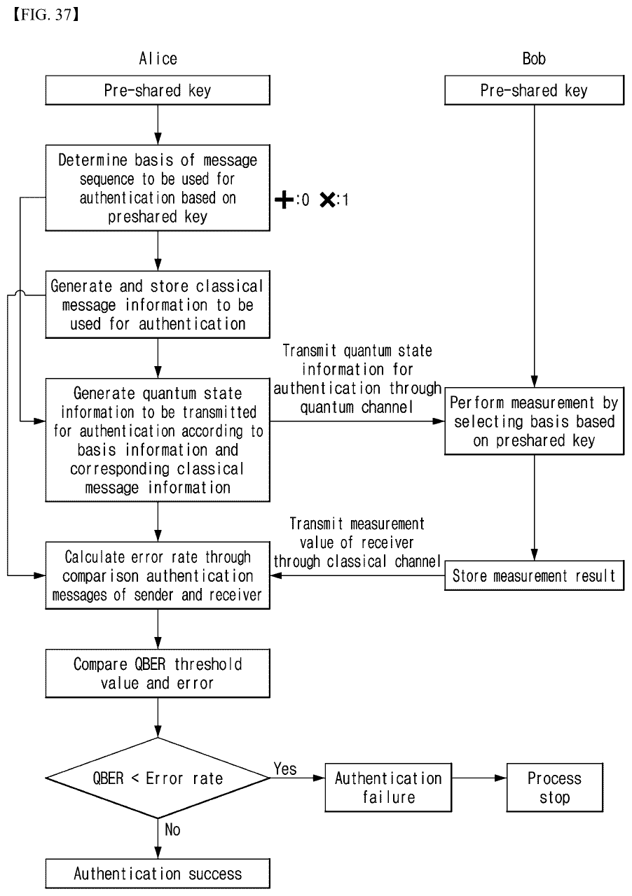

FIG. 35 is a diagram illustrating an example of performing an authentication between the transmitter and the receiver in the system applicable to the present disclosure.

For example, as illustrated in FIG. 35, Alice selects a basis based on the preshared key and sends an authentication code, and Bob performs basis selection based on the preshared key, measures the quantum state to verify the authentication code, and then provides feedback to verify whether transmitting and receiving objects are authorized objects.

In the embodiment of FIG. 35, a process for generating an authentication code to be used for user authentication is illustrated assuming a noise free channel. First, the sender and the receiver share the same preshared key in advance. Based on this, the sender determines the basis for the authentication information to be transmitted based on a preshared key value. At this time, it is promised in advance that when a preshared key bit is 0, a rectilinear basis is selected, and when the preshared key bit is 1, a diagonal basis is selected. Therefore, as in the example above, when the preshared key is 0110, the base information to be used for transmitting an authentication message is determined as +xx+, and a quantum state corresponding to the authentication message generated by the sender is generated based on the selected basis. At this time, it is promised between the sender and the receiver that when the authentication message is in a 0 degree or 45 degree polarization state, the authentication Code value is 0, and when the authentication message is in a 90 degree or 135 degree polarization state, the authentication code value is 1. The generated quantum state information is transmitted to the receiver through the quantum channel, and the receiver selects a measurement basis using the same preshared key as the sender. This allows the receiver to perform an accurate measurement by measuring the quantum information transmitted from the sender using the same basis as the sender. Therefore, when a measurement result is transformed into bit information according to a promised rule by the receiver, the authentication code of the receiver may be obtained. Then, the receiver feeds back the measured authentication code to the sender through the classical channel, and the receiver determines whether the authentication code generated by the sender matches the authentication code obtained as the measurement result, thereby determining whether authentication is passed.

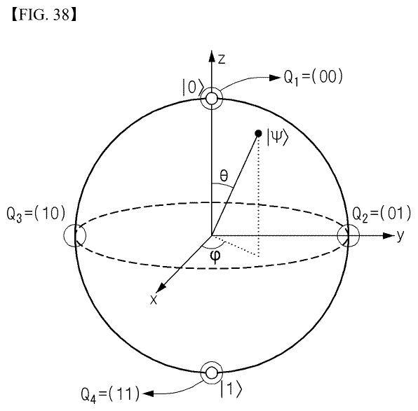

FIG. 36 is a diagram illustrating an example of a process of performing an authentication between the transmitter and the receiver in the system applicable to the present disclosure.

In a real quantum channel environment, a channel error exists due to an influence of decoherence and an Eve's hijacking attempt, so even if the sender and receiver generate and measure the authentication code with the same computation basis, the same authentication code may not always be obtained for all qubits. FIG. 36 illustrates a procedure in an environment in which an error exists.

In the embodiment of FIG. 36, the authentication code measured by the receiver is transmitted to the sender through the classical channel, and this value is compared with the authentication code of the sender to estimate an error rate. Whether the authentication is passes is determined based on whether the estimated error rate exceeds a QBER threshold. Since the error rate not exceeding the QBER threshold ensures that the third party does not interfere with information transmitted in the quantum channel other than a channel error, this value may be used as a factor for determining whether authentication passes or fails. That is, when the error rate is lower than the QBER threshold, user authentication is considered successful; otherwise, authentication is considered failed and a remaining secret key sharing process is stopped. In the above, the QBER threshold may be determined in advance in the system considering a channel environment.

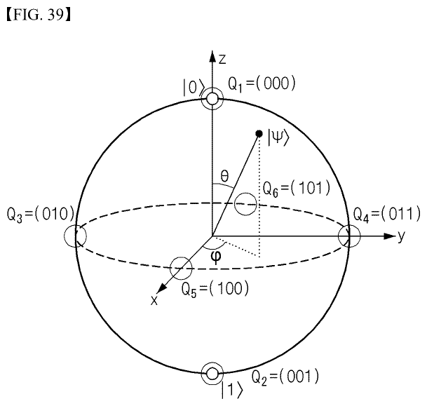

FIG. 37 is a diagram illustrating an example of a process of performing an authentication between the transmitter and the receiver in the system applicable to the present disclosure.

In the embodiment of FIG. 36, a detailed authentication procedure may be schematized as in FIG. 37.
1. Alice and Bob share the preshared key, which is authentication information promised in advance. At this time, the preshared key may be discarded after one-time use, and updated to a new preshared key.
2. The sender Alice first selects a basis of an authentication message to be generated based on the preshared key.
3. Classical message information to be used for authentication is generated, and stored for later comparison with the authentication code of the receiver.
4. After generating authentication message information of the quantum state to be transmitted to the quantum channel based on the previously selected basis and classical message information for authentication, the authentication message information is transmitted to the quantum channel.
5. The receiver selects a basis to be used when measuring the authentication message received via the quantum channel based on the same pre-shared key as the transmitter and stores a result of the measurement.
6. The receiver transmits an authentication code which is the measurement result to the transmitter through the classical channel.
7. The sender estimates the error rate by comparing the authentication code of the sender generated before transmitting the quantum channel with the authentication code received in the previous step.
8. It is checked whether the error rate exceeds the QBER threshold.
9. When the error rate is lower than the QBER threshold, it is determined that authentication is successful, otherwise, it is determined that authentication fails.

In the above operation, the preshared key-based user authentication scheme has a problem in that the quantum state should be generated and transmitted as long as the preshared key. The longer the preshared key, the greater a quantity of qubit resources required. Further, since authentication is performed based on the preshared key, repeated measurements through random basis selection of Eve may result in partial leakage of the preshared key. Therefore, there is a problem that it is difficult to repeatedly use the preshared key, so the preshared key based user authentication scheme should be used like a one time pad (OTP).

In the present disclosure, proposed is a method of allocating multiple digital bit information to one qubit by quantizing a qubit state in a method promised in advance and considering a method in which each quantized qubit state corresponds to one digital information. At this time, multiple pieces of information composed of one qubit may be allocated as a computation basis for quantum measurement. Based on this, proposed is a method for reducing the number of required qubits in the preshared key based user authentication scheme, and increasing security performance.

### Detailed Description of Various Embodiments of Present Disclosure

### 1. Symmetric M-order Quantum State Modulation

In various embodiments of the present disclosure, proposed is a symmetric M-order quantum state modulation (symmetric M-QSM) which is a method of setting multiple computation bases by defining multiple quantum state constellations by quantizing one qubit. Here, M-order is the number of quantum state constellations, and the number of computation basis pairs formed through the M-order is 2/M.

The quantized constellation set S of the symmetric M-QSM proposed by the present disclosure includes quantized qubit constellations obtained by applying an optimal quantization for the surface of the unit sphere described above to the Bloch sphere. At this time, the constellation pair has a condition in which the constellations have an orthogonal relationship to each other. The quantized constellation set S of the symmetric M-QSM may be obtained by deriving an optimal quantization point for the surface of the unit sphere as described above, and organized into a general problem as shown in Equation 3.

$$object to . max \{ {min}_{{c}_{i} , {c}_{j} ∈ {S}^{3}} \vert {c}_{i} - {c}_{j} \vert \} , for i \neq j and i , j = 1 , … , M \qquad [ Equation 3 ]$$

$${{subject to . min \vert \vert i 〉}_{{c}_{i}} \cdot \vert j 〉}_{{c}_{j}} \vert = 0 , for i \neq j and i , j = 1 , … , M$$

In the above equation, S³ represents a set of all coordinates on the surface of the unit sphere formed by a three-dimensional orthogonal coordinate system, and cᵢ represents a coordinate expressed in the orthogonal coordinate system. Further, |i [symbol] _{c}_{ᵢ} represents a ket vector of the quantum state corresponding to Bloch sphere coordinates cᵢ=(xᵢ,yᵢ,zᵢ). The ket vector of the quantum state may be represented as |i [symbol] _{c}_{ᵢ}=α̅ᵢ|0 [symbol] +β̅ᵢ|1 [symbol] , and here, an azimuth angle and an elevation angle obtained when a coordinate cᵢ is transformed into a spherical coordinate are a (φᵢ,θᵢ) pair,

$${\overline{α}}_{i} = cos \frac{{θ}_{i}}{2} and {\overline{β}}_{i} = {e}^{j {φ}_{i}} sin \frac{{θ}_{i}}{2} .$$

Therefore, the problem is to e ensuring that any one constellation always has one orthogonal state on the Bloch sphere while maximizing a minimum distance between M coordinates on the surface of the unit sphere. Therefore, a modulation order M is a multiple of 2. In addition, when the general problem is re-expressed in the spherical coordinate again, the general problem may be organized as follows.

$$object to . max \{ {min}_{( {φ}_{i} , {θ}_{i} ) , ( {φ}_{j} , {θ}_{j} )} \sqrt{2 - 2 ( sin {θ}_{i} sin {θ}_{j} cos ( {φ}_{i} - {φ}_{j} ) + cos {θ}_{i} cos {θ}_{j} )} \} , for i \neq j and i , j = 1 , … , M \qquad [ Equation 4 ]$$

$${{subject to . min \vert \vert i 〉}_{{c}_{i}} \cdot \vert j 〉}_{{c}_{j}} \vert = 0 , for i \neq j and i , j = 1 , … , M$$

Assuming that the problem is derived mathematically, the constellation for the M-QSM may be defined as follows.

In order to represent a point on the surface of the Bloch sphere representing the quantum state as the constellation, when an i-th constellation point is Qᵢ, Qᵢ is expressed as a (φᵢ,θᵢ) pair in the spherical coordinate. Then, a quantized qubit state referred to by the i-th constellation point may be represented as |ψᵢ [symbol] =α̅ᵢ|0 [symbol] +β̅ᵢ|1 [symbol] , where

$${\overline{α}}_{i} = cos \frac{{θ}_{i}}{2} and {\overline{β}}_{i} = {e}^{j {φ}_{i}} sin \frac{{θ}_{i}}{2} .$$

When the size of the quantized constellation set S is |S|=M, the quantum state modulation is referred to as M-QSM.

The symmetric M-QSM may be expressed as follows.
(1) Set of Constellation: S={Qᵢ}={(α̅ᵢ, β̅ᵢ)} for i=1, . . . , M
(1-1) i^{th} Constellation: (α̅ᵢ, β̅ᵢ)∈S where

$$( {\overline{α}}_{i} = cos \frac{{θ}_{i}}{2} , {\overline{β}}_{i} = {e}^{j {φ}_{i}} sin \frac{{θ}_{i}}{2} )$$

for i=1, . . . , M
(1-2) (φᵢ,θᵢ) is an i-th quantized qubit constellation obtained through optimal quantization for the surface of the Bloch sphere.
(2) # of Constellation: M=|S|
(3) # of Computation Basis Pair: M/2
(4) Length of Bit Mapping Sequence: B=log₂(M)
(4-1) Bit Mapping Sequence is composed of a basis index of

$$B - 1 = {log}_{2} ( \frac{M}{2} ) bits$$

and a code index of 1 bit.
(5) Condition 1: |α̅ᵢ|²+[β̅ᵢ]=1 for i=1, . . . , M
(6) Condition 2: min(α̅ᵢ·α̅ᵢ+β̅ᵢ·β̅ᵢ)=0 for i≠j and i,j=1, . . . , M

In the above, M constellation points are (60) pairs derived by the general problem, and each constellation point has an orthogonal constellation. Therefore, each constellation point may have M/2 orthogonal pairs, and M/2 orthogonal pairs may be defined as a computation Basis for quantum state measurement.

In the symmetric M-QSM, when N=4, the constellation may be defined in the same scheme as the quantum system using the existing rectilinear basis and cross basis as the computation basis, and the constellation set may be organized as follows.

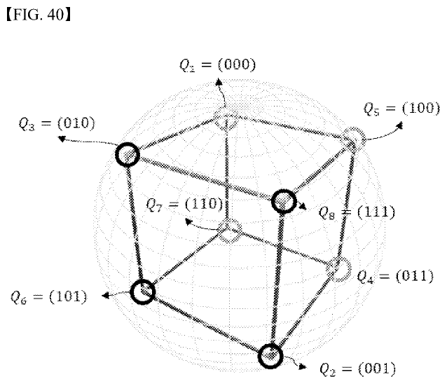

FIG. 38 is a diagram illustrating a constellation of symmetric 4-QSM on the Bloch sphere in the system applicable to the present disclosure.

The symmetric 4-QSM may be expressed as follows.
(1) Set of Constellation:

$$S = \{ {Q}_{1} , {Q}_{2} , {Q}_{3} , {Q}_{4} \} = \{ ( \overline{{α}_{1}} , \overline{{β}_{1}} ) , ( \overline{{α}_{2}} , \overline{{β}_{2}} ) , ( \overline{{α}_{3}} , \overline{{β}_{3}} ) , ( \overline{{α}_{4}} , \overline{{β}_{4}} ) \}$$

(1-1) i^{th} Constellation: (α̅ᵢ, β̅ᵢ)∈S where

$$( {\overline{α}}_{i} = cos \frac{{θ}_{i}}{2} , {\overline{β}}_{i} = {e}^{j {φ}_{i}} sin \frac{{θ}_{i}}{2} )$$

for i=1, . . . 4
(1-2) (φᵢ,θᵢ) is an i-th quantized qubit constellation obtained through optimal quantization for the surface of the Bloch sphere.
(2) # of Constellation: N=[S]=4
(3) # of Computation Basis Pair:

$$\frac{M}{2} = 2$$

(4) Length of Bit Mapping Sequence: B=log₂(M)=2
(4-1) Bit Mapping Sequence is composed of a basis index of

$$B - 1 = {log}_{2} ( \frac{M}{2} ) = 1 bits$$

and a code index of 1 bit.
(5) Condition: |α̅ᵢ|²+|β̅ᵢ|²=1 for i=1, . . . , 4
(6) Condition 2: min(α̅ᵢ·α̅₁+β̅ᵢ·β̅₁)=0 for i≠j and i,j=1, . . . , 4
(7) Set of Bit Sequence={00, 01, 10, 11}
(7-1) Bit Mapping: {Q₁,Q₂,Q₃,Q₄}→{00, 01, 10, 11}
(8) Set of Computation Basis={00, 01}, {10, 11}={Q₁, Q₂}, {Q₃,Q₄}

A 4-QSM mapping table obtained by the optimal quantization may be represented as in Table 8 below.

TABLE 8

| Constellation | Bit Mapping | | |
|---|---|---|---|
| Index i | Basis Index | Code Index | (φᵢ, θᵢ) |
| 1 | 0 | 0 | (0, 0) |
| 2 | 0 | 1 | (0, π) |
| 3 | 1 | 0 | $( \frac{3 π}{2} , \frac{π}{2} )$ |
| 4 | 1 | 1 | $( \frac{π}{2} , \frac{π}{2} )$ |

When the symmetric 4-QSM constellation on the Bloch sphere is schematized, the symmetric 4-QSM constellation may be represented as in FIG. 38.

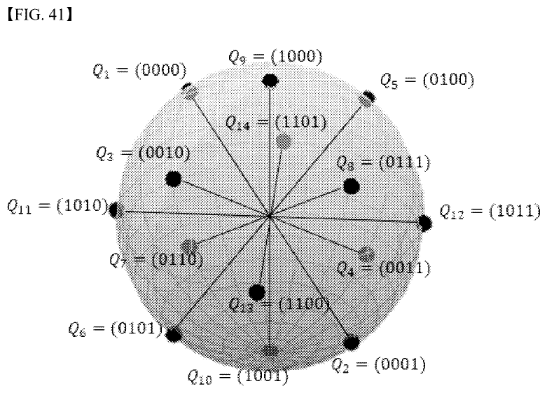

FIG. 39 is a diagram illustrating a constellation of symmetric 6-QSM on the Bloch sphere in the system applicable to the present disclosure.

A method of mapping to form an orthogonal computation basis while having the optimal Euclidean distance between constellations when N=6 may be organized as follows.

The symmetric 6-QSM may be expressed as follows.
(1) Set of Constellation: S={Q₁, . . . , Q₆}={(α̅₁̅,β̅₁̅), . . . , (α̅₆̅,β̅₆̅)}
(1-1) i^{th} Constellation: (α̅ᵢ,β̅ᵢ)∈S where

$$( {\overline{α}}_{i} = cos \frac{{θ}_{i}}{2} , {\overline{β}}_{i} = {e}^{j {φ}_{i}} sin \frac{{θ}_{i}}{2} )$$

for i=1, . . . , 6
(1-2) (φᵢ,θᵢ) is an i-th quantized qubit constellation obtained through optimal quantization for the surface of the Bloch sphere.
(2) # of Constellation: N=[S]=6
(3) # of Computation Basis Pair:

$$\frac{M}{2} = 3$$

(4) Length of Bit Mapping Sequence: B=2.5
(4-1) Bit Mapping Sequence is composed of a basis index of B−1=1.5 bits and a code index of 1 bit.
(5) Condition: |α̅ᵢ|²+|β̅ᵢ|²=1 for i=1, . . . 6
(6) Condition 2: min(α̅ᵢ·α̅ᵢ+βᵢ·β̅ᵢ)=0 for i≠j and i,j=1, . . . , 6
(7) Set of Bit Sequence={000, . . . , 101}
(7-1) Bit Mapping: {Q₁, . . . Q₆}→{000, . . . , 101}
(8) Set of Computation Basis={000, 001}, {010, 011}, {100, 101}={Q₁,Q₂}, {Q₃,Q₄}, {Q₅, Q₆}

An 6-QSM mapping table obtained by the optimal quantization may be represented as in Table 9 below.

TABLE 9

| Constellation | Bit Mapping | | |
|---|---|---|---|
| Index i | Basis Index | Code Index | (φᵢ, θᵢ) |
| 1 | 00 | 0 | (0, 0) |
| 2 | 00 | 1 | (0, π) |
| 3 | 01 | 0 | $( \frac{3 π}{2} , \frac{π}{2} )$ |
| 4 | 01 | 1 | $( \frac{π}{2} , \frac{π}{2} )$ |
| 5 | 10 | 0 | $( 0 , \frac{π}{2} )$ |
| 6 | 10 | 1 | $( π , \frac{π}{2} )$ |

When the symmetric 6-QSM constellation on the Bloch sphere is schematized, the symmetric 6-QSM constellation may be represented as in FIG. 39.

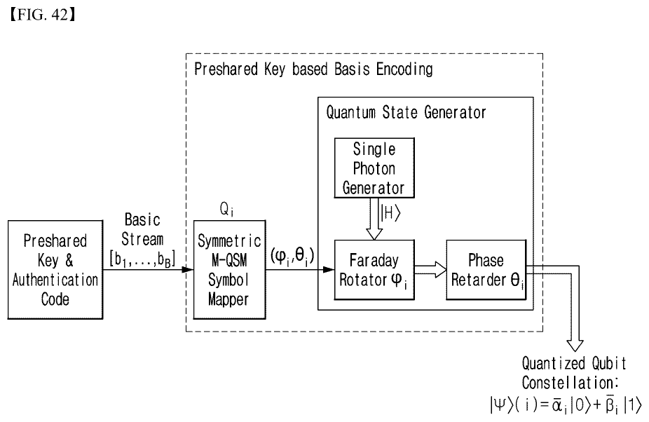

FIG. 40 is a diagram illustrating a constellation of symmetric 8-QSM on the Bloch sphere in the system applicable to the present disclosure.

A method of mapping to form an orthogonal computation basis while having the optimal Euclidean distance between constellations when N=8 may be organized as follows.

The symmetric 8-QSM may be expressed as follows.
(1) Set of Constellation: S={Q₁, . . . , Q_{B}}={(α̅₁̅,β̅₁̅), . . . , (α̅₈̅,β̅₈̅)}
(1-1) i^{th} Constellation: (α̅ᵢ,β̅ᵢ)∈S where

$$( {\overline{α}}_{i} = cos \frac{{θ}_{i}}{2} , {\overline{β}}_{i} = {e}^{j {φ}_{i}} sin \frac{{θ}_{i}}{2} )$$

for i=1, . . . , 8
(1-2) (φᵢ, θᵢ) is an i-th quantized qubit constellation obtained through optimal quantization for the surface of the Bloch sphere.
(2) # of Constellation: N=[S]=8
(3) # of Computation Basis Pair:

$$\frac{M}{2} = 4$$

(4) Length of Bit Mapping Sequence: B=log₂(M)=3
(4-1) Bit Mapping Sequence is composed of a basis index of

$$B - 1 = {log}_{2} ( \frac{M}{2} ) = 2$$

bits and a code index of 1 bit.
(5) Condition: |α̅ᵢ|²+|β̅ᵢ|²=1 for i=1, . . . , 8
(6) Condition 2: min(α̅ᵢ·α̅ᵢ+β̅ᵢ·β̅ᵢ)=0 for i≠j and i,j=1, . . . , 8
(7) Set of Bit Sequence={000, . . . , 111}
(7-1) Bit Mapping: {Q₁, . . . , Q₈}→{000, . . . , 111}
(8) Set of Computation Basis={000, 001}, {010, 011}, {100, 101}, {110,111}={Q₁, Q₂}, {Q₃, Q₄}, {Q₅, Q₆}, {Q₇, Q₈}

An 8-QSM mapping table obtained by the optimal quantization may be represented as in Table 10.

TABLE 10

| Constellation | Bit Mapping | | |
|---|---|---|---|
| Index i | Basis Index | Code Index | (φᵢ, θᵢ) |
| 1 | 00 | 0 | $( 0 , \frac{π}{3} )$ |
| 2 | 00 | 1 | $( \frac{π}{2} , \frac{π}{3} )$ |
| 3 | 01 | 0 | $( \frac{3 π}{2} , \frac{π}{3} )$ |
| 4 | 01 | 1 | $( π , \frac{π}{3} )$ |
| 5 | 10 | 0 | $( 0 , \frac{2 π}{3} )$ |
| 6 | 10 | 1 | $( \frac{π}{2} , \frac{2 π}{3} )$ |
| 7 | 11 | 0 | $( \frac{3 π}{2} , \frac{2 π}{3} )$ |
| 8 | 11 | 1 | $( π , \frac{2 π}{3} )$ |

When the symmetric 8-QSM constellation on the Bloch sphere is schematized, the symmetric 8-QSM constellation may be represented as in FIG. 40.

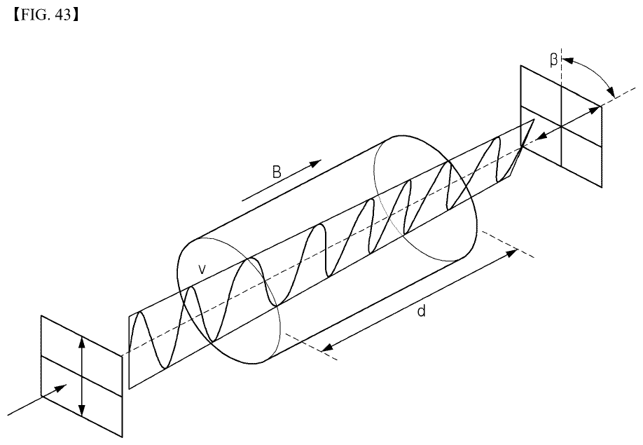

FIG. 41 is a diagram illustrating a constellation of symmetric 14-QSM on the Bloch sphere in the system applicable to the present disclosure.

In a similar method, a method of mapping to form an orthogonal computation basis while having the optimal Euclidean distance between constellations when N=14 may be organized as follows by combining the symmetric 6-QSM and the symmetric 8-QSM.

The symmetric 14-QSM may be expressed as follows.
(1) Set of Constellation: S={Q₁, . . . , Q₁₄}={(α̅₁̅,β̅₁̅), . . . , (α̅₈̅, β̅₈̅)}
(1-1) i^{th} Constellation: (α̅ᵢ,β̅ᵢ)∈S where

$$( {\overline{α}}_{i} = cos \frac{{θ}_{i}}{2} , {\overline{β}}_{i} = {e}^{j {φ}_{i}} sin \frac{{θ}_{i}}{2} )$$

for i=1, . . . , 14
(1-2) (φᵢ,θᵢ) is an i-th quantized qubit constellation obtained through optimal quantization for the surface of the Bloch sphere.
(2) # of Constellation: N=|S|=14
(3) # of Computation Basis Pair:

$$\frac{M}{2} = 7$$

(4) Length of Bit Mapping Sequence: B=log₂(M)=3.75
(4-1) Bit Mapping Sequence

[symbol]

$$B - 1 = {log}_{2} ( \frac{M}{2} ) = 2.75$$

bit [symbol] Basis Index [symbol] 1 bit°/Code Index is composed of a basis index of

$$B - 1 = {log}_{2} ( \frac{M}{2} ) = 2.75$$

bits and a code index of 1 bit.
(5) Condition: |α̅ᵢ̅²+|β̅ᵢ̅=1 for i=1, . . . , 14
(6) Condition 2: min(α̅ᵢ̅·α̅₁̅+β̅ᵢ̅·β̅₁̅)=0 for i≠j and i,j=1, . . . , 14
(7) Set of Bit Sequence={0000, . . . , 1101}
(7-1) Bit Mapping: {Q₁, . . . , Q₁₄}→{0000, . . . , 1101}
(8) Set of Computation Basis={0000, 0001}, {0010, 0011}, . . . , {1100,1101}=

An 8-QSM mapping table obtained by the optimal quantization may be represented as in Table 11.

TABLE 11

| Constellation | Bit Mapping | | |
|---|---|---|---|
| Index i | Basis Index | Code Index | (φᵢ, θᵢ) |
| 1 | 000 | 0 | $( 0 , \frac{π}{3} )$ |
| 2 | 000 | 1 | $( \frac{π}{2} , \frac{π}{3} )$ |
| 3 | 001 | 0 | $( \frac{3 π}{2} , \frac{π}{3} )$ |
| 4 | 001 | 1 | $( π , \frac{π}{3} )$ |
| 5 | 010 | 0 | $( 0 , \frac{2 π}{3} )$ |
| 6 | 010 | 1 | $( \frac{π}{2} , \frac{2 π}{3} )$ |
| 7 | 011 | 0 | $( \frac{3 π}{2} , \frac{2 π}{3} )$ |
| 8 | 011 | 1 | $( π , \frac{2 π}{3} )$ |
| 9 | 100 | 0 | (0, 0) |
| 10 | 100 | 1 | (0, π) |
| 11 | 101 | 0 | $( \frac{3 π}{2} , \frac{π}{2} )$ |
| 12 | 101 | 1 | $( \frac{π}{2} , \frac{π}{2} )$ |
| 13 | 110 | 0 | $( 0 , \frac{π}{2} )$ |
| 14 | 110 | 1 | $( π , \frac{π}{2} )$ |

When the symmetric 14-QSM constellation on the Bloch sphere is schematized, the symmetric 8-QSM constellation may be represented as in FIG. 41.

In the same method, an optimal constellation may be obtained for all Ns and the symmetric M-QSM mapping table may be defined in advance.

The symmetric M-QSM mapping table defined in advance as above is promised between the sender and the receiver.

Based on the symmetric M-QSM mapping table defined in advance as above, the sender and the receiver may measure the quantum state using each orthogonal constellation pair as the computation basis.

### 2. OSM Based Quantum Authentication

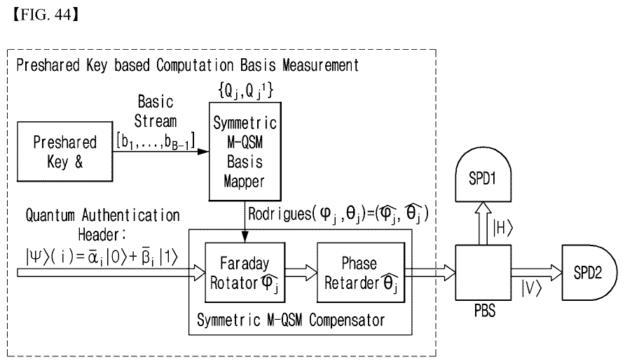

FIG. 42 is a diagram illustrating an example of a symmetric M-QSM sender structure in the system applicable to the present disclosure.

The present disclosure proposes a method, and a sender and a receiver for configuring the quantum state based on the symmetric M-QSM, and a transceiver, in a method for performing user authentication through the quantum channel by selecting the computation basis based on the preshared key shared in advance as proposed in 1. Symmetric M-order Quantum State Modulation described above.

A structure of a symmetric M-QSM-based sender (Alice) that performs user authentication through the quantum channel is illustrated as in FIG. 42.

In the sender, a B-bit basis stream is generated by the preshared key promised between the sender and the receiver and an authentication code, which is a random bit for authentication confirmation. Here, the preshared key is divided into pieces of a size corresponding to B-1 bits from the entire preshared key, and the authentication code is a 1-bit random bit. The generated B-bit basis stream determines one qubit state Qᵢ by a symmetric M-QSM symbol mapper. The symmetric M-QSM symbol mapper operates by each mapping table of the symmetric M-QSM technique proposed in 1. Symmetric M-order Quantum State Modulation. Here, in order to determine one qubit state, the computation basis index of the symmetric M-QSM is selected based on the preshared key, and the code index is selected based on the authentication code. For example, assuming the symmetric 8-QSM, when the preshared key bit is 00 and the authentication code bit is 0, basis index 00 and code index 0 are selected by the symmetric 8-QSM mapping table, and qubit Q₁ corresponding to constellation index 1 is selected. Further, when the preshared key bit is 10 and the authentication code bit is 1, basis index 10 and code index 1 are selected by the symmetric 8-QSM mapping table, and qubit Q₆ corresponding to constellation index 6 is selected. Therefore, by the modulation order M of the symmetric M-QSM used, the number of qubits may be reduced to 1/(log 2 (M/2)) of a total length of the preshared key. For example, using the symmetric 8-QSM, user authentication may be performed with only half the qubits of a preshared key bit stream length.

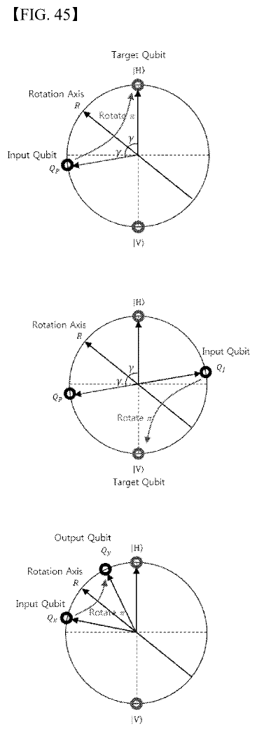

FIG. 43 is a diagram illustrating an example of a Faraday rotator in the system applicable to the present disclosure.

In a preshared key based basis encoder, a quantum state generator generates the qubit state information (φᵢ,θᵢ) output by the symmetric M-QSM symbol mapper as quantized bits.

The quantum state generator, which is a physical device that generates the quantized qubit constellation mapped by the symbol mapper as the quantum state, is composed of a single photon generator and a quantum state controller.

(1) The single photon generator is a device that physically configures a logical pure state |0> or |1> with polarization |H> or |V> for a single photon as an initial qubit for generating a target qubit state. Here, |H [symbol] represents a horizontal linear polarization state, and |V [symbol] represents a vertical linear polarization state.

(1-1) The single photon generator 1 may be implemented by a method which generates a light source through CW-Laser, passes only a physical state corresponding to the initial qubit, that is, |H [symbol] or |V [symbol] by a polarizer, and then reduces a quantity of photons up to a single photon level by an attenuator.

(2) The quantum state controller is a device that transforms the initial qubit state (e.g., |H>) generated by the single photon generator into the qubit state determined by the symbol mapper. For example, when the initial qubit state is a polarization |H> for a single photon, the qubit state information φᵢ and θᵢ input from the symbol mapper are reflected through the Faraday rotator and a phase retarder to generate the quantized qubit constellation.

The Faraday rotator, which is a device that rotates an axis direction of the polarization based on a Faraday effect, applies, when an input polarization passes through an element made of a ferromagnetic crystal, a magnetic field to an element to rotate a polarization direction. In this case, a degree of polarization rotation β is determined by a Verdet constant v, which is an element characteristic value of the ferromagnetic crystal, a flux density B of the applied magnetic field, and a length d of the element.

(2-2) The Faraday rotator rotates the single photon polarization |H [symbol] corresponding to the Initial Qubit State by φᵢ. This means a rotation for longitude on the Bloch sphere.

(2-3) The phase retarder, which is a wave plate created based on a birefringent material, is used to transform a linear polarization into a circular polarization. The birefringent material may generate a degree of the circular polarization by utilizing a characteristic that a vertical polarization component corresponding to a y axis passes more slowly than a horizontal polarization component corresponding to an x axis, when a fast axis is the x axis, based on a difference in phase velocity between a reference fast axis and a slow axis.

(2-4) The phase retarder receives an output of the Faraday rotator, in which rotates the single photon polarization |H [symbol] corresponding to the initial qubit state by φᵢ, and rotates the latitude by θᵢ on the Bloch sphere.

(2-5) Therefore, the initial qubit state generated by the single photon generator may be transformed into the target quantized qubit constellation |ψᵢ [symbol] =α̅ᵢ|0 [symbol] +β̅ᵢ|1 [symbol] according to a relational expression of

$${\overline{α}}_{i} = cos \frac{{θ}_{i}}{2} , {\overline{β}}_{i} = {e}^{j {φ}_{i}} sin \frac{{θ}_{i}}{2} .$$

The quantized qubit constellation <|ψᵢ [symbol] =α̅ᵢ|0 [symbol] +β̅ᵢ|1 [symbol] generated above is delivered to the receiver through the quantum channel.

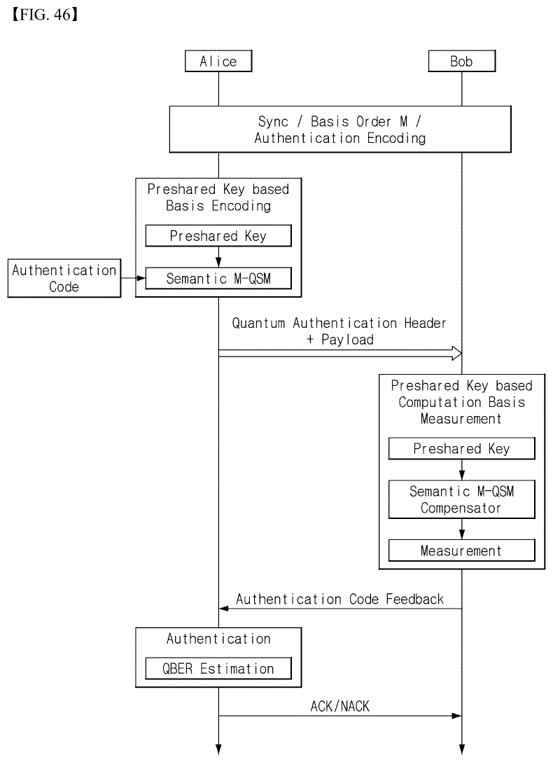

FIG. 44 is a diagram illustrating an example of a symmetric M-QSM receiver structure in the system applicable to the present disclosure.

A structure of a symmetric M-QSM-based receiver (Bob) that performs user authentication through the quantum channel is illustrated as in FIG. 44.

The receiver performs a basis compensation for the qubit of the quantum authentication header received from the sender based on the preshared key promised between the sender and the receiver. From the receiver's perspective, the preshared key information is known information because the preshared key information is information promised in advance, and the authentication code information is unknown information because the authentication code information is random bit information generated by the sender. When a measurement is performed after performing the basis compensation based on the preshared key, authentication information may be obtained. In the present disclosure, the basis compensation refers to transforming, based on a symmetric M-QSM basis selected based on the preshared key, the corresponding basis into the rectilinear basis by a symmetric M-QSM compensator.

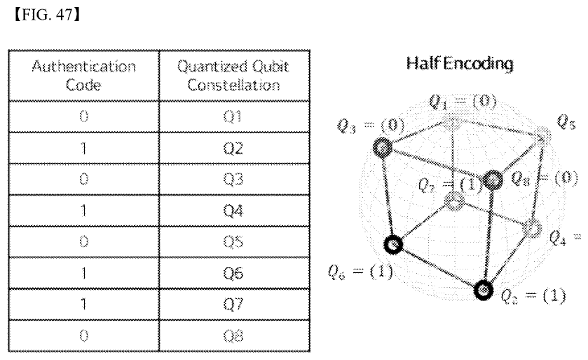

FIG. 45 is a diagram illustrating an example of a quantum state transform process in the system applicable to the present disclosure.

In the above, the measurement by a single qubit is finally passed through a polarization beam splitter (PBS) and measured as |H [symbol] or |V [symbol] by a single photon detector (SPD). Therefore, the basis compensation serves to transform the quantum state into the rectilinear basis which is a final measurement basis by a basis index of B-1 bits selected by the preshared key. Transform information of the quantum state for the basis compensation is performed with Rodrigues(φᵢ, θᵢ)=( [symbol] , θ̅ᵢ̅). Here, Rodrigues(φᵢ, θᵢ) is a method for transforming the phase information (φᵢ, θᵢ) of the qubit state Qⱼ corresponding to authentication code 0 in the computation basis selected based on the preshared key into a quantum state of |H [symbol] with a Rodrigues' rotation formula.

Quantum state transform through the Rodrigues' rotation formula may be written as Equation 5 below when a current state Qᵢ and a transform target state |H [symbol] are given.

$${Q}_{i} \to Rodrigues ( {φ}_{j} , {θ}_{j} ) = Transform ( {Q}_{i} , {Q}_{j} ) = {Q}_{i} cos π + ( R \times {Q}_{i} ) sin π + R ( R \cdot {Q}_{i} ) ( 1 - cos π ) \qquad [ Equation 5 ]$$

In Equation 5, x represents a cross product and · represents a dot product. Through the transform, in the case of any Qᵢ=Qⱼ, the quantum state may be transformed into |H [symbol] . In this case, when Qᵢ=Qⱼ^{⊥} in the transform, Qᵢ is a quantum state orthogonal to Qⱼ, so a transform result becomes |V [symbol] . That is, a transform axis R is fixed by the preshared key, and is transformed to |H [symbol] or |V [symbol] depending on the state of the input Qᵢ. In this case, when the state of Qᵢ is any Qₓ other than Qᵢ^{⊥}, which is a quantum state orthogonal to Qⱼ or Qⱼ, the state of Qᵢ is not transformed into |H [symbol] or |V [symbol] , but is transformed into a state of Q_{y}, which is located some distance from a z-axis on the Bloch sphere, and is probabilistically measured by an H/V Basis in a final measurement step. When the contents are schematized and expressed, the contents are illustrated in FIG. 45.

Therefore, in order to accurately measure the authentication code in the final measurement step, it is necessary to take the basis compensation by setting an accurate transform axis R based on the preshared key. On the other hand, since it is possible for Eve, which does not have the preshared key, to take the basis compensation by setting the accurate transform axis R, Eve may not obtain the authentication code accurately.

The symmetric M-QSM compensator is a phase transform device corresponding to quantum state transform through the Rodrigues' rotation formula. Based on the preshared key, phase information ( [symbol] , \hat{θ}₁) corresponding to the quantum state transform derived through the Rodrigues' rotation formula is obtained, and the quantum state transform is performed using a Faraday rotator and a phase retarder. Operations of a Faraday mirror and the phase retarder are the same as those of the quantum state generator in the sender.

The quantum state transformed by the symmetric M-QSM compensator passes through the PBS and measured by the SPD corresponding to |H [symbol] or |V [symbol] to obtain the authentication code. The obtained authentication code is fed back to Alice to confirm whether authentication is made.

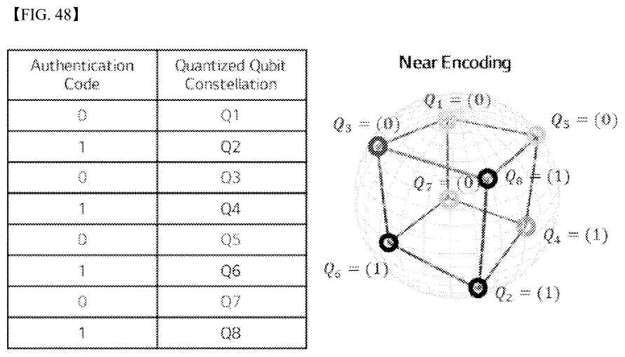

FIG. 46 is a diagram illustrating an example of a symmetric M-QSM based authentication procedure in the system applicable to the present disclosure.

An entire procedure of the symmetric M-QSM-based authentication process described above may be organized as in FIG. 46.

(1) The sender (Alice) and the receiver (Bob) have a preshared key shared in advance for user authentication.

(2) Alice and Bob promise the modulation order M of the symmetric M-QSM for synchronization information and authentication, and an authentication encoding technique of the symmetric M-QSM.

(2-1) Here, the authentication encoding technique of the symmetric M-QSM is half encoding/near encoding/cross encoding, etc., and refers to a type in which the symmetric M-QSM modulation method is the same, but the index information of the authentication code to be mapped is different.

(3) For authentication, Alice generates the quantum state with the symmetric M-QSM using the preshared key and the authentication code.

(3-1) in this case, the generated quantum state may be a qubit stream generated by performing the symmetric M-QSM by the length of the preshared key.

(4) Alice transmits the generated quantum state in the quantum authentication header.

(5) Bob performs a quantum state transform using a symmetric M-QSM compensator that performs the basis compensation for each received quantum state of the quantum authentication header with the preshared key.

(6) Bob obtains the authentication code by performing a measurement promised in advance based on the transformed quantum state.

(7) Bob feeds back the obtained authentication code to Alice.

(8) Alice performs a QBER estimation by comparing the transmitted authentication code with the authentication code which is fed back.

(9) When Alice determines that a QBER estimation result does not exceed a predefined threshold, Alice determines that authentication is made, and transmits an ACK, otherwise, Alice transmits a NACK.

(9-1) The predefined threshold is promised in advance by considering an influence of decoherence that may exist in a quantum channel environment.

The QBER estimation in (8) means an error rate by comparing the bit information of the authentication code sent by Alice and the authentication code fed back from Bob.

### 3. Optimal Authentication Code Design

In various embodiments of the present disclosure, proposed is a scheme of setting different code indexes mapped to the same qubit constellation in designing 1. Symmetric M-order Quantum State Modulation described above. The number of cases of the actually generated Qubit State and each state are the same, but when the mapping table for the state of each qubit state is set differently, the amount of leakage information may be set differently from Eve's perspective.

In the authentication code design, since the symmetric 4-QSM and the symmetric 6-QSM are the same as each other in terms of an Euclidean distance from any basis to another basis, so the symmetric 4-QSM and the symmetric 6-QSM are the same as each other in terms of the amount of leakage information in Eve's perspective regardless of an encoding strategy used. Therefore, the authentication code design does not affect system performance. On the other hand, for modulation orders of symmetric 8-QSM or higher, the Euclidean distance from any basis to another basis varies depending on a choice. Therefore, the performance of the authentication code design varies depending on the encoding strategy. Therefore, three different encoding schemes may be defined depending on a method for assigning the code index as follows.

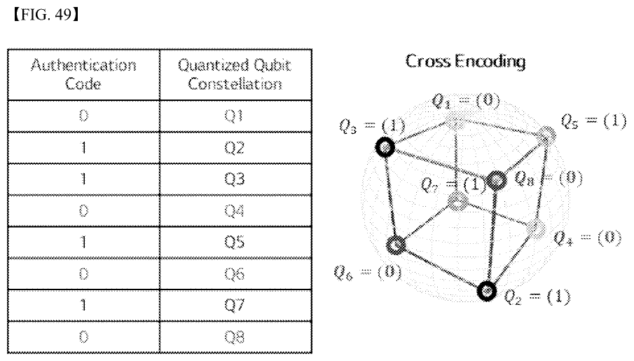

FIG. 47 is a diagram illustrating an example of symmetric 8-QSM with half encoding in the system applicable to the present disclosure.

Half Encoding: A scheme of assigning code index 0 to constellations of M/2 close to |H [symbol] on the Bloch sphere, and code index 1 to constellations of M/2 close to |V

[symbol]

In the embodiment of FIG. 47, the half encoding assigns authentication code 0 to four constellation points Q1, Q3, Q5, and Q8 close to |H [symbol] on the Bloch sphere. On the other hand, authentication code 1 is assigned to four constellation points Q2, Q4, Q6, and Q7, which are close to |V [symbol] on the Bloch sphere.

In the same method, the authentication code mapping of the symmetric M-QSM mapping table may also be promised in advance between the sender and the receiver using the half encoding strategy in other modulation orders.

FIG. 48 is a diagram illustrating an example of symmetric 8-QSM with near encoding in the system applicable to the present disclosure.

Near Encoding (encoding scheme of minimizing a success rate of MitM attack): A scheme of assigning the same code index to the constellations of M/2-1 that have a minimum distance from any one constellation on the Bloch sphere as a group, and assigning different code indexes to the remaining M/2 constellations.

In the embodiment of FIG. 48, when the near encoding assigns authentication code 0 to constellation point Q1, the near encoding assigns authentication code 0 to Q3, Q5, and Q7, which have a minimum distance from Q1. On the other hand, when assigning authentication code 1 to Q2, which is orthogonal to constellation point Q1, authentication code 1 is assigned to Q4, Q6, and Q8, which have a minimum distance from Q2.

In the same method, the authentication code mapping of the symmetric M-QSM mapping table may also be promised in advance between the sender and the receiver using the near encoding strategy in other modulation orders.

FIG. 49 is a diagram illustrating an example of symmetric 8-QSM with cross encoding in the system applicable to the present disclosure.

Cross Encoding (encoding scheme of minimizing an authentication success rate of Eve): A scheme of assigning opposite code indexes to adjacent constellations based on any one constellation on the Bloch sphere

In the embodiment of FIG. 49, when the cross encoding assigns authentication code 0 to constellation point Q1, the near encoding assigns authentication code 1 to Q3, Q5, and Q7, which have a minimum distance from Q1. On the other hand, when assigning authentication code 1 to Q2, which is orthogonal to constellation point Q1, authentication code 0 is assigned to Q4, Q6, and Q8, which have a minimum distance from Q2.

In the same method, the authentication code mapping of the symmetric M-QSM mapping table may also be promised in advance between the sender and the receiver using the cross encoding strategy in other modulation orders.

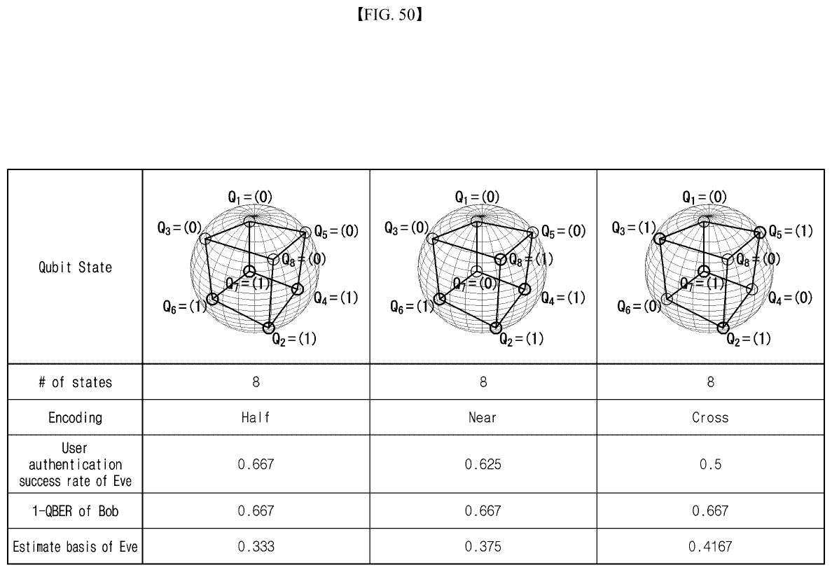

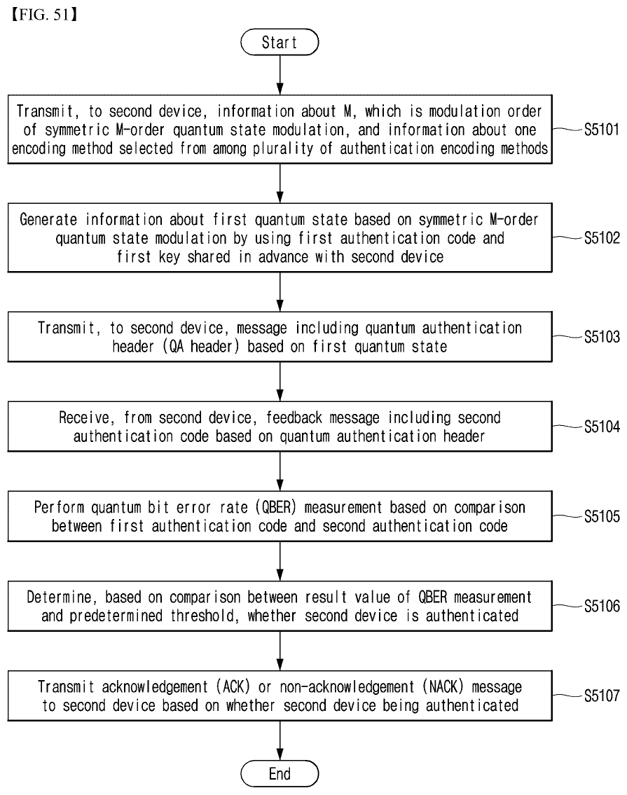

FIG. 50 is a diagram illustrating an example of security performance analysis according to a symmetric 8-QSM case in the system applicable to the present disclosure.

In the embodiment of FIG. 50, when the symmetric 8-QSM is used in QSM-based QA, security performance according to an encoding strategy is illustrated.

In the embodiment of FIG. 50, the user authentication success rate of Eve represents a success rate when Eve attempts user authentication pretending to be Bob using a random basis without information about the preshared key for a single qubit. Therefore, when the number of qubits corresponding to the preshared key is N, (a user authentication access rate of Eve) N becomes a final user authentication success rate. Therefore, the lower the user authentication success rate of Eve, the better the performance. Therefore, it can be seen that the cross encoding strategy is the best strategy in terms of the user authentication success rate of Eve, followed by the near encoding and the half encoding in terms of performance.

In the embodiment of FIG. 50, 1-QBER of Bob is a probability that there will be no error in Bob and Alice's QBER estimation when Eve performs a Man-in-the-Middle (MitM) attack on a single qubit. Therefore, when the number of qubits corresponding to the preshared key is N, (1-QBER)) N becomes a final MitM success rate. Therefore, the lower the user authentication success rate of Eve, the better the performance. As analyzed above, the MitM success rate of Eve is not affected by encoding performance.

In the embodiment of FIG. 50, a basis estimation of Eve is a probability that Eve performs the MitM Attack on a single Qubit, sends the qubit state measured by Eve to Bob, and estimates what the preshared key is based on the authentication code which Bob feeds back. Therefore, when the number of qubits corresponding to the preshared key is N, (Eve's Basis Estimation) N becomes a final preshared key leakage probability. Therefore, the lower the basis estimation success rate of Eve, the better the performance. Therefore, it can be seen that the half encoding strategy is the best strategy in terms of the Eve's basis estimation success rate, followed by the near encoding and the cross in terms of performance.

According to characteristics according to the encoding strategy of the embodiment of FIG. 50, the QSM based QA System may promise the encoding strategy in advance between the sender and the receiver. Depending on security indicators targeted by the system or system parameters considering a channel situation, the encoding strategy may be set differently.

The encoding strategy between the sender and the receiver may be promised in advance in step (2) of an overall procedure in the embodiment of FIG. 46 from the system perspective.

(1) In the embodiment of FIG. 50, the selection of the encoding strategy may be determined by the security indicator.

(1-1) For a strategy of minimizing the amount of leakage information of the preshared key, the system may select and promise a half encoding scheme with a lowest basis estimation probability of Eve.

(1-2) Further, for example, for a strategy of minimizing the MitM attack success rate of Eve, the system may select and promise a cross encoding scheme with a lowest user authentication success rate of Eve.

(1-3) In addition, for example, when both the minimization of the MitM attack success rate of Eve and the minimization of the amount of leakage information of the preshared key need to be achieved, the system may select and promise the near encoding scheme in which the user authentication success rate and the basis estimation success rate of Eve are appropriate by considering a trade-off of both indicators.

(2) The selection of the encoding strategy may be determined by the channel situation.

(2-1) In a system that uses Eve's user authentication success rate, which is affected only by a channel environment of a forward quantum channel, as a most important indicator, an optimal encoding strategy may be selected and promised based on a change in Eve's user authentication success rate due to channel characteristics of the forward quantum channel.

(2-2) In a system that uses Eve's basis estimation success rate which is affected by both a channel environment of the forward quantum channel and a channel environment of a classical feedback channel, as a most important indicator, the optimal encoding strategy may be selected and promised based on a change in Eve's basis estimation success rate due to channel characteristics of both channels.

In the embodiment of FIG. 50, the encoding strategy between the sender and the receiver may be determined periodically or aperiodically based on the security indicator or channel environment by the sender or receiver and may be separately signaled and known to the receiver or sender.

In the embodiment of FIG. 50, the selection of the encoding strategy is the same as the selection method from the system perspective.

It is apparent that the quantum state proposed in various embodiments of the present disclosure is enabled to be applied to all quantum states that may be expressed by a probability amplitude based on a superposition property of quantum. A quantum superposition state includes all quantum states in which two states probabilistically coexist before measurement from the viewpoint of a two-level computation basis. For example, when the quantum state is defined by configuring the 2-level computational basis based on each of time, phase, polarization, etc., it is apparent that the N-QSM scheme is enabled to be applied from the viewpoint of the defined Bloch sphere. It is apparent that the quantum state is applicable to all particle units with quantum properties, such as photons and electrons, which correspond to smallest units of physical quantities.

### Expected Effects of Various Embodiments of Present Disclosure

Various embodiments of the present disclosure have technical effects of reducing the number of required qubits of an authentication header for QA, increasing a detection capability of Eve, and reducing the amount of leakage information of a preshared key used in the QA through symmetric M-QSM-based QA.

Key features of various embodiments of the present disclosure are as follows.
(1) Constellation design method for symmetric M-QSM
(2) Symmetric M-QSM based QA procedure
(3) Sender-receiver structure for symmetric M-QSM based QA
(4) Encoding method of authentication code for each constellation in symmetric M-QSM based QA

### [Description of Claim Related to First Device]

Hereinafter, the above-described embodiments will be described in detail with reference to FIG. 27 in terms of an operation of a first device with respect to a second device. Methods to be described below are just distinguished for convenience and unless the methods mutually exclusive, it is needless to say that some components of any one method may be substituted with some components of another method or may be applied in combination with each other.

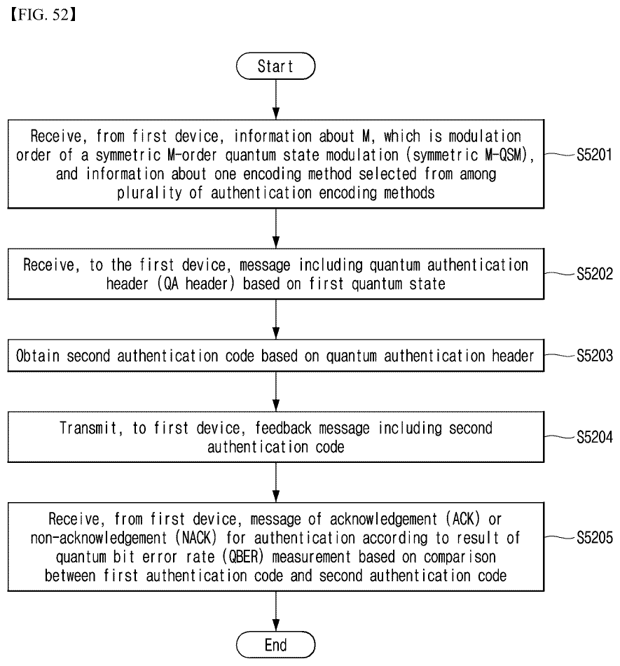

FIG. 51 is a diagram illustrating an example of an operation process of a first device in the system applicable to the present disclosure.

According to various embodiments of the present disclosure, a method performed by the first device in the quantum communication system is provided. In the embodiment of FIG. 51, the first device may correspond to Alice and the second device may correspond to Bob. In some cases, the first device may correspond to Bob and the second device may correspond to Alice.

In step S5101, the first device transmits, to a second device, information about M, which is a modulation order of a symmetric M-order quantum state modulation (symmetric M-QSM), and information about one encoding method selected from among a plurality of authentication encoding methods.

In step S5102, the first device generates information about a first quantum state based on the symmetric M-order quantum state modulation by using a first authentication code and a first key shared in advance with the second device.

In step S5103, the first device transmits, to the second device, a message including a quantum authentication header (QA header) based on the first quantum state.

In step S5104, the first device receives, from the second device, a feedback message including a second authentication code based on the quantum authentication header.

In step S5105, the first device performs a quantum bit error rate (QBER) measurement based on a comparison between the first authentication code and the second authentication code.

In step S5106, the first device determines, based on a comparison between a result value of the QBER measurement and a predetermined threshold, whether the second device is authenticated.

In step S5107, the first device transmits an acknowledgement (ACK) or non-acknowledgement (NACK) message to the second device based on whether the second device being authenticated.

According to various embodiments of the present disclosure, the second authentication code may be based on a second quantum state transformed from the quantum authentication header by a symmetric M-order quantum state modulation compensator (symmetric M-QSM compensator) using the first key.

According to various embodiments of the present disclosure, the symmetric M-order quantum state modulation compensator (symmetric M-QSM compensator) may be configured to perform a basis compensation for the first quantum state of the quantum authentication header by using the first key.

According to various embodiments of the present disclosure, the plurality of encoding methods may be different from each other in terms of an authentication code for M which is the modulation order of the symmetric M-order quantum state modulation (symmetric M-QSM) and a mapping table of a qubit constellation point. The respective qubit constellation points may correspond to respective quantum states. The first authentication code may be based on a mapping table corresponding to the one encoding method. Information about a mapping table corresponding to each of the plurality of encoding methods may be shared in advance between the first device and the second device.

According to various embodiments of the present disclosure, the plurality of encoding methods may be configured such that the higher a first probability that a third device will successfully authenticate as the second device by the first device based on a random basis without information of a first key, the lower a second probability that the third device will estimate the first key based on an authentication code received from the second device.

According to various embodiments of the present disclosure, the one encoding method among the plurality of encoding methods may be determined based on a configured security policy or a channel state of the quantum communication system.

According to various embodiments of the present disclosure, the first quantum state may correspond to a length of the first key.

According to various embodiments of the present disclosure, the QBER measurement may be related to a ratio at which an error occurs based on first bit information of the first authentication code and second bit information of the second authentication code.

According to various embodiments of the present disclosure, a first device in a quantum communication system is provided. The first device may include: a general memory; a transceiver; and at least one processor, and the at least one processor may be configured to perform the operation method of first device according to the embodiment of FIG. 51.

According to various embodiments of the present disclosure, a device controlling the first device in the quantum communication system is provided. The device includes at least one processor; and at one memory operably accessing to the at least one processor. The at least one memory may be configured to instructions for performing the operation method of the first device according to the embodiment of FIG. 51 based on being executed by the at least one processor.

According to various embodiments of the present disclosure, provided are one or more non-transitory computer-readable media storing one or more instructions. The one or more instructions may perform operations based on being executed by one or more processors, and the operations may include the operation method of the first device according to the embodiment of FIG. 51.

### [Description of Claim Related to Second Device]

Hereinafter, the above-described embodiments will be described in detail with reference to FIG. 52 in terms of an operation of the second device with respect to the first device. Methods to be described below are just distinguished for convenience and unless the methods mutually exclusive, it is needless to say that some components of any one method may be substituted with some components of another method or may be applied in combination with each other.

FIG. 52 is a diagram illustrating an example of an operation process of a second device in the system applicable to the present disclosure.

According to various embodiments of the present disclosure, a method performed by the first node in the quantum communication system is provided. In the embodiment of FIG. 52, the first device may correspond to Alice and the second device may correspond to Bob. In some cases, the first device may correspond to Bob and the second device may correspond to Alice.

In step S5201, the second device receives, from the first device, information about M, which is a modulation order of a symmetric M-order quantum state modulation (symmetric M-QSM), and information about one encoding method selected from among a plurality of authentication encoding methods.

In step S5202, the second device receives, to the first device, a message including a quantum authentication header (QA header) based on the first quantum state. Information about a first quantum state may be generated based on the symmetric M-order quantum state modulation by using a first authentication code and a first key shared in advance with the first device.

In step S5203, the second device obtains a second authentication code based on the quantum authentication header.

In step S5204, the second device transmits, to the first device, a feedback message including the second authentication code.

In step S5205, the second device receives, from the first device, a message of an acknowledgement (ACK) or a non-acknowledgement (NACK) for an authentication according to a result of a quantum bit error rate (QBER) measurement based on a comparison between the first authentication code and the second authentication code.

According to various embodiments of the present disclosure, step S5203 of obtaining the second authentication code based on the quantum authentication header may include a step of obtaining a second quantum state by performing a quantum state transform conversion based on a symmetric M-order quantum state modulation compensator (symmetric M-QSM compensator) according to the modulation order M using the first key for the first quantum state of the quantum authentication header, and a step of obtaining the second authentication code based on the second quantum state.

According to various embodiments of the present disclosure, the symmetric M-order quantum state modulation compensator (symmetric M-QSM compensator) may be configured to perform a basis compensation for the first quantum state of the quantum authentication header by using the first key.

According to various embodiments of the present disclosure, the plurality of encoding methods may be different from each other in terms of a mapping table of code indexes for qubit constellations. The plurality of encoding methods may be different from each other in terms of an authentication code for M which is the modulation order of the symmetric M-order quantum state modulation (symmetric M-QSM) and a mapping table of a qubit constellation point. The respective qubit constellation points may correspond to respective quantum states. The first authentication code may be based on a mapping table corresponding to the one encoding method. Information about a mapping table corresponding to each of the plurality of encoding methods may be shared in advance between the first device and the second device.

According to various embodiments of the present disclosure, the plurality of encoding methods may be configured such that the higher a first probability that a third device will successfully authenticate as the second device by the first device based on a random basis without information of a first key, the lower a second probability that the third device will estimate the first key based on an authentication code received from the second device.

According to various embodiments of the present disclosure, the one encoding method among the plurality of encoding methods may be determined based on a configured security policy or a channel state of the quantum communication system.

According to various embodiments of the present disclosure, the first quantum state may correspond to a length of the first key.

According to various embodiments of the present disclosure, the QBER measurement may be related to a ratio at which an error occurs based on first bit information of the first authentication code and second bit information of the second authentication code.

According to various embodiments of the present disclosure, there is provided a second device in a quantum communication system. The second device may include a transceiver and at least one processor, and the at least one processor may be configured to perform an operation method of the second device based on an embodiment of FIG. 52.

According to various embodiments of the present disclosure, there is provided a device controlling a second device in a quantum communication system. The device may include at least one processor and at least one memory operably connected to the at least one processor. The at least one memory may be configured to store instructions performing an operation method of the second device based on an embodiment of FIG. 52 based on being executed by the at least one processor.

According to various embodiments of the present disclosure, there are provided one or more non-transitory computer readable mediums storing one or more instructions. The one or more instructions may be configured to perform operations based on being executed by one or more processors, and the operations may include an operation method of a second device based on an embodiment of FIG. 52.

### Communication System Applicable to the Present Disclosure

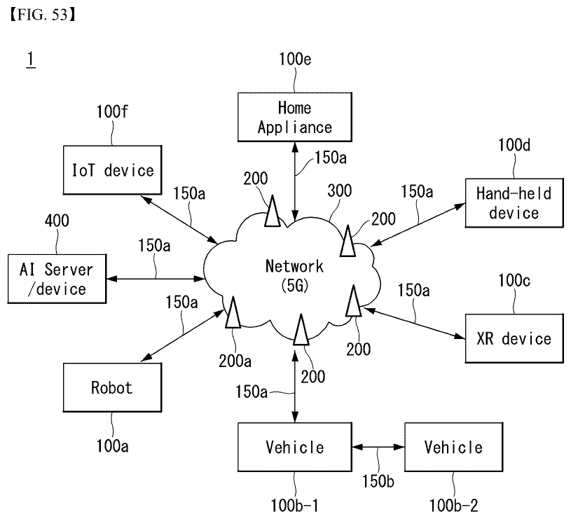

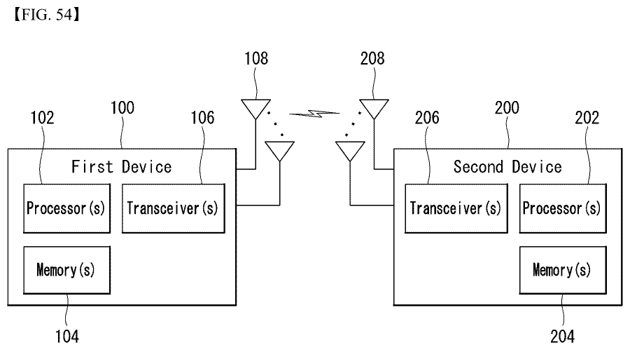

FIG. 53 illustrates a communication system 1 applied to various embodiments of the present disclosure.

Referring to FIG. 53, a communication system 1 applied to various embodiments of the present disclosure includes a wireless device, a base station, and a network. Herein, the wireless device refers to a device performing communication using Radio Access Technology (RAT) (e.g., 5G New RAT (NR)) or Long-Term Evolution (LTE), 6G wireless communication) and may be referred to as communication/radio/5G device/6G device. Although not limited thereto, the wireless devices may include a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BS and the network may be implemented as wireless devices and a specific wireless device 200a may operate as a BS/network node with respect to other wireless devices.

The wireless devices 100a to 100f may be connected to the network 300 via the BS 200. An Artificial Intelligence (AI) technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network, or 6G network. Although the wireless devices 100a to 100f may communicate with each other through the BS 200/network 300, the wireless devices 100a to 100f may perform direct communication (e.g., sidelink communication) with each other without passing through the BS/network. For example, the vehicles 100b-1 and 100b-2 may perform direct communication (e.g. Vehicle-to-Vehicle (V2V)/Vehicle-to-everything (V2X) communication). Additionally, the IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BS/the wireless device, the base station and the base station may transmit/receive radio signals to/from each other through the wireless communication/connections 150a, 150b, and 150c. For example, the wireless communication/connections 150a, 150b, and 150c may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Meanwhile, NR supports multiple numerology (or subcarrier spacing (SCS)) to support various 5G services. For example, when SCS is 15 kHz, it supports a wide area in traditional cellular bands, and when SCS is 30 kHz/60 kHz, it supports dense-urban, lower latency, and wider carrier bandwidth, when SCS is 60 kHz or higher, it supports bandwidth greater than 24.25 GHz to overcome phase noise.

The NR frequency band can be defined as two types of frequency ranges (FR1, FR2). The values of the frequency range may be changed, for example, and the frequency ranges of the two types (FR1, FR2) may be as shown in Table 12 below. For convenience of explanation, among the frequency ranges used in the NR system, FR1 may mean “sub 6 GHz range”, and FR2 may mean “above 6 GHz range” and may be called millimeter wave (mmW).

TABLE 12

| Frequency Range | Corresponding frequency | |
|---|---|---|
| designation | range | Subcarrier Spacing |
| FR1 | 450 MHz-6000 MHz | 15, 30, 60 kHz |
| FR2 | 24250 MHz-52600 MHz | 60, 120, 240 kHz |

As described above, the numerical value of the frequency range of the NR system can be changed. For example, FR1 may include a band of 410 MHz to 7125 MHz as shown in Table 13 below. That is, FR1 may include a frequency band of 6 GHz (or 5850, 5900, 5925 MHz, etc.). For example, the frequency band above 6 GHz (or 5850, 5900, 5925 MHz, etc.) included within FR1 may include an unlicensed band. Unlicensed bands can be used for a variety of purposes, for example, for communications for vehicles (e.g., autonomous driving).

TABLE 13

| Frequency Range | Corresponding frequency | |
|---|---|---|
| designation | range | Subcarrier Spacing |
| FR1 | 41 MHz-7125 MHz | 15, 30, 60 kHz |
| FR2 | 24250 MHz-52600 MHz | 60, 120, 240 kHz |

### Wireless Device Applicable to the Present Disclosure

Examples of a wireless device to which various embodiments of the present disclosure are applied are described below.

FIG. 54 illustrates a wireless device applicable to various embodiments of the present disclosure.

Referring to FIG. 54, a first wireless device 100 and a second wireless device 200 may transmit and receive radio signals through various wireless access technologies (e.g., LTE and NR). {The first wireless device 100 and the second wireless device 200} may correspond to {the wireless device 100x and the base station 200} and/or {the wireless device 100x and the wireless device 100x} of FIG. 53.

The first wireless device 100 may include one or more processors 102 and one or more memories 104 and may further include one or more transceivers 106 and/or one or more antennas 108. The processor 102 may control the memory 104 and/or the transceiver 106 and may be configured to implement the descriptions, functions, procedures, proposals, methods and/or operation flowcharts described in the present disclosure. For example, the processor 102 may process information within the memory 104 to generate first information/signal, and then transmit a radio signal including the first information/signal through the transceiver 106. Further, the processor 102 may receive a radio signal including second information/signal through the transceiver 106, and then store in the memory 104 information obtained from signal processing of the second information/signal. The memory 104 may be connected to the processor 102 and store various information related to an operation of the processor 102. For example, the memory 104 may store software codes including instructions for performing all or some of processes controlled by the processor 102 or performing the descriptions, functions, procedures, proposals, methods and/or operation flowcharts described in the present disclosure. The processor 102 and the memory 104 may be a part of a communication modem/circuit/chip designed to implement the wireless communication technology (e.g., LTE and NR). The transceiver 106 may be connected to the processor 102 and may transmit and/or receive the radio signals via one or more antennas 108. The transceiver 106 may include a transmitter and/or a receiver. The transceiver 106 may be used interchangeably with a radio frequency (RF) unit. In various embodiments of the present disclosure, the wireless device may mean the communication modem/circuit/chip.

The second wireless device 200 may include one or more processors 202 and one or more memories 204 and may further include one or more transceivers 206 and/or one or more antennas 208. The processor 202 may control the memory 204 and/or the transceiver 206 and may be configured to implement the descriptions, functions, procedures, proposals, methods and/or operation flowcharts described in the present disclosure. For example, the processor 202 may process information within the memory 204 to generate third information/signal and then transmit a radio signal including the third information/signal through the transceiver 206. Further, the processor 202 may receive a radio signal including fourth information/signal through the transceiver 206 and then store in the memory 204 information obtained from signal processing of the fourth information/signal. The memory 204 may be connected to the processor 202 and store various information related to an operation of the processor 202. For example, the memory 204 may store software codes including instructions for performing all or some of processes controlled by the processor 202 or performing the descriptions, functions, procedures, proposals, methods and/or operation flowcharts described in the present disclosure. The processor 202 and the memory 204 may be a part of a communication modem/circuit/chip designated to implement the wireless communication technology (e.g., LTE and NR). The transceiver 206 may be connected to the processor 202 and may transmit and/or receive the radio signals through one or more antennas 208. The transceiver 206 may include a transmitter and/or a receiver, and the transceiver 206 may be used interchangeably with the RF unit. In various embodiments of the present disclosure, the wireless device may mean the communication modem/circuit/chip.

Hardware elements of the wireless devices 100 and 200 are described in more detail below. Although not limited thereto, one or more protocol layers may be implemented by one or more processors 102 and 202. For example, one or more processors 102 and 202 may implement one or more layers (e.g., functional layers such as PHY, MAC, RLC, PDCP, RRC, and SDAP). One or more processors 102 and 202 may generate one or more protocol data units (PDUs) and/or one or more service data units (SDUs) based on the descriptions, functions, procedures, proposals, methods and/or operation flowcharts described in the present disclosure. One or more processors 102 and 202 may generate messages, control information, data, or information based on the descriptions, functions, procedures, proposals, methods and/or operation flowcharts described in the present disclosure. One or more processors 102 and 202 may generate a signal (e.g., a baseband signal) including the PDU, the SDU, the messages, the control information, the data, or the information based on the functions, procedures, proposals and/or methods described in the present disclosure, and provide the generated signal to one or more transceivers 106 and 206. One or more processors 102 and 202 may receive the signal (e.g., baseband signal) from one or more transceivers 106 and 206 and acquire the PDU, the SDU, the messages, the control information, the data, or the information based on the descriptions, functions, procedures, proposals, methods and/or operation flowcharts described in the present disclosure.

One or more processors 102 and 202 may be referred to as a controller, a microcontroller, a microprocessor, or a microcomputer. One or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in one or more processors 102 and 202. The descriptions, functions, procedures, proposals, methods and/or operation flowcharts described in the present disclosure may be implemented using firmware or software, and the firmware or software may be implemented to include modules, procedures, functions, and the like. Firmware or software configured to perform the descriptions, functions, procedures, proposals, methods and/or operation flowcharts described in the present disclosure may be included in one or more processors 102 and 202 or stored in one or more memories 104 and 204 and may be executed by one or more processors 102 and 202. The descriptions, functions, procedures, proposals, methods and/or operation flowcharts described in the present disclosure may be implemented using firmware or software in the form of codes, instructions and/or a set form of instructions.

The one or more memories 104 and 204 may be connected to the one or more processors 102 and 202 and store various types of data, signals, messages, information, programs, codes, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located inside and/or outside the one or more processors 102 and 202. The one or more memories 104 and 204 may be connected to the one or more processors 102 and 202 through various technologies such as wired or wireless connection.

The one or more transceivers 106 and 206 may transmit, to one or more other devices, user data, control information, radio signals/channels, etc. mentioned in the methods and/or operation flowcharts of the present disclosure. The one or more transceivers 106 and 206 may receive, from the one or more other devices, the user data, control information, radio signals/channels, etc. mentioned in the descriptions, functions, procedures, proposals, methods and/or operation flowcharts described in the present disclosure. For example, the one or more transceivers 106 and 206 may be connected to the one or more processors 102 and 202 and transmit and receive radio signals. For example, the one or more processors 102 and 202 may control the one or more transceivers 106 and 206 to transmit the user data, control information, or radio signals to the one or more other devices. The one or more processors 102 and 202 may control the one or more transceivers 106 and 206 to receive the user data, control information, or radio signals from the one or more other devices. The one or more transceivers 106 and 206 may be connected to the one or more antennas 108 and 208, and the one or more transceivers 106 and 206 may be configured to transmit and receive over the one or more antennas 108 and 208 the user data, control information, radio signals/channels, etc. mentioned in the descriptions, functions, procedures, proposals, methods and/or operation flowcharts described in the present disclosure. In the present disclosure, the one or more antennas may be a plurality of physical antennas or a plurality of logical antennas (e.g., antenna ports). The one or more transceivers 106 and 206 may convert the received radio signals/channels etc. from RF band signals to baseband signals in order to process the received user data, control information, radio signals/channels, etc. using the one or more processors 102 and 202. The one or more transceivers 106 and 206 may convert the user data, control information, radio signals/channels, etc. processed using the one or more processors 102 and 202 from the baseband signals to the RF band signals. To this end, the one or more transceivers 106 and 206 may include (analog) oscillators and/or filters.

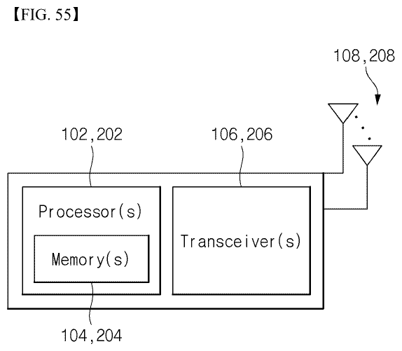

FIG. 55 illustrates another example of a wireless device applicable to various embodiments of the present disclosure.

Referring to FIG. 55, a wireless device may include at least one processor 102 and 202, at least one memory 104 and 204, at least one transceiver 106 and 206, and one or more antennas 108 and 208.

The wireless device illustrated in FIG. 54 is different from the wireless device illustrated in FIG. 55 in that the processors 102 and 202 and the memories 104 and 204 are separated from each other in FIG. 54, and the processors 102 and 202 include the memories 104 and 204 in FIG. 55.

Since the detailed description for the processors 102 and 202, the memories 104 and 204, the transceivers 106 and 206, and the one or more antennas 108 and 208 illustrated in FIG. 29 is the same as that described above, repetitive descriptions are omitted to avoid unnecessary repetition of description.

Examples of a signal processing circuit to which various embodiments of the present disclosure are applied are described below.

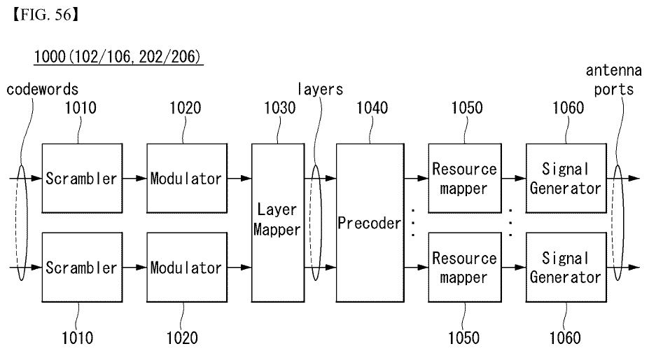

FIG. 56 illustrates a signal processing circuit for a transmission signal.

Referring to FIG. 56, a signal processing circuit 1000 may include scramblers 1010, modulators 1020, a layer mapper 1030, a precoder 1040, resource mappers 1050, and signal generators 1060. Although not limited to this, an operation/function of FIG. 56 may be performed by the processors 102 and 202 and/or the transceivers 106 and 206 of FIG. 54. Hardware elements of FIG. 56 may be implemented by the processors 102 and 202 and/or the transceivers 106 and 206 of FIG. 54. For example, blocks 1010 to 1060 may be implemented by the processors 102 and 202 of FIG. 54. Further, the blocks 1010 to 1050 may be implemented by the processors 102 and 202 of FIG. 54, and the block 1060 may be implemented by the transceivers 106 and 206 of FIG. 54.

Codewords may be converted into radio signals via the signal processing circuit 1000 of FIG. 56. The codewords are encoded bit sequences of information blocks. The information blocks may include transport blocks (e.g., a UL-SCH transport block, a DL-SCH transport block). The radio signals may be transmitted via various physical channels (e.g., PUSCH, PDSCH, etc.).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W, where N is the number of antenna ports, and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols, and the generated radio signals may be transmitted to other devices over each antenna. To this end, the signal generators 1060 may include inverse fast Fourier transform (IFFT) modules, cyclic prefix (CP) inserters, digital-to-analog converters (DACs), and frequency up-converters.

Signal processing procedures for a received signal in the wireless device may be configured in a reverse manner of the signal processing procedures 1010 to 1060 of FIG. 56. For example, the wireless devices (e.g., 100 and 200 of FIG. 54) may receive radio signals from the exterior through the antenna ports/transceivers. The received radio signals may be converted into baseband signals through signal restorers. To this end, the signal restorers may include frequency down-converters, analog-to-digital converters (ADCs), CP remover, and fast Fourier transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

Examples of use of a wireless device to which various embodiments of the present disclosure are applied are described below.

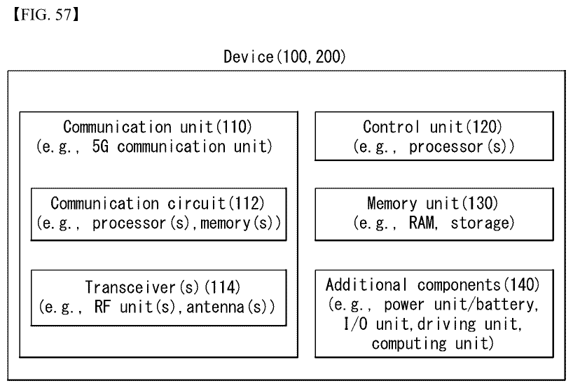

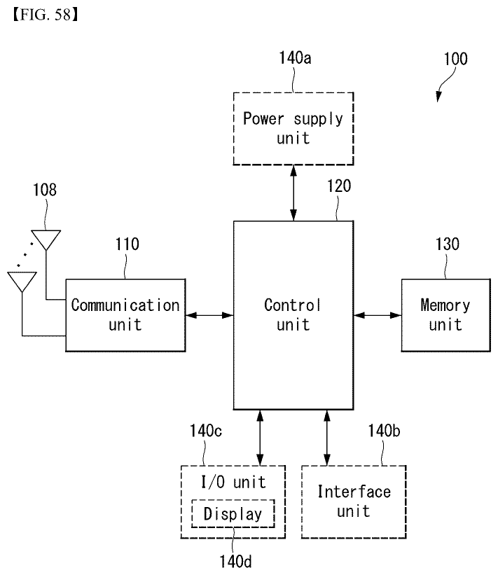

FIG. 57 illustrates another example of a wireless device applied to various embodiments of the present disclosure. The wireless device may be implemented in various forms based on use cases/services (see FIG. 53).

Referring to FIG. 57, wireless devices 100 and 200 may correspond to the wireless devices 100 and 200 of FIG. 54 and may consist of various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 54. For example, the transceiver(s) 114 may include the one or more transceivers 106 and 206 and/or the one or more antennas 108 and 208 of FIG. 54. The control unit 120 is electrically connected to the communication unit 110, the memory 130, and the additional components 140 and controls overall operation of the wireless devices. For example, the control unit 120 may control an electric/mechanical operation of the wireless device based on programs/codes/instructions/information stored in the memory unit 130. The control unit 120 may transmit the information stored in the memory unit 130 to the exterior (e.g., other communication devices) through the communication unit 110 via a wireless/wired interface or store, in the memory unit 130, information received via the wireless/wired interface from the exterior (e.g., other communication devices) through the communication unit 110.

The additional components 140 may be variously configured based on types of wireless devices. For example, the additional components 140 may include at least one of a power unit/battery, input/output (I/O) unit, a driving unit, and a computing unit. The wireless device may be implemented in the form of the robot (100a of FIG. 53), the vehicles (100b-1 and 100b-2 of FIG. 53), the XR device (100c of FIG. 53), the hand-held device (100d of FIG. 53), the home appliance (100e of FIG. 53), the IoT device (100f of FIG. 53), a digital broadcast terminal, a hologram device, a public safety device, an MTC device, a medicine device, a fintech device (or a finance device), a security device, a climate/environment device, the AI server/device (400 of FIG. 53), the BSs (200 of FIG. 53), a network node, etc., but is not limited thereto. The wireless device may be used in a mobile or fixed place based on a use-example/service.

In FIG. 57, all the various elements, components, units/parts, and/or modules of the wireless devices 100 and 200 may be connected to each other via wired interfaces or at least a part thereof may be wirelessly connected through the communication unit 110. For example, in each of the wireless devices 100 and 200, the control unit 120 and the communication unit 110 may be connected by wire, and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may consist of a set of one or more processors. As an example, the control unit 120 may include a set of a communication control processor, an application processor, an electronic control unit (ECU), a graphical processing unit, and a memory control processor. As another example, the memory 130 may include a random access memory (RAM), a dynamic RAM (DRAM), a read only memory (ROM)), a flash memory, a volatile memory, a non-volatile memory, and/or a combination thereof. Examples of implementation of FIG. 57 are described in more detail below.

FIG. 58 illustrates a hand-held device applied to various embodiments of the present disclosure. The hand-held device may include a smartphone, a smartpad, a wearable device (e.g., a smartwatch or a smartglasses), or a portable computer (e.g., a notebook). The mobile device may be referred to as a mobile station (MS), a user terminal (UT), a mobile subscriber station (MSS), a subscriber station (SS), an advanced mobile station (AMS), or a wireless terminal (WT).

Referring to FIG. 58, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 57, respectively.

The communication unit 110 may transmit and receive signals (e.g., data and control signals) to and from other wireless devices or BSs. The control unit 120 may perform various operations by controlling components of the hand-held device 100. The control unit 120 may include an application processor (AP). The memory unit 130 may store data/parameters/programs/codes/instructions needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, for data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

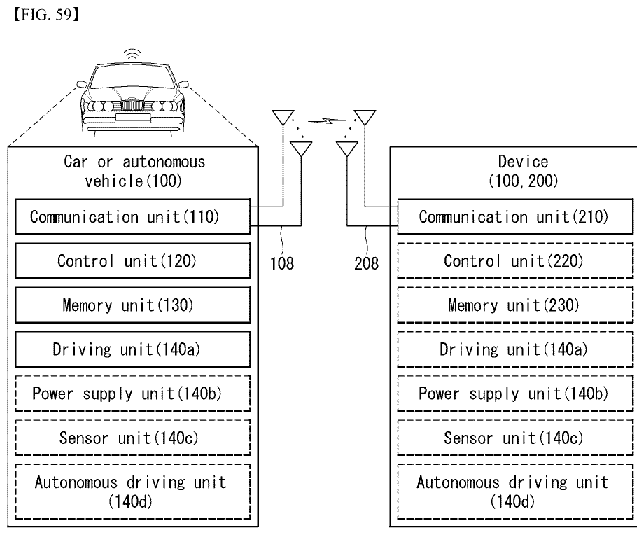

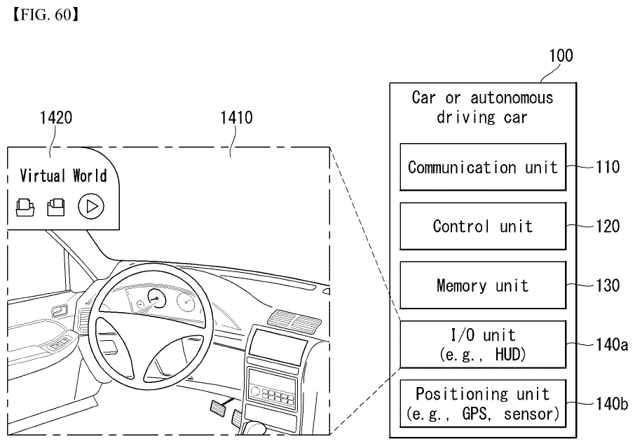

FIG. 59 illustrates a vehicle or an autonomous vehicle applied to various embodiments of the present disclosure.

The vehicle or autonomous vehicle may be implemented by a mobile robot, a car, a train, a manned/unmanned Aerial Vehicle (AV), a ship, etc.

Referring to FIG. 59, a vehicle or autonomous vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 57, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous vehicle 100. The control unit 120 may include an electronic control unit (ECU). The driving unit 140a may allow the vehicle or the autonomous vehicle 100 to drive on a road. The driving unit 140a may include an engine, a motor, a powertrain, a wheel, a brake, a steering device, etc. The power supply unit 140b may supply power to the vehicle or the autonomous vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a so that the vehicle or the autonomous vehicle 100 moves along the autonomous driving path based on the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transmit information on a vehicle position, the autonomous driving path, and/or the driving plan to the external server. The external server may predict traffic information data using AI technology, etc., based on the information collected from vehicles or autonomous vehicles and provide the predicted traffic information data to the vehicles or the autonomous vehicles.

FIG. 60 illustrates a vehicle applied to various embodiments of the present disclosure. The vehicle may be implemented as a transport means, a train, an aerial vehicle, a ship, etc.

Referring to FIG. 60, a vehicle 100 may include a communication unit 110, a control unit 120, a memory unit 130, an I/O unit 140a, and a positioning unit 140b. The blocks 110 to 130/140a and 140b correspond to blocks 110 to 130/140 of FIG. 57, respectively.

The communication unit 110 may transmit and receive signals (e.g., data and control signals) to and from external devices such as other vehicles or base stations. The control unit 120 may perform various operations by controlling components of the vehicle 100. The memory unit 130 may store data/parameters/programs/codes/instructions for supporting various functions of the vehicle 100. The I/O unit 140a may output an AR/VR object based on information within the memory unit 130. The I/O unit 140a may include an HUD. The positioning unit 140b may acquire location information of the vehicle 100. The location information may include absolute location information of the vehicle 100, location information of the vehicle 100 within a traveling lane, acceleration information, and location information of the vehicle 100 from a neighboring vehicle. The positioning unit 140b may include a GPS and various sensors.

As an example, the communication unit 110 of the vehicle 100 may receive map information and traffic information from an external server and store the received information in the memory unit 130. The positioning unit 140b may obtain vehicle location information through the GPS and the various sensors and store the obtained information in the memory unit 130. The control unit 120 may generate a virtual object based on the map information, the traffic information, and the vehicle location information, and the I/O unit 140a may display the generated virtual object on a window in the vehicle (1410 and 1420). The control unit 120 may determine whether the vehicle 100 normally drives within a traveling lane, based on the vehicle location information. If the vehicle 100 abnormally exits from the traveling lane, the control unit 120 may display a warning on the window in the vehicle through the I/O unit 140a. In addition, the control unit 120 may broadcast a warning message about driving abnormity to neighboring vehicles through the communication unit 110. According to situations, the control unit 120 may transmit the location information of the vehicle and the information about driving/vehicle abnormality to related organizations through the communication unit 110.

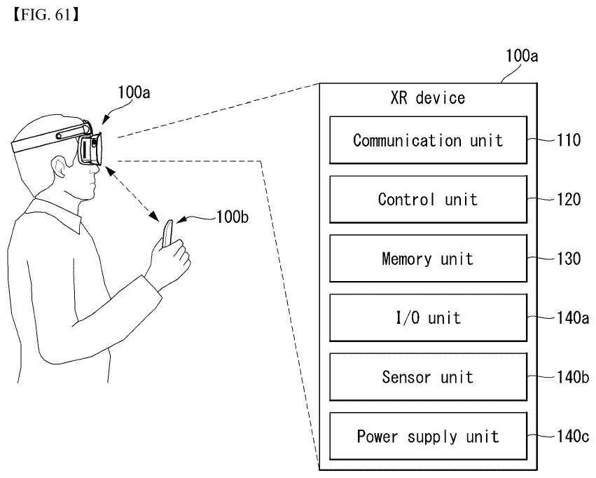

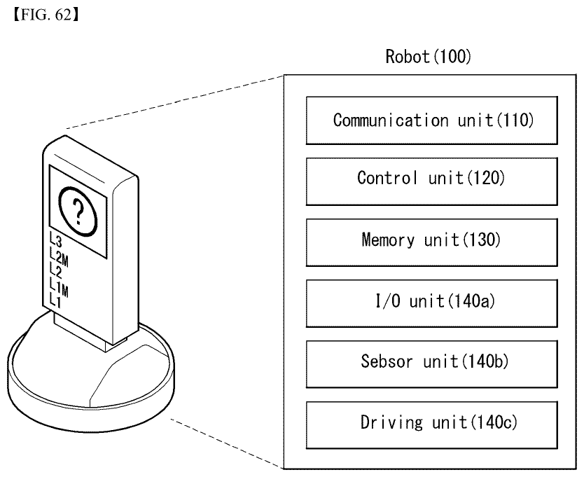

FIG. 61 illustrates an XR device applied to various embodiments of the present disclosure. The XR device may be implemented as an HMD, a head-up display (HUD) mounted in a vehicle, a television, a smartphone, a computer, a wearable device, a home appliance, a digital signage, a vehicle, a robot, etc.

Referring to FIG. 61, an XR device 100a may include a communication unit 110, a control unit 120, a memory unit 130, an I/O unit 140a, a sensor unit 140b, and a power supply unit 140c. The blocks 110 to 130/140a to 140c correspond to the blocks 110 to 130/140 of FIG. 57, respectively.

The communication unit 110 may transmit and receive signals (e.g., media data, control signal, etc.) to and from external devices such as other wireless devices, handheld devices, or media servers. The media data may include video, images, sound, etc. The control unit 120 may control components of the XR device 100a to perform various operations. For example, the control unit 120 may be configured to control and/or perform procedures such as video/image acquisition, (video/image) encoding, and metadata generation and processing. The memory unit 120 may store data/parameters/programs/codes/instructions required to drive the XR device 100a/generate an XR object. The I/O unit 140a may obtain control information, data, etc. from the outside and output the generated XR object. The I/O unit 140a may include a camera, a microphone, a user input unit, a display, a speaker, and/or a haptic module. The sensor unit 140b may obtain a state, surrounding environment information, user information, etc. of the XR device 100a. The sensor 140b may include a proximity sensor, an illumination sensor, an acceleration sensor, a magnetic sensor, a gyro sensor, an inertial sensor, an RGB sensor, an IR sensor, a fingerprint scan sensor, an ultrasonic sensor, a light sensor, a microphone, and/or a radar. The power supply unit 140c may supply power to the XR device 100a and include a wired/wireless charging circuit, a battery, etc.

For example, the memory unit 130 of the XR device 100a may include information (e.g., data) required to generate the XR object (e.g., an AR/VR/MR object). The I/O unit 140a may obtain instructions for manipulating the XR device 100a from a user, and the control unit 120 may drive the XR device 100a based on a driving instruction of the user. For example, if the user desires to watch a film, news, etc. through the XR device 100a, the control unit 120 may transmit content request information to another device (e.g., a handheld device 100b) or a media server through the communication unit 110. The communication unit 110 may download/stream content such as films and news from another device (e.g., the handheld device 100b) or the media server to the memory unit 130. The control unit 120 may control and/or perform procedures, such as video/image acquisition, (video/image) encoding, and metadata generation/processing, for the content and generate/output the XR object based on information about a surrounding space or a real object obtained through the I/O unit 140a/sensor unit 140b.

The XR device 100a may be wirelessly connected to the handheld device 100b through the communication unit 110, and the operation of the XR device 100a may be controlled by the handheld device 100b. For example, the handheld device 100b may operate as a controller of the XR device 100a. To this end, the XR device 100a may obtain 3D location information of the handheld device 100b and generate and output an XR object corresponding to the handheld device 100b.

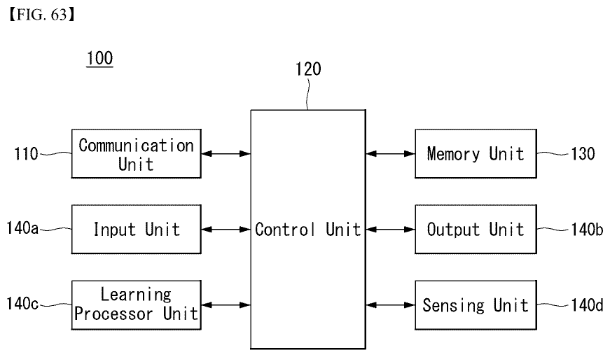

FIG. 62 illustrates a robot applied to various embodiments of the present disclosure. The robot may be categorized into an industrial robot, a medical robot, a household robot, a military robot, etc., based on a used purpose or field.

Referring to FIG. 62, a robot 100 may include a communication unit 110, a control unit 120, a memory unit 130, an I/O unit 140a, a sensor unit 140b, and a power supply unit 140c. The blocks 110 to 130/140a to 140c correspond to the blocks 110 to 130/140 of FIG. 57, respectively.

The communication unit 110 may transmit and receive signals (e.g., driving information and control signals) to and from external devices such as other wireless devices, other robots, or control servers. The control unit 120 may perform various operations by controlling components of the robot 100. The memory unit 130 may store data/parameters/programs/codes/instructions for supporting various functions of the robot 100. The I/O unit 140a may obtain information from the outside of the robot 100 and output information to the outside of the robot 100. The I/O unit 140a may include a camera, a microphone, a user input unit, a display unit, a speaker, and/or a haptic module. The sensor unit 140b may obtain internal information of the robot 100, surrounding environment information, user information, etc. The sensor unit 140b may include a proximity sensor, an illumination sensor, an acceleration sensor, a magnetic sensor, a gyro sensor, an inertial sensor, an IR sensor, a fingerprint recognition sensor, an ultrasonic sensor, a light sensor, a microphone, a radar, etc. The driving unit 140c may perform various physical operations such as movement of robot joints. In addition, the driving unit 140c may allow the robot 100 to travel on the road or to fly. The driving unit 140c may include an actuator, a motor, a wheel, a brake, a propeller, etc.

FIG. 63 illustrates an AI device applied to various embodiments of the present disclosure.

The AI device may be implemented as a fixed device or a mobile device, such as a TV, a projector, a smartphone, a PC, a notebook, a digital broadcast terminal, a tablet PC, a wearable device, a Set Top Box (STB), a radio, a washing machine, a refrigerator, a digital signage, a robot, a vehicle, etc.

Referring to FIG. 63, an AI device 100 may include a communication unit 110, a control unit 120, a memory unit 130, an input unit 140a, an out unit 140b, a learning processor unit 140c, and a sensor unit 140d. The blocks 110 to 130/140a to 140d correspond to the blocks 110 to 130/140 of FIG. 57, respectively.

The communication unit 110 may transmit and receive wired/radio signals (e.g., sensor information, user input, learning models, or control signals) to and from external devices such as other AI devices (e.g., 100x, 200, or 400 of FIG. 53) or an AI server 200 using wired/wireless communication technology. To this end, the communication unit 110 may transmit information within the memory unit 130 to an external device and transmit a signal received from the external device to the memory unit 130.

The control unit 120 may determine at least one feasible operation of the AI device 100, based on information which is determined or generated using a data analysis algorithm or a machine learning algorithm. The control unit 120 may perform an operation determined by controlling components of the AI device 100. For example, the control unit 120 may request, search, receive, or use data of the learning processor unit 140c or the memory unit 130 and control the components of the AI device 100 to perform a predicted operation or an operation determined to be preferred among at least one feasible operation. The control unit 120 may collect history information including the operation contents of the AI device 100 and operation feedback by a user and store the collected information in the memory unit 130 or the learning processor unit 140c or transmit the collected information to an external device such as an AI server (400 of FIG. 53). The collected history information may be used to update a learning model.

The memory unit 130 may store data for supporting various functions of the AI device 100. For example, the memory unit 130 may store data obtained from the input unit 140a, data obtained from the communication unit 110, output data of the learning processor unit 140c, and data obtained from the sensor unit 140. The memory unit 130 may store control information and/or software code needed to operate/drive the control unit 120.

The input unit 140a may acquire various types of data from the exterior of the AI device 100. For example, the input unit 140a may acquire learning data for model learning, and input data to which the learning model is to be applied. The input unit 140a may include a camera, a microphone, and/or a user input unit. The output unit 140b may generate output related to a visual, auditory, or tactile sense. The output unit 140b may include a display unit, a speaker, and/or a haptic module. The sensing unit 140 may obtain at least one of internal information of the AI device 100, surrounding environment information of the AI device 100, and user information, using various sensors. The sensor unit 140 may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone, and/or a radar.

The learning processor unit 140c may learn a model consisting of artificial neural networks, using learning data. The learning processor unit 140c may perform AI processing together with the learning processor unit of the AI server (400 of FIG. 53). The learning processor unit 140c may process information received from an external device through the communication unit 110 and/or information stored in the memory unit 130. In addition, an output value of the learning processor unit 140c may be transmitted to the external device through the communication unit 110 and may be stored in the memory unit 130.

The claims described in various embodiments of the present disclosure can be combined in various ways. For example, technical features of the method claims of various embodiments of the present disclosure can be combined and implemented as a device, and technical features of the device claims of various embodiments of the present disclosure can be combined and implemented as a method. In addition, the technical features of the method claims and the technical features of the device claims in various embodiments of the present disclosure can be combined and implemented as a device, and the technical features of the method claims and the technical features of the device claims in various embodiments of the present disclosure can be combined and implemented as a method.

1. An operation method of a first device in a quantum communication system, comprising:
transmitting, to a second device, information about M, which is a modulation order of a symmetric M-order quantum state modulation (symmetric M-QSM), and information about one encoding method selected from among a plurality of authentication encoding methods;
generating information about a first quantum state on the basis of the symmetric M-order quantum state modulation by using a first authentication code and a first key shared in advance with the second device;
transmitting, to the second device, a message including a quantum authentication header (QA header) based on the first quantum state;
receiving, from the second device, a feedback message including a second authentication code based on the quantum authentication header;
performing a quantum bit error rate (QBER) measurement based on a comparison between the first authentication code and the second authentication code;
determining, based on a comparison between a result value of the QBER measurement and a predetermined threshold, whether the second device is authenticated; and
transmitting an acknowledgement (ACK) or non-acknowledgement (NACK) message to the second device based on whether the second device being authenticated.

2. The method of claim 1, wherein
the second authentication code is based on a second quantum state transformed from the quantum authentication header by a symmetric M-order quantum state modulation compensator (symmetric M-QSM compensator) using the first key.

3. The method of claim 1, wherein the symmetric M-order quantum state modulation compensator (symmetric M-QSM compensator) is configured to perform a basis compensation for the first quantum state of the quantum authentication header by using the first key.

4. The method of claim 1, wherein the plurality of encoding methods are different from each other in terms of an authentication code for M which is the modulation order of the symmetric M-order quantum state modulation (symmetric M-QSM) and a mapping table of a qubit constellation point,
wherein the respective qubit constellation points correspond to respective quantum states,
wherein the first authentication code is based on a mapping table corresponding to the one encoding method, and
wherein information about a mapping table corresponding to each of the plurality of encoding methods is shared in advance between the first device and the second device.

5. The method of claim 4, wherein in the plurality of encoding methods,
as a first probability that a third device is to succeed in an authentication by the first device like the second device based on a random basis without information about the first key is higher,
a second probability in which the third device is to estimate the first key based on an authentication code received from the second device is configured to be lower.

6. The method of claim 5, wherein the one encoding method among the plurality of encoding methods is determined based on a configured security policy or a channel state of the quantum communication system.

7. The method of claim 1, wherein the first quantum state corresponds to a length of the first key.

8. The method of claim 1, wherein the QBER measurement is related to a ratio at which an error occurs based on first bit information of the first authentication code and second bit information of the second authentication code.

9. An operation method of a second device in a quantum communication system, comprising:
receiving, from a first device, information about M, which is a modulation order of a symmetric M-order quantum state modulation (symmetric M-QSM), and information about one encoding method selected from among a plurality of authentication encoding methods;
receiving, from the first device, a message including a quantum authentication (QA) header based on a first quantum state, wherein information about the first quantum state is generated based on the symmetric M-order quantum state modulation (symmetric M-QSM) by using a first authentication code and a first key shared in advance with the first device;
obtaining a second authentication code based on the quantum authentication header;
transmitting, to the first device, a feedback message including the second authentication code; and
receiving, from the first device, a message of an acknowledgement (ACK) or a non-acknowledgement (NACK) for an authentication according to a result of a quantum bit error rate (QBER) measurement based on a comparison between the first authentication code and the second authentication code.

10. The method of claim 9, wherein the obtaining of the second authentication code based on the quantum authentication header includes
obtaining a second quantum state by performing a quantum state transform based on a symmetric M-QSM compensator according to M which is the modulation order by using the first key for the first quantum state of the quantum authentication header, and
obtaining the second authentication code based on the second quantum state.

11. The method of claim 10, wherein the symmetric M-order quantum state modulation compensator (symmetric M-QSM compensator) is configured to perform a basis compensation for the first quantum state of the quantum authentication header by using the first key.

12. The method of claim 9, wherein the plurality of encoding methods are different from each other in terms of a mapping table of code indexes for qubit constellations,
wherein the plurality of encoding methods are different from each other in terms of an authentication code for M which is the modulation order of the symmetric M-order quantum state modulation (symmetric M-QSM) and a mapping table of a qubit constellation point,
wherein the respective qubit constellation points correspond to respective quantum states,
wherein the first authentication code is based on a mapping table corresponding to the one encoding method, and
wherein information about a mapping table corresponding to each of the plurality of encoding methods is shared in advance between the first device and the second device.

13. The method of claim 12, wherein in the plurality of encoding methods,
as a first probability that a third device is to succeed in an authentication by the first device like the second device based on a random basis without information about the first key is higher,
a second probability in which the third device is to estimate the first key based on an authentication code received from the second device is configured to be lower.

14. The method of claim 13, wherein the one encoding method among the plurality of encoding methods is determined based on a configured security policy or a channel state of the quantum communication system.

15. The method of claim 9, wherein the first quantum state corresponds to a length of the first key.

16. The method of claim 9, wherein the QBER measurement is related to a ratio at which an error occurs based on first bit information of the first authentication code and second bit information of the second authentication code.

17. A first device in a quantum communication system, comprising:
a transceiver; and
at least one processor,
wherein the at least one processor is configured to
transmit, to a second device, information about M, which is a modulation order of a symmetric M-order quantum state modulation (symmetric M-QSM), and information about one encoding method selected from among a plurality of authentication encoding methods,
generate information about a first quantum state on the basis of the symmetric M-order quantum state modulation by using a first authentication code and a first key shared in advance with the second device,
transmit, to the second device, a message including a quantum authentication header (QA header) based on the first quantum state,
receive, from the second device, a feedback message including a second authentication code based on the quantum authentication header,
perform a quantum bit error rate (QBER) measurement based on a comparison between the first authentication code and the second authentication code,
determine, based on a comparison between a result value of the QBER measurement and a predetermined threshold, whether the second device is authenticated, and
transmit an acknowledgement (ACK) or non-acknowledgement (NACK) message to the second device based on whether the second device being authenticated.

18-20. (canceled)
